(19) United States
(12) Patent Application Publication
(10) Pub. No.: US 2026/0358167 A1
(43) Pub. Date: Nov. 12, 2026

(54) POWDER WEIGHING ASSEMBLY, POWDER SCOOPING APPARATUS, AND EXPERIMENTAL DEVICE

(71) Applicant: SHENZHEN JINGTAI TECHNOLOGY CO., LTD., Shenzhen (CN)

(72) Inventors: Yang LIU, Shenzhen (CN); Wei WANG, Shenzhen (CN); Jinkang HUANG, Shenzhen (CN); Xiaoyun LI, Shenzhen (CN); Tuanyuan DING, Shenzhen (CN); Shuhuan HU, Shenzhen (CN)

(21) Appl. No.: 19/718,339

(22) Filed: Jun. 24, 2026

Related U.S. Application Data
(63) Continuation-in-part of application No. PCT/CN2025/103619, filed on Jun. 25, 2025.

(30) Foreign Application Priority Data
Dec. 19, 2024 (CN) 202411900244.5

(51) Int. Cl. G01G 17/04; B25J 11/00

(52) U.S. Cl. CPC G01G 17/04; B25J 11/00

(57) ABSTRACT

A powder weighing assembly, a powder scooping apparatus, and an experimental device are provided. The powder weighing assembly includes a moving mechanism, a container seat, and a weighing device disposed on one side of the container seat in a first direction. The moving mechanism is connected to the container seat and/or the weighing device, and is configured to cause relative movement between the container seat and the weighing device, to enable the container seat and the weighing device to be in contact with or separated from each other in the first direction. The container seat includes a first placement structure that is configured for placement of a target container to be filled with powder and a second placement structure that is configured for placement of a source container filled with powder. The weighing device is configured to be in contact with the container seat and weigh the container seat.

### CROSS-REFERENCE TO RELATED APPLICATION(S)

This application is a continuation-in-part of International Application No. PCT/CN2025/103619, filed Jun. 25, 2025, which claims priority to Chinese Patent Application No. 202411900244.5, filed Dec. 19, 2024, the entire disclosure of which are hereby incorporated by reference.

### TECHNICAL FIELD

This disclosure relates to the field of automated equipment technology, and in particular, to a powder weighing assembly, a powder scooping apparatus, and an experimental device.

### BACKGROUND

In fields such as biology, pharmaceuticals, chemical engineering, and medical care, many experiments and production processes involve quantitative powder dispensing procedures. At present, powder dispensing procedures are usually completed by manual operation. Generally, an experimenter places a target container on a balance, then uses a small scoop to scoop powder from a source container and pours the powder into the target container, and uses the balance to weigh the poured powder.

### SUMMARY

In a first aspect, the present disclosure provides a powder weighing assembly. The powder weighing assembly includes a moving mechanism, a container seat, and a weighing device. The moving mechanism is connected to the container seat and/or the weighing device, and is configured to cause relative movement between the container seat and the weighing device, to enable the container seat and the weighing device to be in contact with or separated from each other in a first direction. The container seat includes a first placement structure and a second placement structure. The first placement structure is configured for placement of a target container to be filled with powder. The second placement structure is configured for placement of a source container filled with powder. The weighing device is disposed on one side of the container seat in the first direction, and is configured to be in contact with the container seat and weigh the container seat.

In a second aspect, the present disclosure further provides a powder scooping apparatus. The powder scooping apparatus includes a powder scooping manipulator and the powder weighing assembly according to any one of the various implementations of the first aspect. The powder scooping manipulator is configured to scoop powder from the source container and transfer the powder into the target container. The powder scooping manipulator includes a powder scooping robotic arm and a powder scooping mechanism. The powder scooping mechanism is disposed on the powder scooping robotic arm. The powder scooping robotic arm is configured to drive the powder scooping mechanism to move between the source container and the target container. The powder scooping mechanism is configured to scoop the powder from the source container and pour the powder into the target container.

In a third aspect, the present disclosure further provides an experimental device. The experimental device includes the powder weighing assembly according to any one of the various implementations of the first aspect, or includes the powder scooping apparatus according to any one of the various implementations of the second aspect.

### BRIEF DESCRIPTION OF THE DRAWINGS

To more clearly describe implementations in the present disclosure or technical solutions in related art, the accompanying drawings that need to be used in description of implementations or the related art will be briefly introduced below. Apparently, the accompanying drawings in the following description are only some implementations in the present disclosure, and those of ordinary skill in the art may also obtain other accompanying drawings based on these accompanying drawings without creative effort.

FIG. 1 is a structural view of a powder weighing assembly according to an embodiment.

FIG. 2 is a structural view of a moving mechanism and a container seat according to an embodiment.

FIG. 3 is a side view of a moving mechanism and a container seat according to an embodiment.

FIG. 4 is a structural view of a powder weighing assembly according to another embodiment.

FIG. 5 is a structural view of a powder scooping apparatus according to an embodiment.

FIG. 6 is a structural view of a powder scooping manipulator according to an embodiment.

FIG. 7 is a structural view of a powder scooping manipulator according to another embodiment.

FIG. 8 is a structural view of a powder scooping manipulator according to yet another embodiment.

FIG. 9 is a partial cross-sectional view of a powder scooping manipulator according to an embodiment.

FIG. 10 is a structural view of a loading-and-unloading manipulator according to an embodiment.

FIG. 11 is a structural view of a gripper according to an embodiment.

FIG. 12 is a structural view of a loading-and-unloading manipulator according to another embodiment.

FIG. 13 is a structural view of a gripper according to another embodiment.

FIG. 14 is a structural view of a tube clamping mechanism and a powder vibration mechanism according to an embodiment.

FIG. 15 is a structural view of a powder weighing assembly according to yet another embodiment.

FIG. 16 is a structural view of a powder scooping apparatus according to another embodiment.

FIG. 17 is a structural view of a powder-scooping-member pick-and-place mechanism according to an embodiment.

FIG. 18 is a structural view of a gripper according to yet another embodiment.

FIG. 19 is a structural view of a gripper according to yet another embodiment.

FIG. 20 is a structural view of a loading-and-unloading manipulator according to yet another embodiment.

FIG. 21 is a structural view of a powder weighing assembly according to yet another embodiment.

FIG. 22 is a structural view of a container seat in FIG. 21.

### DESCRIPTION OF REFERENCE SIGNS OF THE ACCOMPANYING DRAWINGS

1000—powder scooping apparatus, 100—powder weighing assembly, 10—moving mechanism, 11—lifting seat, 111—bottom plate, 112—first side-plate, 113—second side-plate, 12—lifting driving member, 13—lifting transmission structure, 20—container seat, 21—first placement structure, 211—bottom support, 2111—bearing portion, 2112—contact portion, 212—limiting block, 2121—limiting hole, 2122—limiting arm, 213—connecting rod, 22—second placement structure, 221—first stand, 2211—first accommodating groove, 222—second stand, 2221—second accommodating groove, 23—seat body, 231—first support arm, 232—second support arm, 233—connection plate, 234—placement space, 30—weighing device, 40—tube pressing mechanism, 41—tube pressing driving member, 42—tube pressing transmission member, 421—tube pressing transmission structure, 422—rotating shaft, 43—tube pressing arm, 431—tube pressing plate, 4311—structural hole, 432—tube pressing head, 4321—pressing surface, 4322—tube pressing groove, 433—abutting head, 434—roller, 44—first support plate, 45—second support plate, 50—box body, 51—box cover, 511—notch, 512—first cover surface, 513—second cover surface, 52—cavity, 53—first plate body, 54—second plate body, 55—third plate body, 56—fourth plate body, 57—fifth plate body, 58—sixth plate body, 59—avoidance opening, 501—door shield, 502—first avoidance groove, 503—second avoidance groove, 504—windproof enclosure, 200—base, 201—pulley, 202—handle, 203—mounting plate, 204—sliding plate, 205—translation mechanism, 300—powder scooping manipulator, 60—powder scooping robotic arm, 61—first support mechanism, 62—second support mechanism, 63—support structure, 631—first support member, 632—second support member, 633—first transmission member, 634—second transmission member, 635—first driving member, 636—second driving member, 637—third driving member, 6371—mover, 6372—stator, 6373—guide member, 6374—detection apparatus, 6375—fixing plate, 6376—end plate, 6377—cover plate, 638—third transmission member, 6381—slider, 6382—connection head, 6383—connecting member, 639—fourth transmission member, 64—joint, 641—first rotating member, 642—second rotating member, 70—powder scooping mechanism, 71—first powder-scooping driving member, 72—first powder—scooping transmission member, 721—bushing, 722—guide shaft, 73—powder scooping member, 731—powder scooping rod, 732—scoop, 733—screw shaft, 7331—helical groove, 7332—straight groove, 734—first nut, 735—second nut, 736—bearing, 737—adapter sleeve, 738—locking nut, 739—adapter, 74—second powder—scooping driving member, 75—second powder-scooping transmission member, 751—first powder-scooping synchronous pulley, 752—second powder-scooping synchronous pulley, 753—powder-scooping synchronous belt, 76—third powder-scooping driving member, 77—third powder-scooping transmission member, 80—visual inspection assembly, 81—inspection bracket, 82—first inspection member, 83—second inspection member, 90—loading-and-unloading manipulator, 91—loading-and-unloading robotic arm, 911—loading-and-unloading support arm, 9111—first loading-and-unloading driving structure, 9112—second loading-and-unloading driving structure, 9113—first loading-and-unloading connecting arm, 9114—second loading-and-unloading connecting arm, 9115—third loading-and-unloading connecting arm, 9116—fourth loading-and-unloading connecting arm, 912—loading-and-unloading adjustment arm, 9121—third loading-and-unloading driving structure, 9122—first adjustment arm, 9123—second adjustment arm, 9124—adjustment plate, 9125—third adjustment arm, 913—loading-and-unloading connecting seat, 92—gripper, 921—finger, 922—gripper fixed seat, 923—gripper movable seat, 924—gripper transmission rod, 925—gripper transmission structure, 926—first gripper transmission member, 927—second gripper transmission member, 9271—first rod, 9272—second rod, 928—elastic member, 929—third gripper transmission member, 920—fourth gripper transmission member, 93—gripper driving structure, 931—gripper driving member, 932—belt transmission mechanism, 9321—mating member, 9322—second synchronous pulley, 9323—third synchronous pulley, 9324—first synchronous belt, 9325—second synchronous belt, 941—first spline-nut, 942—second spline-nut, 943—adapter bearing, 944—adapter joint, 945—locking member, 946—limiting member, 947—mounting seat, 948—pressing plate, 95—rotation mechanism, 951—rotational driving member, 952—first rotation gear, 953—second rotation gear, 954—rotary bearing, 955—sensing sheet, 96—base seat, 97—rotating driving member, 98—rotary disc, L1—first rotation axis, L2—second rotation axis, L3—third rotation axis, L4—fourth rotation axis, L5—fifth rotation axis, L6—sixth rotation axis, L7—seventh rotation axis, L8—eighth rotation axis, L9—ninth rotation axis, 400—tube clamping mechanism, 401—clamping assembly, 402—clamping member, 403—clamping driving member, 404—rotation assembly, 405—first moving assembly, 406—first lifting assembly, 407—first translation assembly, 500—buffer seat, 600—powder vibration mechanism, 601—mounting arm, 602—powder vibration driving member, 603—powder vibration member, 604—second moving assembly, 605—second lifting assembly, 606—second translation assembly, 700—electrostatic elimination mechanism, 800—powder-scooping-member pick-and-place mechanism, 801—seat-rotation driving member, 802—loading seat, 803—unloading seat, 804—receiving groove, 805—slot, 2000—target container, 3000—source container, X—third direction, Y—second direction, Z—first direction.

### DETAILED DESCRIPTION

Technical solutions of implementations of the present disclosure will be described clearly and completely with reference to accompanying drawings in implementations of the present disclosure. Apparently, implementations described herein are merely some implementations, rather than all implementations, of the present disclosure. Based on implementations of the present disclosure, all other implementations obtained by those of ordinary skill in the art without creative effort shall fall within the protection scope of the present disclosure.

It is to be noted that, when a component (element or member) is deemed as being “fixed” or “secured” to another component (element or member), the component (element or member) can be directly on the other component (element or member) or there may be an intermediate component (element or member) between the two components (elements or members). When a component (element or member) is considered to be “connected” or “coupled” to another component (element or member), the component (element or member) may be directly connected or coupled to the other component (element or member) or there may be an intermediate component (element or member) between the two components (elements or members).

Unless otherwise defined, all technical and scientific terms used herein have the same meaning as commonly understood by those skilled in the art of the present disclosure. The terms used herein in the present disclosure are for the purpose of describing specific embodiments only and are not intended to limit the present disclosure. The term “and/or” used herein includes any and all combinations of one or more related listed items. The term “at least one of A or B” used herein refers to A alone, B alone, or both A and B.

In fields such as biology, pharmaceuticals, chemical engineering, and medical care, many experiments and production processes involve quantitative powder dispensing procedures. At present, powder dispensing procedures are usually completed by manual operation. Generally, an experimenter places a target container on a balance, then uses a small scoop to scoop powder from a source container and pours the powder into the target container, and uses the balance to weigh the poured powder. This method requires the experimenter to repeatedly perform powder scooping and pouring operations, which consumes considerable time and effort of the experimenter, and has the problems such as high labor cost, low operation accuracy, and low efficiency.

The purpose of the present disclosure is to provide a powder weighing assembly, a powder scooping apparatus, and an experimental device, so as to solve the problems such as high labor cost, low operation accuracy, and low efficiency existing in the existing quantitative powder dispensing process.

Some implementations of the present disclosure will be described in detail below with reference to the accompanying drawings. The following embodiments and features in the embodiments can be combined with each other without conflict.

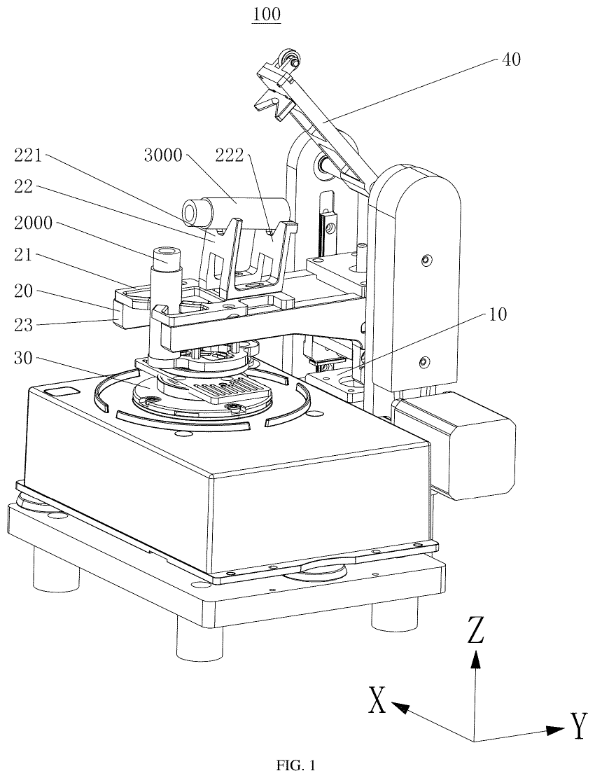

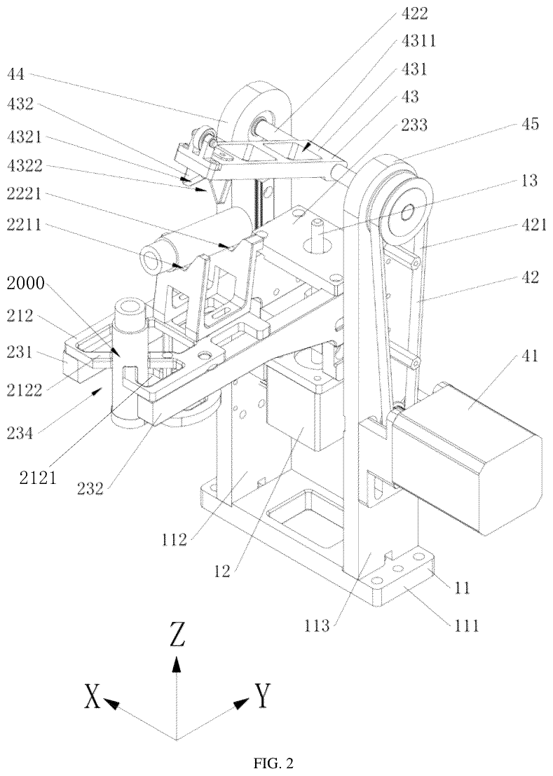

Reference can be made to FIG. 1 to FIG. 4. The present disclosure provides a powder weighing assembly 100. The powder weighing assembly 100 includes a moving mechanism 10, a container seat 20, and a weighing device 30. The moving mechanism 10 is connected to the container seat 20 and/or the weighing device 30, and is configured to cause relative movement between the container seat 20 and the weighing device 30, to enable the container seat 20 and the weighing device 30 to be in contact with or separated from each other in a first direction Z. The container seat 20 includes a first placement structure 21 and a second placement structure 22. The first placement structure 21 is configured for placement of a target container 2000 to be filled with powder. The second placement structure 22 is configured for placement of a source container 3000 filled with powder (not shown). The weighing device 30 is disposed on one side of the container seat 20 in the first direction Z, and is configured to be in contact with the container seat 20 and weigh the container seat 20.

Optionally, the moving mechanism 10 can drive the container seat 20 and/or the weighing device 30 to perform lifting movement, and/or, the moving mechanism 10 can drive the container seat 20 and/or the weighing device 30 to perform translational movement, which is not limited. For example, the moving mechanism 10 is connected to the container seat 20 and can drive the container seat 20 to lift, and the weighing device 30 is fixedly disposed. Alternatively, the moving mechanism 10 is connected to the container seat 20 and can drive the container seat 20 to lift, and the moving mechanism 10 is connected to the weighing device 30 and can drive the weighing device 30 to translate. Alternatively, the moving mechanism 10 is connected to both the container seat 20 and the weighing device 30 and can drive the container seat 20 and the weighing device 30 to approach or move away from each other in the first direction Z.

In an embodiment, the moving mechanism 10 is connected to the container seat 20 and is configured to drive the container seat 20 to lift in the first direction Z. Optionally, the moving mechanism 10 includes a lifting driving member 12 and a lifting transmission structure 13. The lifting transmission structure 13 is connected to the lifting driving member 12, and is connected to the container seat 20. The lifting driving member 12 is configured to drive the lifting transmission structure 13 to drive the container seat 20 to lift in the first direction Z. Optionally, the lifting transmission structure 13 includes at least one of a lead screw and nut pair, a gear and rack pair, a worm wheel and worm pair, etc., which is not limited.

Optionally, the moving mechanism 10 further includes a lifting seat 11. The lifting driving member 12 is disposed on the lifting seat 11. The lifting seat 11 is configured to fix the lifting driving member 12 and can also be configured to guide the movement of the container seat 20. Optionally, the lifting seat 11 includes a bottom plate 111, a first side-plate 112, and a second side-plate 113. One end of each of the first side-plate 112 and the second side-plate 113 is connected to the bottom plate 111. The first side-plate 112 and the second side-plate 113 are arranged at opposite intervals. Both the first side-plate 112 and the second side-plate 113 extend in the first direction Z. The container seat 20 is disposed between the first side-plate 112 and the second side-plate 113. The container seat 20 is slidably connected to at least one of the first side-plate 112 or the second side-plate 113. Optionally, at least one of a surface of the first side-plate 112 facing the second side-plate 113 and a surface of the second side-plate 113 facing the first side-plate 112 is provided with a slide rail. The slide rail extends in the first direction Z. The container seat 20 is in sliding fit with the slide rail.

Optionally, the lifting seat 11, the lifting driving member 12, and the lifting transmission structure 13 of the moving mechanism 10 may be located on the same side of the container seat 20, such as on one side of the container seat 20 in a length direction (second direction Y) of the container seat 20.

By providing the above powder weighing assembly 100, the automation of the weighing process can be realized, the labor cost can be reduced, and the operation accuracy and efficiency can be improved.

Reference can be made to FIG. 1 to FIG. 4. The moving mechanism 10 is connected to the container seat 20 and is configured to drive the container seat 20 to lift in the first direction Z. The container seat 20 further includes a seat body 23. The seat body 23 is connected to the moving mechanism 10. The first placement structure 21 and the second placement structure 22 are both disposed on the seat body 23. The second placement structure 22 protrudes from one side of the first placement structure 21 away from the weighing device 30, or the second placement structure 22 is flush with the first placement structure 21 in the first direction Z.

The first placement structure 21 is spaced apart from the second placement structure 22 in the first direction Z and/or the second direction Y. The second direction Y intersects with the first direction Z. An extending direction of the source container 3000 on the second placement structure 22 intersects with the first direction Z. An extending direction of the target container 2000 on the first placement structure 21 is parallel to or intersects with the extending direction of the source container 3000 on the second placement structure 22.

The first placement structure 21 and the second placement structure 22 may be arranged at intervals in the first direction Z, so that the source container 3000 and the target container 2000 may be arranged at intervals up and down. Alternatively, the first placement structure 21 and the second placement structure 22 may be arranged at intervals in the second direction Y, so that the source container 3000 and the target container 2000 may be arranged at intervals left and right. Alternatively, the first placement structure 21 and the second placement structure 22 may be arranged at intervals in both the first direction Z and the second direction Y, so that the source container 3000 and the target container 2000 may be staggered in both the up-down direction and the left-right direction. Optionally, the first direction Z may be a height direction of the container seat 20, and the second direction Y may be a length direction or width direction of the container seat 20, which is not limited.

The source container 3000 may be higher than or flush with the target container 2000, so that the powder scooped out from the source container 3000 can be quickly transferred to the target container 2000. The extending direction of the source container 3000 intersects with the first direction Z, for example, the source container 3000 may be in a horizontal state or an inclined state. Preferably, an opening of the source container 3000 is higher than the bottom of the source container 3000, so that the source container 3000 is in an inclined state, thereby facilitating powder scooping and preventing powder from flowing out easily. The target container 2000 may be parallel to the extending direction of the source container 3000, that is, placement directions of the target container 2000 and the source container 3000 are consistent, so that orientations of openings of the target container 2000 and the source container 3000 are consistent, thereby facilitating quick powder transfer. The target container 2000 may intersect with the extending direction of the source container 3000, for example, the extending direction of the target container 2000 is parallel to the first direction Z, or the extending direction of the target container 2000 intersects with the first direction Z but is not parallel to the extending direction of the source container 3000, which is not limited.

In an embodiment, as illustrated in FIG. 1 to FIG. 4, the first placement structure 21 is spaced apart from the second placement structure 22 in both the first direction Z and the second direction Y.

The opening of the source container 3000 faces one side of the opening of the target container 2000. The weighing device 30 is disposed below the seat body 23 in the first direction Z. Optionally, the seat body 23 includes a first support arm 231, a second support arm 232, and a connection plate 233. Both the first support arm 231 and the second support arm 232 extend in the second direction Y and are arranged at intervals opposite to each other. A space between the first support arm 231 and the second support arm 232 defines a placement space 234. The placement space 234 is configured for placement of the target container 2000. The connection plate 233 is connected between the first support arm 231 and the second support arm 232. The connection plate 233 may be slidingly connected to the lifting seat 11 of the moving mechanism 10, and may be connected to the lifting transmission structure 13 of the moving mechanism 10. Each of the first placement structure 21 and the second placement structure 22 is connected to the first support arm 231 and the second support arm 232.

By arranging the first placement structure 21 and the second placement structure 22 on the seat body 23 at intervals, the source container 3000 and the target container 2000 have a spacing distance, and the source container 3000 is located above the target container 2000. Therefore, sufficient operating space and convenience can be provided for scooping powder from the source container 3000 and pouring powder into the target container 2000.

Reference can be made to FIG. 1 to FIG. 4. The first placement structure 21 includes a bottom support 211, a limiting block 212, and a connecting rod 213. The bottom support 211 is spaced apart from the limiting block 212 in the first direction Z. The bottom support 211 is located on one side of the limiting block 212 facing the weighing device 30. The bottom support 211 and/or the limiting block 212 are connected and fixed to the seat body 23. The connecting rod 213 is disposed between the bottom support 211 and the limiting block 212. One end of the connecting rod 213 is connected to the bottom support 211, and the other end of the connecting rod 213 is connected to the limiting block 212. The limiting block 212 defines a limiting hole 2121 for accommodation of the target container 2000. The bottom support 211 is configured to support the target container 2000.

Optionally, the limiting block 212 includes multiple limiting arms 2122 arranged in a circumferential direction. The multiple limiting arms 2122 cooperatively define the limiting hole 2121. Optionally, the limiting block 212 may also have a plate-like structure. The limiting hole 2121 is a through hole extending through the limiting block 212 in the first direction Z, or the limiting hole 2121 is a counterbore with an opening facing away from the weighing device 30, which is not limited.

Optionally, the bottom support 211 is disposed on one side of the first support arm 231 and the second support arm 232 facing the weighing device 30. The limiting block 212 is disposed on the surface of the first support arm 231 and the second support arm 232 facing away from the weighing device 30. One end of the connecting rod 213 is connected to the bottom support 211, and the other end of the connecting rod 213 is connected to at least one of the limiting block 212, the first support arm 231, or the second support arm 232. Both the bottom support 211 and the limiting block 212 at least partially correspond to the placement space 234. The limiting hole 2121 corresponds to the placement space 234. The connecting rod 213 may be rod-shaped or plate-shaped, etc., which is not limited. The bottom support 211 may define a groove, and a shape of the groove may be adapted to a shape of the bottom of the target container 2000. The target container 2000 can pass through the limiting hole 2121 and the bottom of the target container 2000 abuts against the bottom support 211, so that the target container 2000 is disposed in the first direction Z, and the partial structure of the target container 2000 is limited in the placement space 234, so as to prevent the target container 2000 from falling.

Optionally, the bottom support 211 includes a bearing portion 2111 and a contact portion 2112. The contact portion 2112 is connected to the bearing portion 2111. The bearing portion 2111 is opposite to the limiting hole 2121 in the first direction Z. The bearing portion 2111 is configured for bearing of the target container 2000. The contact portion 2112 is configured to be in contact with the weighing device 30. Optionally, the second placement structure 22 is disposed on the surface of the limiting block 212 facing away from the bottom support 211, and is located on one side of the limiting hole 2121 facing the connection plate 233.

Optionally, the seat body 23 and the limiting block 212 may be of an integrated structure, for example, the seat body 23 and the limiting block 212 together form a plate-shaped structure. Optionally, multiple limiting holes 2121 may be defined on the limiting block 212, and correspondingly, grooves whose number and positions correspond to the number and positions of the limiting holes 2121 are defined on the bottom support 211, so that multiple target containers 2000 can be placed at the same time to improve the experimental throughput.

To facilitate taking the target container 2000 after powder pouring, the limiting block 212 only fixes the target container 2000 through forces such as friction and thrust, and the target container 2000 can be separated from the limiting block 212 when subjected to a force away from the weighing device 30 in the first direction Z. When weighing the container seat 20, it is necessary to avoid contact between the weighing device 30 and the target container 2000. Therefore, by providing the bottom support 211 and the connecting rod 213, the weighing device 30 is only in contact with the bottom support 211 when weighing the container seat 20, which does not affect the position and stress state of the target container 2000, thereby ensuring the weighing accuracy.

Reference can be made to FIG. 1 to FIG. 4. The second placement structure 22 includes a first stand 221 and a second stand 222. The first stand 221 and the second stand 222 are disposed on the seat body 23 at intervals in the second direction Y. One end of the first stand 221 away from the seat body 23 defines a first accommodating groove 2211. One end of the second stand 222 away from the seat body 23 defines a second accommodating groove 2221. The first accommodating groove 2211 and the second accommodating groove 2221 are configured for collective accommodation of the source container 3000.

Optionally, the bottom wall surfaces of the first accommodating groove 2211 and the second accommodating groove 2221 are both located above the target container 2000 in the first direction Z, so as to provide sufficient operating space for scooping powder from the source container 3000 and pouring powder into the target container 2000.

Optionally, both the first accommodating groove 2211 and the second accommodating groove 2221 are flared, which facilitates placement of the source container 3000 into the first accommodating groove 2211 and the second accommodating groove 2221, reduces the positioning accuracy required for placing the source container 3000, and also facilitates compatibility with source containers 3000 of different sizes. Optionally, the second placement structure 22 further includes a connecting block. The connecting block is connected to the first stand 221 and the second stand 222. The connecting block is connected to the seat body 23 or the limiting block 212.

Optionally, the first stand 221, the second stand 222, and the connecting block are of an integrated structure. Optionally, the first stand 221, the second stand 222, and the connecting block are all disposed on the aforementioned limiting block 212. Therefore, the first placement structure 21 and the second placement structure 22 can be mounted on the container seat 20 with only one fixing operation.

By providing the aforementioned second placement structure 22, the source container 3000 can be placed in both the first accommodating groove 2211 and the second accommodating groove 2221 at the same time, so that when the source container 3000 is of a rotationally symmetric structure or a cylindrical structure with a smaller equivalent diameter, it is difficult for the source container 3000 to roll off from the first stand 221 and the second stand 222, thereby improving the stability and reliability of the powder weighing assembly 100.

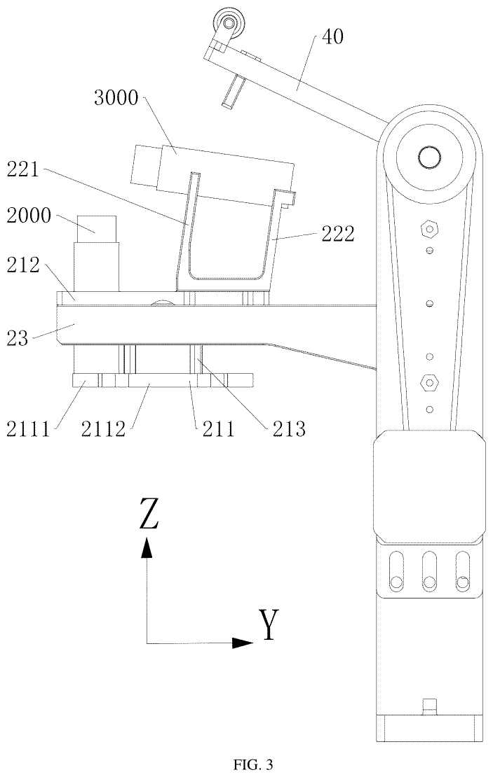

Reference can be made to FIG. 3. In the second direction Y, a distance between the first stand 221 and the first placement structure 21 is less than a distance between the second stand 222 and the first placement structure 21. In the first direction Z, a distance between the first accommodating groove 2211 and the first placement structure 21 is greater than a distance between the second accommodating groove 2221 and the first placement structure 21.

The opening of the source container 3000 is located on one side of the first stand 221 facing away from the second stand 222, so that the opening of the source container 3000 orients obliquely upward, so as to prevent powder from flowing out of the source container 3000. The target container 2000 is disposed in the first direction Z and the opening of the target container 2000 faces the side of the source container 3000, and the opening of the source container 3000 is higher than the opening of the target container 2000. Such an arrangement can improve the convenience and efficiency of powder transfer, and also reduce the amount of powder loss caused by powder spilling during powder transfer. Optionally, both the first stand 221 and the second stand 222 are disposed obliquely on the container seat 20. In a specific embodiment, the surface of the seat body 23 facing away from the weighing device 30 is on the horizontal plane, and both the first stand 221 and the second stand 222 are disposed obliquely in a direction away from the first placement structure 21 to provide sufficient operating space for placing and taking the target container 2000.

By limiting the relative positions and sizes of the first stand 221 and the second stand 222, the source container 3000 on the second placement structure 22 is disposed obliquely relative to the horizontal plane, thereby facilitating the powder scooping operation on the source container 3000 and avoiding powder from flowing out of the source container 3000.

It can be understood that the above is a preferred example of the first placement structure 21 and the second placement structure 22. The first placement structure 21 and the second placement structure 22 may also be configured into other structures, which are not limited by the present disclosure. When the first placement structure 21 is spaced apart from the second placement structure 22 in the second direction Y, the specific implementation of the first placement structure 21 can refer to the specific implementation of the aforementioned second placement structure 22, which is not limited.

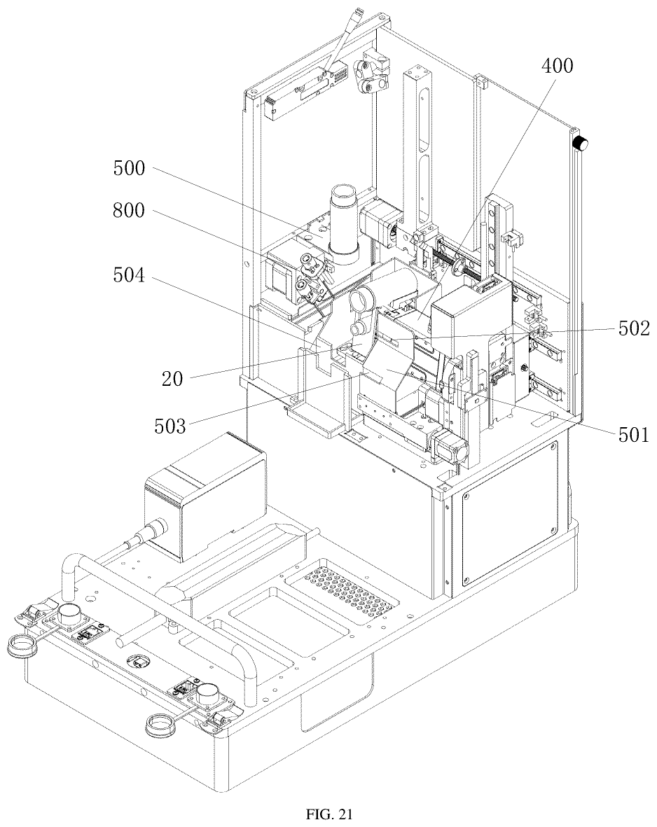

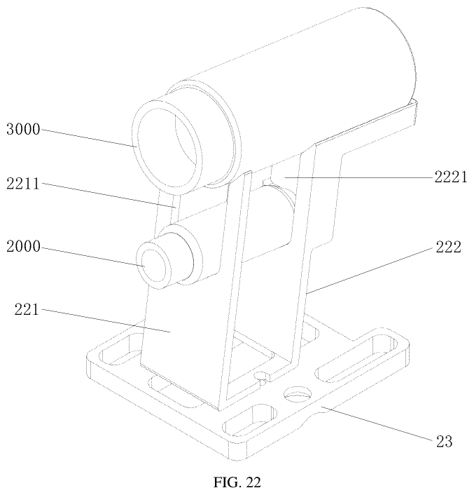

In an embodiment, as illustrated in FIG. 21 and FIG. 22, the first placement structure 21 is spaced apart from the second placement structure 22 in the first direction Z.

The container seat 20 further includes a first stand 221 and a second stand 222. The first stand 221 and the second stand 222 are disposed on the seat body 23 at intervals in the second direction Y. The first stand 221 defines a first accommodating groove 2211 from one end of the first stand 221 away from the seat body 23 toward the other end of the first stand 221 close to the seat body 23. The second stand 222 defines a second accommodating groove 2221 from one end of the second stand 222 away from the seat body 23 toward the other end of the second stand 222 close to the seat body 23. One end of the first accommodating groove 2211 close to the seat body 23 and one end of the second accommodating groove 2221 close to the seat body 23 jointly form the first placement structure 21, and are configured for collective accommodation of the target container 2000. The other end of the first accommodating groove 2211 away from the seat body 23 and the other end of the second accommodating groove 2221 away from the seat body 23 jointly form the second placement structure 22, and are configured for collective accommodation of the source container 3000.

In the first direction Z, a distance between the end of the first accommodating groove 2211 close to the seat body 23 and the seat body 23 is greater than a distance between the end of the second accommodating groove 2221 close to the seat body 23 and the seat body 23. A distance between the other end of the first accommodating groove 2211 away from the seat body 23 and the seat body 23 is greater than a distance between the other end of the second accommodating groove 2221 away from the seat body 23 and the seat body 23. The opening of the source container 3000 and the opening of the target container 2000 are both located on one side of the first stand 221 facing away from the second stand 222.

Both the first accommodating groove 2211 and the second accommodating groove 2221 may be of a U-like structure or a V-like structure, which is not limited. From the end of the first accommodating groove 2211 away from the seat body 23 to the end of the first accommodating groove 2211 close to the seat body 23, the size of the first accommodating groove 2211 may be constant or gradually decrease. The same is true for the second accommodating groove 2221.

The target container 2000 is located below the source container 3000. The orientations of the openings of the target container 2000 and the source container 3000 are consistent and are both inclined upward. Compared with the aforementioned case where the target container 2000 is placed vertically in the first direction Z, thanks to the obliquely placed target container 2000, powder can be easily scooped out from the target container 200 when the powder is added in excess, and the probability of pouring the powder outside the target container 2000 can be reduced.

Optionally, the extending direction of the target container 2000 is parallel to the extending direction of the source container 3000, and the target container 2000 is located directly below the source container 3000. With such an arrangement, powder transfer can be quickly realized without changing the operating direction of the powder scooping mechanism, the control logic can be simplified, and the transfer path can be shortened. In addition, the space occupation ratio of the structure can also be reduced, so that the structure can be more compact.

Optionally, the first stand 221 and the second stand 222 may be connected and fixed to the seat body 23, such as by means of welding, screwing, bonding, etc., to achieve connection and fixation; or may be detachably connected to the seat body 23, such as through positioning pins, buckles, magnetic attraction, etc., to achieve detachable connection, which is not limited. Optionally, the first stand 221, the second stand 222, and the seat body 23 may be of an integrated structure. The integrated structure may be detachably connected to the moving mechanism 10, such as through positioning pins, buckles, magnetic attraction, etc., to achieve detachable connection, without limitation, thereby facilitating the quick picking, placing, and replacement of the target container 2000 and the source container 3000.

Reference can be made to FIG. 1 to FIG. 4, the powder weighing assembly 100 further includes a tube pressing mechanism 40. The tube pressing mechanism 40 is configured to press the source container 3000 against the second placement structure 22. The tube pressing mechanism 40 includes a tube pressing driving member 41, a tube pressing transmission member 42, and a tube pressing arm 43. The tube pressing transmission member 42 is connected to the tube pressing driving member 41 and the tube pressing arm 43. The tube pressing driving member 41 is configured to drive the tube pressing arm 43 to move through the tube pressing transmission member 42. One end of the tube pressing arm 43 away from the tube pressing transmission member 42 is configured to press the source container 3000 against the second placement structure 22.

When no source container 3000 is placed on the second placement structure 22, the tube pressing arm 43 is separated from the second placement structure 22. When the source container 3000 is placed on the second placement structure 22, the tube pressing driving member 41 drives the tube pressing arm 43 to move toward the source container 3000 through the tube pressing transmission member 42 so that the tube pressing arm 43 presses the source container 3000. When the source container 3000 needs to be removed from the second placement structure 22, the tube pressing driving member 41 drives the tube pressing arm 43 to move away from the source container 3000 through the tube pressing transmission member 42 so that the tube pressing arm 43 releases the source container 3000.

Optionally, the tube pressing driving member 41 is an electric machine, an air cylinder, etc. Optionally, the tube pressing transmission member 42 includes any one or a combination of a connecting rod, a lead screw and nut pair, a belt and pulley pair, a gear and rack pair, a worm wheel and worm pair, etc., without limitation. Optionally, the part of the tube pressing arm 43 used to contact the source container 3000 is provided with a buffer structure (not shown) such as a rubber layer, a silicone layer, a sponge layer, or a felt layer, to prevent damage to the source container 3000 when the tube pressing arm 43 presses the source container 3000.

By providing the tube pressing mechanism 40, the source container 3000 does not detach from the second placement structure 22 due to the powder scooping operation or when the container seat 20 moves in the first direction Z, thereby ensuring stability and reliability of the powder weighing assembly 100.

Reference can be made to FIG. 1 to FIG. 4. The tube pressing arm 43 includes a tube pressing plate 431 and a tube pressing head 432. One end of the tube pressing plate 431 is connected and fixed to the tube pressing transmission member 42. The tube pressing head 432 is disposed at one end of the tube pressing plate 431 away from the tube pressing transmission member 42 and on one side of the tube pressing plate 431 facing the second placement structure 22. The tube pressing head 432 has a pressing surface 4321. The pressing surface 4321 is configured to press against a sidewall of the source container 3000, to enable the tube pressing head 432 to press the source container 3000.

The tube pressing head 432 is connected to the end of the tube pressing plate 431 away from the tube pressing transmission member 42, and when the tube pressing head 432 presses against the source container 3000, the tube pressing head 432 is located at the middle position of the aforementioned first stand 221 and second stand 222, so as to prevent the source container 3000 from being displaced due to uneven force on both ends of the source container 3000.

Optionally, the tube pressing plate 431 defines multiple structural holes 4311 for weight reduction, so as to reduce the torque of the tube pressing driving member 41 and the structural strength requirement of the tube pressing transmission member 42, and prolong the service life. Optionally, the tube pressing head 432 defines a tube pressing groove 4322. The pressing surface 4321 is a groove wall of the tube pressing groove 4322. The tube pressing groove 4322 is flared, so as to reduce the assembly precision requirement and manufacturing precision requirement of the tube pressing head 432. Optionally, a buffer structure (not shown) such as a rubber layer, a silicone layer, or a felt layer is provided on the pressing surface 4321, so as to prevent the tube pressing head 432 from damaging the source container 3000 when pressing against the source container 3000. Optionally, the tube pressing plate 431 and the tube pressing head 432 may be detachably connected by means of snapping, screwing, riveting, etc., so as to replace the corresponding tube pressing head 432 according to source containers 3000 of different sizes.

By providing the tube pressing arm 43 to compress the source container 3000, the source container 3000 does not detach from the second placement structure 22 due to the powder scooping operation or when the container seat 20 moves in the first direction Z, thereby ensuring the stability and reliability of the powder weighing assembly 100.

Reference can be made to FIG. 1 to FIG. 4. The tube pressing mechanism 40 further includes a first support plate 44 and a second support plate 45. The first support plate 44 and the second support plate 45 are located on opposite sides of the container seat 20 (such as the seat body 23 of the container seat 20) and are adjacent to the second placement structure 22. The tube pressing transmission member 42 includes a tube pressing transmission structure 421 and a rotating shaft 422. The tube pressing transmission structure 421 is connected to the tube pressing driving member 41 and the rotating shaft 422. The tube pressing driving member 41 is disposed on the first support plate 44 or the second support plate 45, and is configured to drive the rotating shaft 422 to rotate through the tube pressing transmission structure 421. The rotating shaft 422 is located between the first support plate 44 and the second support plate 45. Two ends of the rotating shaft 422 are respectively rotatably connected to the first support plate 44 and the second support plate 45. The tube pressing arm 43 is connected and fixed to the rotating shaft 422.

Optionally, the tube pressing transmission structure 421 includes but is not limited to any one or a combination of a belt and pulley pair, a connecting rod, a lead screw and nut pair, a gear and rack pair, a worm wheel and worm pair, etc. Optionally, one end of the rotating shaft 422 is rotatably connected to the first support plate 44, and the other end of the rotating shaft 422 is rotatably connected to the second support plate 45. The tube pressing transmission structure 421 may be disposed between the first support plate 44 and the second support plate 45, or may be disposed on the side opposite to both the first support plate 44 and the second support plate 45. The tube pressing transmission structure 421 is connected to the aforementioned tube pressing driving member 41 and connected to the rotating shaft 422, so that the tube pressing driving member 41 drives the rotating shaft 422 to rotate through the tube pressing transmission structure 421, and the rotating shaft 422 then drives the tube pressing arm 43 to rotate.

Optionally, the first support plate 44 is connected to one end of the aforementioned first side-plate 112 away from the bottom plate 111, and/or, the first support plate 44 and the first side-plate 112 are the same structure, and/or, the second support plate 45 is connected to the end of the aforementioned second side-plate 113 away from the bottom plate 111, and/or, the second support plate 45 and the second side-plate 113 are the same structure, which is not limited.

By providing the aforementioned tube pressing mechanism 40, the space occupation of the tube pressing mechanism 40 in the second direction Y is saved, and the arrangement of the tube pressing transmission structure 421 enables the tube pressing driving member 41 to be mounted according to the space occupation and heat dissipation conditions, thereby greatly improving the layout rationality and structural compactness of the powder weighing assembly 100.

Reference can be made to FIG. 1 to FIG. 4. The tube pressing arm 43 is located on one side of the second placement structure 22 facing away from the weighing device 30. For example, the tube pressing arm 43 is located on one side of the aforementioned container seat 20 facing away from the bottom plate 111. With such an arrangement, the tube pressing arm 43 can press against the source container 3000 from above the source container 3000, and the tube pressing arm 43 and the second placement structure 22 can cooperate to fix the source container 3000, thereby simplifying the structure of the tube pressing arm 43.

Optionally, the moving mechanism 10 is located between the first support plate 44 and the second support plate 45, and is located on one side of the tube pressing arm 43 facing the weighing device 30. With such an arrangement, not only can space layout be saved, but also the rotation of the tube pressing arm 43 does not interfere with the lifting movement of the moving mechanism 10.

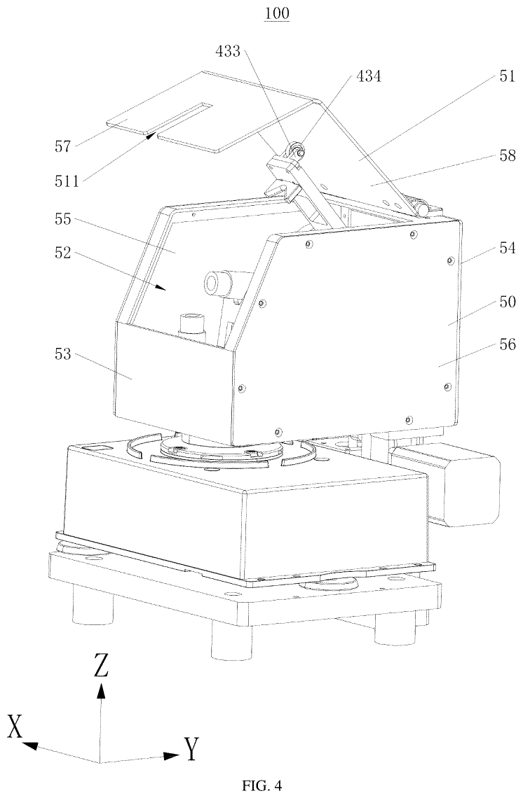

Reference can be made to FIG. 4. The powder weighing assembly 100 further includes a box body 50 and a box cover 51. The box body 50 defines a cavity 52 with an opening. The moving mechanism 10, the container seat 20, the weighing device 30, and the tube pressing mechanism 40 are all accommodated in the cavity 52. The box cover 51 is movably connected to the box body 50 to open or close the opening of the cavity 52. The movable connection between the box cover 51 and the box body 50 may be a rotational connection or a sliding connection, etc., which is not limited.

Optionally, the box body 50 includes a first plate body 53, a second plate body 54, a third plate body 55, and a fourth plate body 56. The first plate body 53 and the second plate body 54 are arranged at opposite intervals in the second direction Y. The third plate body 55 and the fourth plate body 56 are arranged at opposite intervals in the third direction X. Each of the first plate body 53 and the second plate body 54 is connected between the third plate body 55 and the fourth plate body 56, and the first plate body 53, the second plate body 54, the third plate body 55, and the fourth plate body 56 cooperatively define the cavity 52. The height of the first plate body 53 in the first direction Z is smaller than the height of each of the second plate body 54, the third plate body 55, and the fourth plate body 56 in the first direction Z, so as to define the opening of the cavity 52.

Optionally, the box cover 51 includes a fifth plate body 57 and a sixth plate body 58. The fifth plate body 57 is connected to and angled relative to the sixth plate body 58. The sixth plate body 58 is movably connected to at least one of the second plate body 54, the third plate body 55, or the fourth plate body 56. The fifth plate body 57 is configured to cooperate with the first plate body 53, the third plate body 55, and the fourth plate body 56 to close the opening of the cavity 52.

By providing the aforementioned box body 50 and box cover 51, when the box cover 51 is opened, it is convenient to take and place the source container 3000 and scoop powder, and to take and place the target container 2000 and pour powder; and when the box cover 51 is closed, the weighing device 30 can be isolated from the outside, and external environmental factors can be prevented from affecting the weighing accuracy of the weighing device 30.

Reference can be made to FIG. 3 and FIG. 4. The box cover 51 is rotatably connected to the box body 50. The tube pressing arm 43 further includes an abutting head 433. The abutting head 433 is disposed on one side of the tube pressing plate 431 facing away from the tube pressing head 432. The abutting head 433 is configured to abut against the box cover 51 and drive the box cover 51 to rotate under the driving of the tube pressing plate 431, so as to open or close the opening of the cavity 52.

The box cover 51 abuts against the abutting head 433 under the action of gravity. When the aforementioned tube pressing driving member 41 drives the tube pressing arm 43 to rotate, the box cover 51 rotates synchronously with the tube pressing arm 43 under the action of gravity to close the opening of the cavity 52, or rotates under the pushing force of the abutting head 433 to open the opening of the cavity 52. Optionally, the abutting head 433 and the tube pressing plate 431 may be of an integrated structure, or may be detachably connected by means of snapping, screwing, riveting, etc., without limitation.

It can be understood that the abutting head 433 may have no physical connection relationship with the box cover 51, and the abutting head 433 is driven by the tube pressing plate 431 to contact and abut against the box cover 51 to drive the box cover 51 to move. Alternatively, the abutting head 433 may be directly connected to the box cover 51, and the tube pressing plate 431 drives the abutting head 433 to move so that the box cover 51 moves synchronously.

By providing the aforementioned abutting head 433 to drive the box cover 51 to rotate to open or close the opening of the cavity 52, the box cover 51 can be driven to fall to close the opening of the cavity 52 when the tube pressing arm 43 presses against the source container 3000. Therefore, there is no need to additionally provide an electric machine or other driving structure to drive the box cover 51 separately, thereby reducing the equipment cost, simplifying the equipment structure, and improving the operating efficiency and the integration of the equipment.

Reference can be made to FIG. 3 and FIG. 4. The abutting head 433 includes a roller 434. The roller 434 is rotatably connected to the tube pressing plate 431. The roller 434 abuts against the box cover 51 and can rotate relative to the box cover 51 when the box cover 51 rotates. Optionally, the outer ring of the roller 434 may be provided with an elastic pad, and the elastic pad may be made of materials such as rubber, plastic or nylon, to prevent the roller 434 from damaging the box cover 51 when rotating relative to the box cover 51.

Optionally, the abutting head 433 may further include a rotating shaft. Both ends of the rotating shaft are rotatably connected to the tube pressing plate 431. The middle part of the rotating shaft is connected and fixed to the roller 434. The rotating connection between the roller 434 and the tube pressing plate 431 can be realized through the rotating shaft.

By providing the aforementioned abutting head 433 with the roller 434, when the abutting head 433 drives the box cover 51 to rotate, the contact area between the abutting head 433 and the box cover 51 can be reduced, the friction between the abutting head 433 and the box cover 51 can be reduced, so that the movement of the box cover 51 can be smoother.

Reference can be made to FIG. 4. The box cover 51 defines a notch 511. When the box cover 51 closes the opening of the cavity 52, the notch 511 corresponds to the source container 3000 and the target container 2000. Optionally, the notch 511 extends to a surface of the fifth plate 57 facing away from the sixth plate 58 to expand the operable space. Optionally, the notch 511 is defined at one end of the aforementioned fifth plate 57 away from the sixth plate 58. Optionally, both the width and length of the notch 511 are at least larger than the opening size of each of the source container 3000 and the target container 2000, thereby facilitating the scoop to extend into the source container 3000 and the target container 2000 through the notch 511 without obstruction for powder transfer operation.

By defining the notch 511 on the box cover 51, when the box cover 51 closes the opening of the cavity 52, the notch 511 corresponds to the source container 3000 and the target container 2000, so that the powder transfer between the source container 3000 and the target container 2000 can be established without opening the box cover 51, thereby avoiding adverse effects of external environmental factors on powder transfer and weighing operations, and improving powder transfer accuracy.

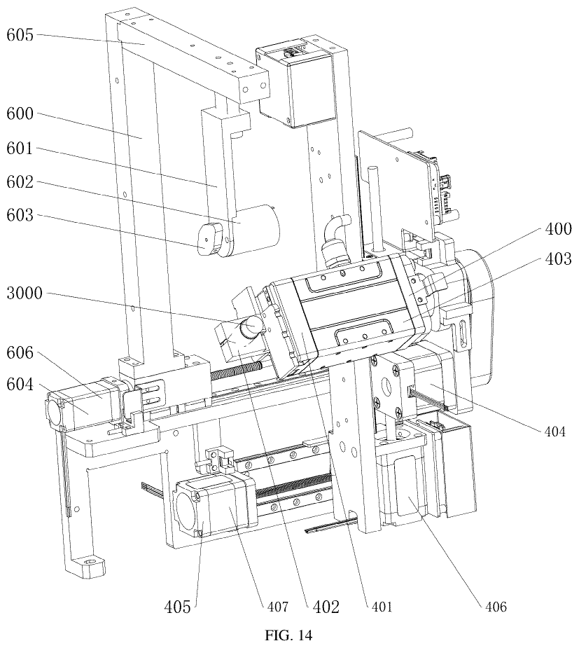

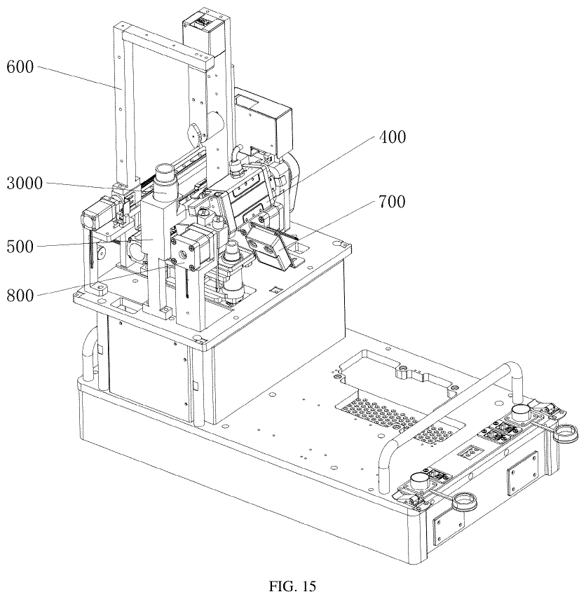

Reference can be made to FIG. 14 and FIG. 15. The powder weighing assembly 100 further includes a tube clamping mechanism 400. The tube clamping mechanism 400 is configured to pick and place the target container 2000 on the first placement structure 21 and/or pick and place the source container 3000 on the second placement structure 22. The tube clamping mechanism 400 includes a clamping assembly 401, a rotating assembly 404, and a first moving assembly 405. The rotating assembly 404 is connected to the clamping assembly 401 and the first moving assembly 405. The first moving assembly 405 is configured to drive the rotating assembly 404 and the clamping assembly 401 to move synchronously. The rotating assembly 404 is configured to drive the clamping assembly 401 to rotate. The clamping assembly 401 is configured to clamp the target container 2000 and/or the source container 3000.

During the powder scooping process, the clamping assembly 401 can always clamp the source container 3000 to prevent the source container 3000 from falling or shifting. During the weighing process, the clamping assembly 401 can place the source container 3000 on the second placement structure 22 and release the source container 3000, so as to prevent affecting the weighing result of the weighing device 30. During the loading-and-unloading process, the tube clamping mechanism 400 can transfer the target container 2000 from the temporary storage position to the first placement structure 21, and can also transfer the target container 2000 from the first placement structure 21 back to the temporary storage position. The tube clamping mechanism 400 can transfer the source container 3000 from the temporary storage position to the second placement structure 22, and can also transfer the source container 3000 from the second placement structure 22 back to the temporary storage position.

Optionally, the clamping assembly 401 includes a clamping member 402 and a clamping driving member 403. The clamping driving member 403 is connected to the clamping member 402 and the rotating assembly 404. The clamping driving member 403 is configured to drive the clamping member 402 to perform opening and closing actions to clamp or release the source container 3000. Optionally, the clamping driving member 403 may be an air cylinder, a hydraulic cylinder, a stepping electric machine, a linear electric machine, etc., without limitation. Optionally, the clamping driving member 403 may be in transmission connection with the clamping member 402 through a connecting rod transmission structure, a gear transmission structure, etc., without limitation. The clamping member 402 may be two oppositely arranged clamping blocks. The two clamping blocks both have clamping surfaces on the opposite sides of the two clamping blocks. The two clamping surfaces interact to clamp the source container 3000. The clamping surface may be of a V-shaped, arc-shaped or other structures, without limitation.

Optionally, in order to improve the rationality of the movement path of the powder weighing assembly 100 and the convenience of powder scooping operation, the source container 3000 may be inclined at a certain angle when located on the second placement structure 22. Therefore, the rotating assembly 404 is caused to drive the clamping member 402 to rotate, so that the clamping assembly 401 can rotate at different angles under the driving of the rotating assembly 404, thereby facilitating the clamping assembly 401 to clamp the source container 3000 or drive the source container 3000 to be placed on the second placement structure 22 or other structures. Optionally, the rotating assembly 404 may include a rotary electric machine and a transmission mechanism. The rotary electric machine drives the clamping assembly 401 to rotate through the transmission mechanism. The transmission mechanism may be a synchronous pulley transmission mechanism, a gear transmission mechanism, etc., without limitation.

Optionally, in order to improve the space utilization rate of the powder weighing assembly 100, the distribution positions and sizes of the various components of the powder weighing assembly 100 are different. Therefore, the first moving assembly 405 is provided to drive the rotating assembly 404 and the clamping assembly 401 to perform translational movement, lifting movement, or composite movement synchronously, without limitation, so that the clamping assembly 401 can drive the source container 3000 to move to different horizontal positions and/or height positions.

In an embodiment, the first moving assembly 405 includes a first lifting assembly 406. The first lifting assembly 406 is connected to the rotating assembly 404. The first lifting assembly 406 is configured to drive the rotating assembly 404 and the clamping assembly 401 to lift synchronously, so that the clamping assembly 401 can drive the source container 3000 to perform powder scooping operation, weighing operation, or transfer operation at different heights. Optionally, the first lifting assembly 406 may be an air cylinder, a hydraulic cylinder, a linear electric machine, etc., without limitation.

In another embodiment, the first moving assembly 405 includes a first translation assembly 407. The first translation assembly 407 is connected to the rotating assembly 404. The first translation assembly 407 is configured to drive the rotating assembly 404 and the clamping assembly 401 to translate synchronously, so that the clamping assembly 401 can drive the source container 3000 to perform powder scooping operation, weighing operation, or transfer operation at different horizontal positions. Optionally, the first translation assembly 407 may be an air cylinder, a hydraulic cylinder, a linear electric machine, etc., without limitation.

Preferably, the first moving assembly 405 includes a first lifting assembly 406 and a first translation assembly 407. The first lifting assembly 406 is connected to the first translation assembly 407 and the rotating assembly 404. The first lifting assembly 406 and the first translation assembly 407 can drive the clamping assembly 401 to perform translational movement, lifting movement, or composite movement, so as to improve the flexibility of the clamping assembly 401.

By providing the aforementioned tube clamping mechanism 400, the powder weighing assembly 100 can transfer the target container 2000 and/or the source container 3000 through the tube clamping mechanism 400, and can replace the aforementioned tube pressing mechanism 40 to fix the source container 3000 during the powder scooping process. In this process, the movement path of the tube clamping mechanism 400 is relatively short and the movement range is relatively small, which is beneficial to improving the operating efficiency and space utilization of the powder weighing assembly 100.

Reference can be made to FIG. 14 and FIG. 15. The powder weighing assembly 100 further includes a buffer seat 500. The buffer seat 500 is configured to temporarily store the source container 3000 and/or the target container 2000. The tube clamping mechanism 400 is also configured to pick and place the source container 3000 and/or the target container 2000 on the buffer seat 500.

Optionally, the buffer seat 500 and the tube clamping mechanism 400 are respectively located on opposite sides of the container seat 20 and are adjacent to the second placement structure 22.

Exemplarily, during the process of the powder weighing assembly 100 scooping and weighing powder from one source container 3000, another source container 3000 containing powder to-be-transferred can be placed on the buffer seat 500. After the powder to-be-transferred in the source container 3000 currently being scooped and weighed is exhausted and the source container 3000 is taken out, the tube clamping mechanism 400 can transfer said another source container 3000 containing the powder to-be-transferred on the buffer seat 500 to the second placement structure 22 to continue operations such as powder scooping and weighing, thereby shortening the transfer path of the source container 3000 and further improving the operating efficiency of the powder weighing assembly 100. In another example, since the second placement structure 22 has a certain inclination angle, a loading-and-unloading manipulator 90 cannot place the source container 3000 on the second placement structure 22 at one time due to the limitation of degrees of freedom. Therefore, the source container 3000 can first be placed on the buffer seat 500 by the loading-and-unloading manipulator 90, and then transferred from the buffer seat 500 to the second placement structure 22 by the tube clamping mechanism 400. When the source container 3000 needs to be removed, the source container 3000 is first transferred from the second placement structure 22 to the buffer seat 500 by the tube clamping mechanism 400, and then the source container 3000 is taken away from the buffer seat 500 by the loading-and-unloading manipulator 90. Optionally, the source container 3000 can be placed on the buffer seat 500 by inserting, snapping, or other manners, so as to prevent the source container 3000 from falling.

Reference can be made to FIG. 14 and FIG. 15. The powder weighing assembly 100 further includes a powder vibration mechanism 600. The powder vibration mechanism 600 includes a mounting arm 601, a powder vibration driving member 602, and a powder vibration member 603. The powder vibration driving member 602 is connected to the mounting arm 601 and the powder vibration member 603. When the powder vibration member 603 is in contact with the source container 3000, the powder vibration driving member 602 is configured to drive the powder vibration member 603 to move, so as to enable the source container 3000 to vibrate.

Optionally, the powder vibration driving member 602 includes at least one of a rotary electric machine or a vibration motor, and the powder vibration member 603 includes at least one of a cam, a tapping rod, or a whip. When the powder vibration driving member 602 is a rotary electric machine, the powder vibration member 603 may be configured as a cam, a tapping rod, a whip, or other structures. The powder vibration driving member 602 drives the powder vibration member 603 to swing or rotate so that the powder vibration member 603 taps or strikes the source container 3000, so that the powder to-be-transferred adhered to the inner wall of the source container 3000 falls off, thereby improving material utilization. When the powder vibration driving member 602 is a vibration motor, the powder vibration driving member 602 can drive the powder vibration member 603 to vibrate to drive the source container 3000 to vibrate, so that the powder to-be-transferred adhered to the inner wall of the source container 3000 falls off, thereby improving material utilization.

In an embodiment, the aforementioned tube clamping mechanism 400 is configured to drive the source container 3000 to move to a position close to the powder vibration member 603 or bring the source container 3000 into contact with the powder vibration member 603, for powder vibration operation.

In another embodiment, the powder vibration mechanism 600 further includes a second moving assembly 604. The second moving assembly 604 is connected to the mounting arm 601. The second moving assembly 604 is configured to drive the mounting arm 601, the powder vibration driving member 602, and the powder vibration member 603 to move synchronously.

In order to improve the space utilization of the powder weighing assembly 100, the distribution positions and sizes of the components of the powder weighing assembly 100 are different. Therefore, the second moving assembly 604 is provided and configured to drive the mounting arm 601, the powder vibration driving member 602, and the powder vibration member 603 to perform translational movement, lifting movement, or composite movement synchronously, without limitation, so that the powder vibration member 603 can perform powder vibration operation when approaching the source container 3000, and after the powder vibration operation is completed, powder scooping and weighing operations can continue to be performed on the source container 3000 while the powder vibration member 603 moves away from the source container 3000, thereby improving operating efficiency.

Specifically, in an embodiment, the second moving assembly 604 includes a second lifting assembly 605. The second lifting assembly is connected to the mounting arm 601. The second lifting assembly 605 is configured to drive the mounting arm 601, the powder vibration driving member 602, and the powder vibration member 603 to lift synchronously. Therefore, the powder vibration member 603 can move downward under the driving of the second lifting assembly 605 to approach the source container 3000 for powder vibration operation, and can rise to the original position after the powder vibration is completed. In addition, the powder scooping and weighing operations can continue to be performed on the source container 3000 while the powder vibration member 603 is rising, thereby improving operating efficiency and reducing the horizontal space occupation of the powder vibration mechanism 600. Optionally, the second lifting assembly 605 may be an air cylinder, a hydraulic cylinder, a linear electric machine, etc., without limitation.

In an embodiment, the second moving assembly 604 includes a second translation assembly 606. The second translation assembly 606 is connected to the mounting arm 601. The second translation assembly 606 is configured to drive the mounting arm 601, the powder vibration driving member 602, and the powder vibration member 603 to translate synchronously. Therefore, the powder vibration member 603 can translate close to the source container 3000 under the driving of the second translation assembly 606 to perform powder vibration operation, and translate back to the original position after powder vibration is completed. In addition, the powder scooping and weighing operations can continue to be performed on the source container 3000 while the powder vibration member 603 is moving away, thereby improving operating efficiency and reducing the space occupation of the powder vibration mechanism 600 in the vertical direction. Optionally, the second translation assembly 606 may be an air cylinder, a hydraulic cylinder, a linear electric machine, etc., which is not limited.

In an embodiment, the second moving assembly 604 includes a second lifting assembly 605 and a second translation assembly 606. The second lifting assembly 605 is connected to the second translation assembly 606 and the mounting arm 601. The second lifting assembly 605 and the second translation assembly 606 can cooperate to drive the mounting arm 601, the powder vibration driving member 602, and the powder vibration member 603 to perform translational movement, lifting movement, or composite movement synchronously, so as to improve the flexibility of the powder vibration mechanism 600.

By providing the aforementioned powder vibration mechanism 600, the powder to-be-transferred adhered to the inner wall of the source container 3000 can be detached under the striking or vibration of the powder vibration member 603, thereby improving the material utilization rate of the powder to-be-transferred.

Reference can be made to FIG. 14 to FIG. 16. The powder weighing assembly 100 further includes a box body 50 and a box cover 51. The box body 50 defines a cavity 52 with an opening. The moving mechanism 10, the container seat 20, and the weighing device 30 are all accommodated in the cavity 52. The box cover 51 is movably connected to the box body 50 to open or close the opening of the cavity 52.

Optionally, the movable connection between the box cover 51 and the box body 50 may be a rotational connection or a sliding connection, etc., which is not limited. The aforementioned tube pressing mechanism 40, tube clamping mechanism 400, and/or powder vibration mechanism 600 may also be accommodated in the cavity 52, which is not limited.

In an embodiment, the second moving assembly 604 can drive the box cover 51 to perform at least one of lifting, translation, or rotation relative to the box body 50, so as to realize the opening and closing of the box cover 51. Exemplarily, the box cover 51 is connected to the mounting arm 601, and the second translation assembly 606 of the second moving assembly 604 drives the box cover 51 to translate relative to the box body 50. The opening and closing actions of the box cover 51 are driven by the second moving assembly 604 of the powder vibration mechanism 600, so that there is no need to additionally provide an electric machine or other driving structures to drive the box cover 51 separately, thereby reducing the equipment cost, simplifying the equipment structure, and improving the operating efficiency and the integration degree of the equipment.

It can be understood that a driving structure may also be additionally provided to independently drive the box cover 51 to move, so as to reduce the equipment coupling degree. The powder vibration mechanism 600 may be disposed inside the box body 50 or outside the box body 50, which is not limited. When the powder vibration mechanism 600 is disposed outside the box body 50, the powder vibration mechanism 600 may be disposed away from the weighing device 30, so as to prevent the powder vibration mechanism 600 from affecting the weighing accuracy of the weighing device 30. Before placing the source container 3000 on the container seat 20, the source container 3000 is first transferred to the powder vibration mechanism 600 for powder vibration, and then the source container 3000 is placed on the container seat 20. The powder vibration mechanism 600 may be an ultrasonic vibration mechanism, a combined mechanism of a rotary electric machine and a cam, etc., which is not limited.

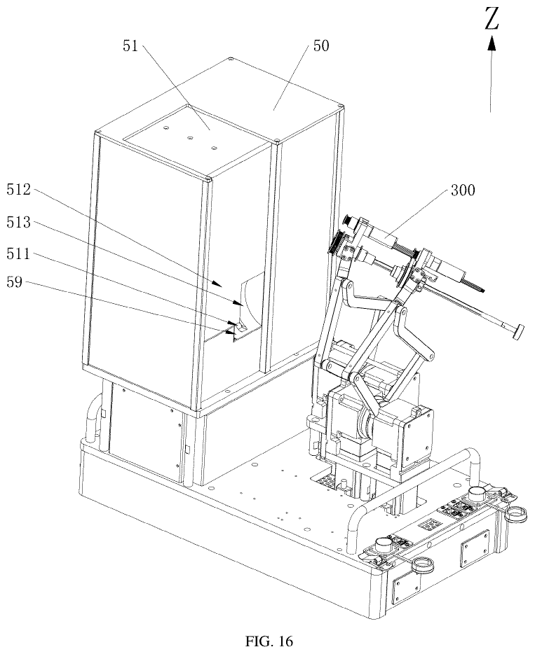

Reference can be made to FIG. 16, the box cover 51 defines a notch 511. When the box cover 51 closes the opening of the cavity 52, the notch 511 corresponds to the source container 3000 and the target container 2000. At this time, the scoop 732 can extend into the cavity 52 through the notch 511, and extend into the source container 3000 and the target container 2000 for powder transfer operation.

Optionally, the box cover 51 includes a first cover surface 512 and a second cover surface 513 connected to each other. The notch 511 is defined on the second cover surface 513. The second cover surface 513 protrudes from the first cover surface 512 in the first direction Z. The box body 50 defines an avoidance opening 59. Part of the second cover surface 513 protruding from the first cover surface 512 is configured to extend into the avoidance opening 59. At least the part of the second cover surface 513 protruding from the first cover surface 512 is concave toward the cavity 52. When the box cover 51 moves relative to the box body 50, the avoidance opening 59 is configured to accommodate at least part of the powder scooping rod 731. Optionally, the other part of the second cover surface 513 not protruding from the first cover surface 512 in the first direction Z may be flush with the first cover surface 512 or concave toward the cavity 52, which is not limited. Preferably, the second cover surface 513 is concave from the first cover surface 512 toward the cavity 52, the first cover surface 512 is a flat surface, and the second cover surface 513 is a flat surface, an arc surface, or a combination of an arc surface and a flat surface, which is not limited.

Specifically, when the box cover 51 closes the opening of the cavity 52, the scoop 732 can extend into the cavity 52 through the notch 511. When the box cover 51 needs to move relative to the box body 50 to open the cavity 52, the scoop 732 can exit the cavity 52 through the notch 511 and be located at the avoidance opening 59. At this time, the scoop 732 is located on one side of the first cover surface 512 facing the cavity 52 and is located on one side of the second cover surface 513 facing away from the cavity 52, so that the box cover 51 does not collide with the scoop 732 when moving relative to the box body 50, and the movement path of the scoop 732 is reduced, improving the operating efficiency of the powder weighing assembly 100. Optionally, the notch 511 extends to part of the second cover surface 513 for extending into the avoidance opening 59, so that the scoop 732 can be directly located in the avoidance opening 59 when exiting the cavity 52 through the notch 511, thereby further reducing the movement path of the scoop 732.

Optionally, as illustrated in FIG. 21, the powder weighing assembly 100 further includes a door shield 501. The door shield 501 is adjacent to the box cover 51 and is movable relative to the box cover 51. When the box cover 51 closes the opening of the cavity 52, the door shield 501 is configured to move to the notch 511 and block part of the notch 511. The door shield 501 defines a first avoidance groove 502 and a second avoidance groove 503. When the door shield 501 moves to the notch 511, the first avoidance groove 502 corresponds to the source container 3000, and the second avoidance groove 503 corresponds to the target container 2000.

Optionally, the first avoidance groove 502 is spaced apart from the second avoidance groove 503 in the first direction Z. Both the first avoidance groove 502 and the second avoidance groove 503 extend through the door shield 501 in the thickness direction of the door shield 501, so that the openings of the target container 2000 and the source container 3000 can be in communication with the outside, thereby facilitating the scoop 732 to extend in the target container 2000 and the source container 3000 for powder transfer operation.

Optionally, in the moving direction of the door shield 501, both the first avoidance groove 502 and the second avoidance groove 503 are defined from one side edge of the door shield 501 toward the opposite side of the door shield 501. The door shield 501 can be disposed inside the cavity 52 or outside the cavity 52, which is not limited. The door shield 501 may be independently driven by a separately provided driving structure.

By providing the door shield 501, the communication area between the outside and the cavity 52 is reduced as much as possible without affecting the normal execution of the powder transfer operation, thereby reducing the impact of the external environment (such as wind, dust, etc.) on the powder transfer accuracy.

Reference can be FIG. 15. The powder weighing assembly 100 further includes an electrostatic elimination mechanism 700. The electrostatic elimination mechanism 700 is disposed facing toward the weighing device 30. The electrostatic elimination mechanism 700 is configured to eliminate static electricity at the weighing device 30 and the container seat 20. Optionally, the electrostatic elimination mechanism 700 releases positive and negative ion flows by structures such as an ion bar or an ion fan to neutralize surface charges on each structure, thereby eliminating static electricity. Optionally, the electrostatic elimination mechanism 700 is disposed inside the cavity 52 and close to the weighing device 30 and the container seat 20; or, the electrostatic elimination mechanism 700 is disposed outside the cavity 52 and faces the weighing device 30 and the container seat 20 inside the cavity 52.

By providing the electrostatic elimination mechanism 700 to eliminate static electricity at the weighing device 30 and the container seat 20, the weighing device 30 is less likely to adhere to dust, the powder in the container is less likely to stick to the wall, and the phenomenon that the reading of the weighing device 30 is inaccurate due to the electrostatic force offsetting part of the gravity is avoided.

Reference can be made to FIG. 21. The powder weighing assembly 100 further includes a windproof enclosure 504. The windproof enclosure 504 is disposed around the weighing device 30 and also around at least part of the container seat 20. To facilitate picking and placing of the target container 2000 and the source container 3000, as well as the execution of the powder transfer operation, the windproof enclosure 504 is a non-sealed structure, for example, the top of the windproof enclosure 504 and the side facing the scoop 732 are fully open or semi-open.

Optionally, the windproof enclosure 504 may be made of a metal material (such as aluminum, aluminum alloy, etc.) or a non-metal material (such as acrylic, glass, etc.). The windproof enclosure 504 may be transparent, thereby facilitating manual observation or a visual inspection assembly 80 to collect the powder condition in each container.

By providing the windproof enclosure 504, wind protection can be provided for the weighing device 30 and the container seat 20, thereby reducing the impact of the external environment on the readings of the weighing device 30 and the powder scooping operation.

Optionally, the powder weighing assembly 100 further includes a visual inspection assembly 80. The visual inspection assembly 80 is disposed facing toward the container seat 20. The visual inspection assembly 80 is configured to detect a powder state of the target container 2000 and/or the source container 3000; and/or the visual inspection assembly 80 is configured to detect an operating state of the powder scooping rod 731 at the container seat 20. The visual inspection assembly 80 may be disposed inside the box 50 or outside the box 50, without limitation.

The powder weighing assembly 100 provided in the present disclosure obtains the actual transferred powder weight sequentially through the weight-loss method and the weight-gain method, specifically as follows. Place the source container 3000 containing the powder to-be-transferred on the second placement structure 22, and place the target container 2000 on the first placement structure 21. The moving mechanism 10 drives the container seat 20 into contact with the weighing device 30 to obtain the initial weight m0 of the container seat 20. Separate the container seat 20 from the weighing device 30, scoop up part of the powder from the source container 3000 and move the scooped powder away from the container seat 20, then bring the container seat 20 into contact with the weighing device 30 to obtain the post-scooping weight m1, where the scooped amount can be obtained by the weight-loss method as ms=m0−m1. Continue to keep the container seat 20 in contact with the weighing device 30, and transfer the scooped powder to the target container 2000 through the opening of the target container 2000 to obtain the post-transfer weight mp, where the powder spillage amount can be obtained by the weight-gain method as mw=mp−m1. Continue to keep the container seat 20 in contact with the weighing device 30, and pour the remaining powder into the target container 2000 to obtain the post-pouring weight m2, where the actual transferred powder amount can be obtained by the weight-gain method as ma=m2−mp.

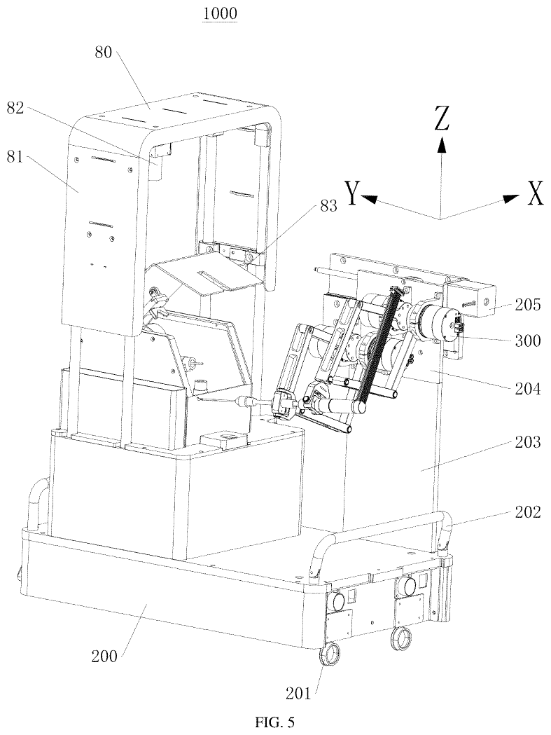

Reference can be made to FIG. 5. The present disclosure further provides a powder scooping apparatus 1000. The scooping apparatus 1000 includes a powder scooping manipulator 300 and the powder weighing assembly 100 in the foregoing embodiment. The powder scooping manipulator 300 is configured to extend into the source container 3000 to scoop up powder and transfer the scooped powder into the target container 2000.

Optionally, the powder scooping manipulator 300 is a robot or the like that can move relative to the powder weighing assembly 100. The powder scooping manipulator 300 can approach the powder weighing assembly 100 when powder scooping operation is needed, and move away from the powder weighing assembly 100 when powder scooping operation is not needed. Optionally, the powder scooping apparatus 1000 further includes a base 200. Both the powder scooping manipulator 300 and the powder weighing assembly 100 are disposed on the base 200.

Optionally, a pulley 201 is provided at one end of the base 200 facing away from the powder scooping manipulator 300 and the powder weighing assembly 100, that is, at the bottom end of the base 200. A handle 202 is provided on the base 200 to facilitate moving the powder scooping apparatus 1000. Optionally, a mounting plate 203 is further provided on the base 200, and the powder scooping manipulator 300 is disposed on the mounting plate 203, so that the powder scooping manipulator 300 corresponds to the position of the powder weighing assembly 100, thereby shortening the distance between the powder scooping manipulator 300 and the powder weighing assembly 100, and facilitating the powder scooping and pouring operations of the powder scooping manipulator 300 on the powder weighing assembly 100.

Optionally, the mounting plate 203 is provided with a sliding plate 204 and a translation mechanism 205. The sliding plate 204 is movably connected to the mounting plate 203. The translation mechanism 205 is disposed on the mounting plate 203 and connected to the sliding plate 204. The powder scooping manipulator 300 is mounted on the sliding plate 204. The translation mechanism 205 is configured to drive the sliding plate 204 to move in the second direction Y so as to drive the entire powder scooping manipulator 300 to approach or move away from the powder weighing assembly 100. Optionally, the mounting plate 203 may be vertically disposed on the base 200, or the mounting plate 203 may be horizontally disposed on the base 200, which is not limited. The translation mechanism 205 may be a combination structure of an electric machine and a lead screw and nut pair, or may be other structures, which is not limited in the present disclosure.

The powder scooping apparatus 1000 provided in the present disclosure can realize the automation of powder scooping operation without manual intervention, thereby reducing labor cost and improving the precision and efficiency of powder scooping operation.

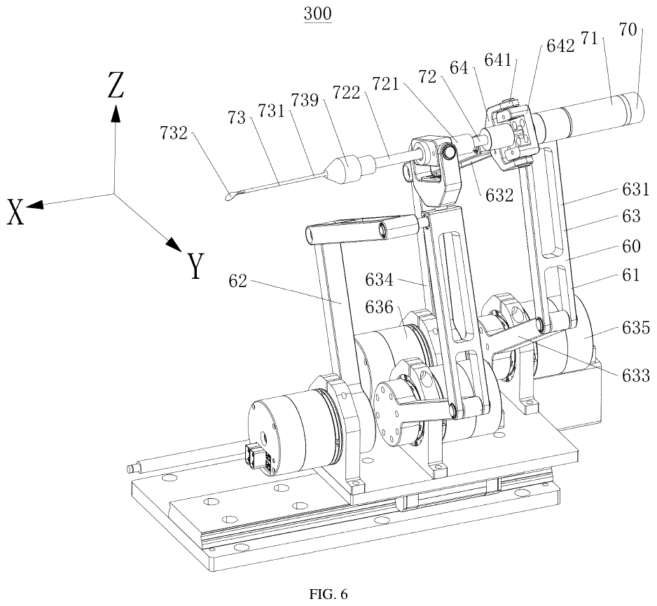

Reference can be made to FIG. 6 to FIG. 9. The powder scooping manipulator 300 includes a powder scooping robotic arm 60 and a powder scooping mechanism 70. The powder scooping mechanism 70 is disposed on the powder scooping robotic arm 60. The powder scooping robotic arm 60 is configured to drive the powder scooping mechanism 70 to move between the source container 3000 and the target container 2000. The powder scooping mechanism 70 is configured to scoop powder from the source container 3000 and pour the powder into the target container 2000.

Optionally, the powder scooping robotic arm 60 is disposed on the aforementioned sliding plate 204, and the sliding plate 204 can drive the powder scooping robotic arm 60 to move in the second direction Y, so as to drive the powder scooping mechanism 70 to move in the second direction Y. Optionally, the powder scooping robotic arm 60 is configured to drive the powder scooping mechanism 70 to approach or move away from the mounting plate 203 (or the sliding plate 204), and can also drive the powder scooping mechanism 70 to swing relative to the mounting plate 203 (sliding plate 204), so that the position of the powder scooping mechanism 70 in space is flexible and has a high degree of freedom.

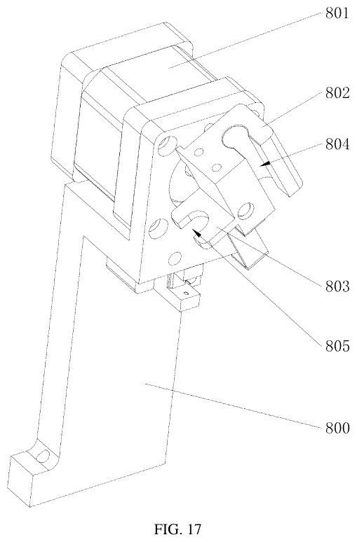

Reference can be made to FIG. 6 to FIG. 9. The powder scooping mechanism 70 includes a powder scooping rod 731. Reference can be made to FIG. 15 and FIG. 17. The powder scooping apparatus 1000 further includes a powder-scooping-member pick-and-place mechanism 800. The powder-scooping-member pick-and-place mechanism 800 includes a seat-rotation driving member 801, a loading seat 802, and an unloading seat 803. Both the loading seat 802 and the unloading seat 803 are connected to the seat-rotation driving member 801. The seat-rotation driving member 801 is configured to drive the loading seat 802 and the unloading seat 803 to rotate. The loading seat 802 defines a receiving groove 804. The receiving groove 804 is configured for placement of the powder scooping rod 731 to enable the powder scooping robotic arm 60 to be connected to the powder scooping rod 731. The unloading seat 803 defines a slot 805. The slot 805 is configured to be snap-fitted with the powder scooping rod 731 to separate the powder scooping rod 731 from the powder scooping robotic arm 60.

Optionally, the powder-scooping-member pick-and-place mechanism 800 may be connected to the powder scooping rod 731 by snapping, inserting, magnetic attraction, etc., which is not limited. Optionally, the seat-rotation driving member 801 is configured to drive the loading seat 802 and the unloading seat 803 to rotate around an axis extending in the third direction X, so that the upper surfaces of the loading seat 802 and the unloading seat 803 face the powder scooping robotic arm 60, thereby facilitating the powder scooping robotic arm 60 to pick and place the powder scooping rod 731.

When the seat-rotation driving member 801 drives the loading seat 802 and the unloading seat 803 to be in a horizontal state, the powder scooping rod 731 can be placed on the loading seat 802 or taken out from the unloading seat 803 manually or by the loading-and-unloading manipulator 90. When the seat-rotation driving member 801 drives the loading seat 802 and the unloading seat 803 to be in an inclined state, the powder scooping robotic arm 60 can be connected to the powder scooping rod 731 on the loading seat 802, and the powder scooping robotic arm 60 can drive the powder scooping rod 731 to separate from the loading seat 802 or move to the unloading seat 803, and after the powder scooping rod 731 is connected to the unloading seat 803, the powder scooping robotic arm 60 separates from the powder scooping rod 731.

By providing the aforementioned powder-scooping-member pick-and-place mechanism 800, the placement position and unloading position of the powder scooping rod 731 are integrated. Therefore, space utilization is improved, automatic loading-and-unloading of the powder scooping rod 731 is realized, the movement path of the powder scooping robotic arm 60 for loading-and-unloading the powder scooping rod 731 is shortened, and the operating efficiency is improved.

Optionally, reference can be made to FIG. 6 to FIG. 9. The powder scooping robotic arm 60 may include a first support mechanism 61 and a second support mechanism 62 spaced apart from the first support mechanism 61. Both the first support mechanism 61 and the second support mechanism 62 are connected to the powder scooping mechanism 70. The first support mechanism 61 and/or the second support mechanism 62 is movable to adjust a spatial position of the powder scooping mechanism 70.

Optionally, the specific structures of the first support mechanism 61 and the second support mechanism 62 are not limited. At least one of the first support mechanism 61 or the second support mechanism 62 is movable. Specifically, the first support mechanism 61 is fixed and the second support mechanism 62 is movable, or the first support mechanism 61 is movable and the second support mechanism 62 is fixed, or both the first support mechanism 61 and the second support mechanism 62 are movable. The movement may specifically be translation, rotation, or any other feasible movement mode, which is not limited.

Optionally, when the moving distances of the first support mechanism 61 and the second support mechanism 62 are equal, the first support mechanism 61 and the second support mechanism 62 can drive the powder scooping mechanism 70 to approach or move away from the aforementioned mounting plate 203 (or sliding plate 204). When the moving distances of the first support mechanism 61 and the second support mechanism 62 are not equal, the first support mechanism 61 and the second support mechanism 62 can drive the powder scooping mechanism 70 to swing relative to the mounting plate 203 (or sliding plate 204) to adjust the angle of the powder scooping mechanism 70.

By providing the first support mechanism 61 and second support mechanism 62 that are movable relative to each other, the powder scooping mechanism 70 can perform translation and yaw movements under the driving of the first support mechanism 61 and the second support mechanism 62, so as to complete functions such as scooping powder in the source container 3000, moving between the source container 3000 and the target container 2000, and pouring powder in the target container 2000.

Reference can be made to FIG. 6 to FIG. 9. At least one of the first support mechanism 61 or the second support mechanism 62 includes a support structure 63 and a joint 64. The joint 64 is rotatably connected to one end of the support structure 63. The joint 64 is connected to the powder scooping mechanism 70.

The specific structures of the support structure 63 and the joint 64 are not limited. The first support mechanism 61 may include the support structure 63 and the joint 64, and the second support mechanism 62 may be of other structures. Alternatively, the second support mechanism 62 may include the support structure 63 and the joint 64, and the first support mechanism 61 may be of other structures. Alternatively, each of the first support mechanism 61 and the second support mechanism 62 may include the support structure 63 and the joint 64. Optionally, the connection manner between the joint 64 and the powder scooping mechanism 70 may be fixed connection, rotational connection, sliding connection, etc., which is not limited.

Exemplarily, each of the first support mechanism 61 and the second support mechanism 62 is movable and includes the support structure 63 and the joint 64. The joint 64 of the first support mechanism 61 and the joint 64 of the second support mechanism 62 are respectively connected to the powder scooping mechanism 70 at two positions of the powder scooping mechanism 70. The first support mechanism 61 moves and/or the second support mechanism 62 moves, and during the movement, the joint 64 can rotate relative to the support structure 63, thereby driving the powder scooping mechanism 70 to move to complete the required operation.

Optionally, the joint 64 includes a first rotating member 641 and a second rotating member 642. The first rotating member 641 is rotatably connected to the support structure 63. The second rotating member 642 is rotatably connected to the first rotating member 641. The second rotating member 642 is connected to the powder scooping mechanism 70. A rotation axis of the first rotating member 641 intersects with a rotation axis of the second rotating member 642.

Specific structures of the first rotating member 641 and the second rotating member 642 are not limited. The second rotating member 642 and the scooping mechanism 70 may be fixedly connected or rotatably connected, which is not limited herein. The rotation axis of the first rotating member 641 and the rotation axis of the second rotating member 642 may be perpendicular or not perpendicular. For example, an angle between the rotation axis of the first rotating member 641 and the rotation axis of the second rotating member 642 is 30 degrees, 45 degrees, 55 degrees, 60 degrees, 90 degrees, or other values. Compared with the manner in which the rotation axis of the first rotating member 641 and the rotation axis of the second rotating member 642 are parallel, one more degree of freedom of rotation can be provided, which facilitates more free adjustment of the powder scooping robotic arm 60 and increases the degree of freedom of motion of the scooping mechanism 70. In addition, the rotation axis of the first rotating member 641 and the rotation axis of the second rotating member 642 may be coplanar or non-coplanar. When the rotation axis of the first rotating member 641 and the rotation axis of the second rotating member 642 are coplanar, the rotation stability of the structure can be improved.

The first rotating member 641 and the second rotating member 642 are rotatable with respect to the support structure 63, thereby providing two rotational degrees of freedom. When at least one of the first support mechanism 61 or the second support mechanism 62 drives the powder scooping mechanism 70 to move, by rotation of the first rotating member 641 and/or the second rotating member 642, the powder scooping mechanism 70 can be moved without jamming, so that the powder scooping robotic arm 60 can drive the powder scooping mechanism 70 to move to complete the required function.

In the case that each of the first support mechanism 61 and the second support mechanism 62 has the joint 64, structures of the two joints 64 may be substantially the same or different, which is not limited herein.

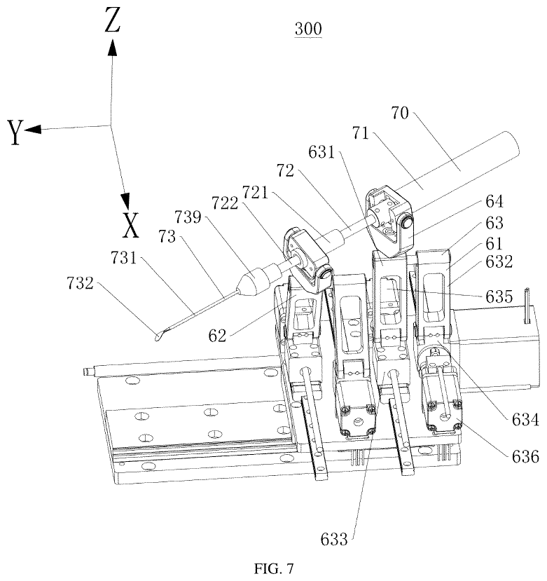

In an embodiment, reference can be made to FIG. 6 and FIG. 7, the powder scooping mechanism 70 includes a first powder-scooping driving member 71, a first powder-scooping transmission member 72, and a powder scooping rod 731. The first powder-scooping driving member 71 is disposed on the powder scooping robotic arm 60. One end of the first powder-scooping transmission member 72 is connected to the first powder-scooping driving member 71, and the other end of the first powder-scooping transmission member 72 is connected to the powder scooping rod 731. The first powder-scooping driving member 71 is configured to drive the powder scooping rod 731 to move to scoop or pour powder. Optionally, the first powder-scooping driving member 71 may be an electric machine or other driving structures, which is not limited. Optionally, the first powder-scooping driving member 71 can drive the powder scooping rod 731 to rotate and/or translate to scoop or pour powder, which is not limited. Optionally, one end of the powder scooping rod 731 away from the first powder-scooping transmission member 72 is provided with a scoop 732 for scooping and pouring powder. Optionally, the first powder-scooping driving member 71 is connected to the first support mechanism 61, and the first powder-scooping transmission member 72 is connected to the second support mechanism 62. Optionally, the whole the powder scooping rod 731 is substantially in the shape of a straight-line extending rod, and the length direction of the powder scooping rod 731 is a direction of straight extension. The powder scooping rod 731 can scoop powder by rotating or translating, which is not limited.

Optionally, the first powder-scooping transmission member 72 includes a bushing 721 and a guide shaft 722. The bushing 721 is sleeved on the guide shaft 722. The guide shaft 722 is rotatable relative to the bushing 721. One end of the guide shaft 722 is connected to the first powder-scooping driving member 71, and the other end of the guide shaft 722 is connected to the powder scooping rod 731. The first powder-scooping driving member 71 is configured to drive the guide shaft 722 to rotate to drive the powder scooping rod 731 to rotate. One end of the powder scooping rod 731 away from the guide shaft 722 is provided with a scoop 732. The second support mechanism 62 is connected to the bushing 721.

The bushing 721 is substantially in the shape of a sleeve, and an outer circumferential surface of the bushing 721 may be cylindrical or cylindrical with an annular protrusion, which is not limited herein. The guide shaft 722 is a cylindrical straight rod. Two ends of the guide shaft 722 may extend out of the bushing 721, or one end of the guide shaft 722 extends out of the bushing 721 and the other end of the guide shaft 722 does not extend out of the bushing 721, which is not limited herein. The bushing 721 is connected and fixed to the second support mechanism 62, and the guide shaft 722 is rotatable relative to the bushing 721, so that the first powder-scooping driving member 71 drives the guide shaft 722 to rotate, to drive the powder scooping rod 731 to rotate, to further drive the scoop 732 to rotate, thereby realizing an operation of powder scooping or powder pouring.

Optionally, the powder scooping mechanism 70 includes a first powder-scooping driving member 71 and a powder scooping member 73. The first powder-scooping driving member 71 is connected to one end of the powder scooping member 73 and is configured to drive the powder scooping member 73 to move. The first support mechanism 61 is connected to the first powder-scooping driving member 71. The second support mechanism 62 is connected to the powder scooping member 73. Optionally, the powder scooping member 73 may include the aforementioned first powder-scooping transmission member 72 and powder scooping rod 731.

It can be understood that the first powder-scooping transmission member 72 may be of other structures, which is not limited. For example, the first powder-scooping transmission member 72 is a coupling, and the first powder-scooping driving member 71 and the powder scooping rod 731 are connected through the coupling.

Optionally, reference can be made to FIG. 6 and FIG. 7, the guide shaft 722 is also movable relative to the bushing 721, and the first support mechanism 61 and the second support mechanism 62 are movable close to or away from each other. A direction in which the guide shaft 722 moves relative to the bushing 721 is an axial direction of the guide shaft 722. In this way, the first support mechanism 61 and the second support mechanism 62 can move close to or away from each other by means of the motion of the guide shaft 722 relative to the bushing 721, thereby further improving the flexibility and movement freedom of the powder scooping mechanism 70. Even without the translation mechanism 205, the powder scooping rod 731 can still move in the second direction Y.

Optionally, reference can be made to FIG. 6 and FIG. 7. The powder scooping member 73 further includes an adapter 739. One end of the adapter 739 is detachably connected to the guide shaft 722, and the other end of the adapter 739 is detachably connected to the powder scooping rod 731.

The specific structure of the adapter 739 is not limited. The detachable connection between the adapter 739 and each of the guide shaft 722 and the powder scooping rod 731 may be screwing, snapping, interference fit, etc., which is not limited. By providing the adapter 739, the connection between the powder scooping rod 731 and the guide shaft 722 can be conveniently established, and the powder scooping rod 731 can be easily replaced to switch between scoops 732 of different specifications.

In an embodiment, the first powder-scooping driving member 71 is a rotary electric machine. The first powder-scooping driving member 71 can drive the first powder-scooping transmission member 72 to rotate through an output shaft of the rotary electric machine, to drive the powder scooping rod 731 to rotate, thereby realizing operations of powder scooping and powder pouring, and the structure is simple and easy to implement.

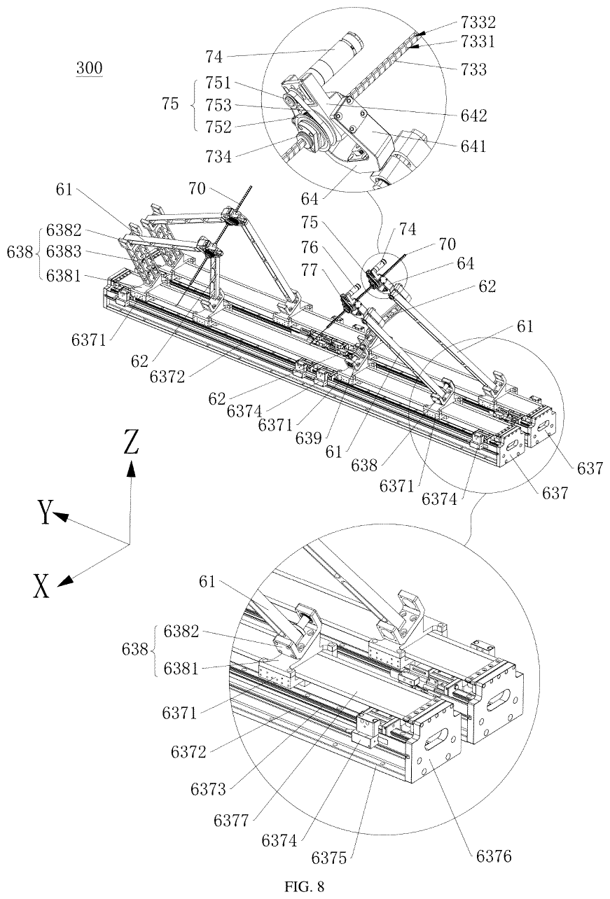

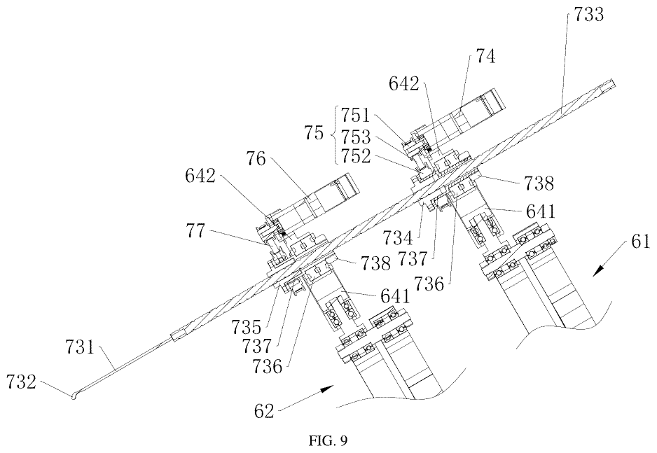

In another embodiment, reference can be made to FIG. 8 and FIG. 9, the powder scooping mechanism 70 includes a second powder-scooping driving member 74, a second powder-scooping transmission member 75, a third powder-scooping driving member 76, a third powder-scooping transmission member 77, and a powder scooping member 73. Both the second powder-scooping transmission member 75 and the third powder-scooping transmission member 77 are connected to the powder scooping member 73. The first support mechanism 61 is connected to the second powder-scooping driving member 74. The second powder-scooping driving member 74 is connected to the second powder-scooping transmission member 75. The second support mechanism 62 is connected to the third powder-scooping driving member 76. The third powder-scooping driving member 76 is connected to the third powder-scooping transmission member 77. Both the first support mechanism 61 and the second support mechanism 62 are movably connected to the powder scooping member 73 (for example, both the first support mechanism 61 and the second support mechanism 62 are slidably connected to the powder scooping member 73, and/or both the first support mechanism 61 and the second support mechanism 62 are rotatably connected to the powder scooping member 73). One end of the powder scooping member 73 away from the second powder-scooping driving member 74 is provided with a scoop 732. The second powder-scooping driving member 74 and the third powder-scooping driving member 76 are configured to drive the powder scooping member 73, through a corresponding powder-scooping transmission member, to perform any one of a translational motion, a rotational motion, or a composite motion of the translational motion and the rotational motion.

Optionally, the second powder-scooping driving member 74 and the third powder-scooping driving member 76 may be structures such as rotary electric machines, linear electric machines, hydraulic pumps, etc., without limitation. The specific structures of the second powder-scooping transmission member 75, the third powder-scooping transmission member 77, and the powder-scooping member 73 may not be limited, as long as under the driving of the second powder-scooping driving member 74 and the third powder-scooping driving member 76, the powder-scooping member 73 can perform any one of a translational motion, a rotational motion, or a composite motion of the translational motion and the rotational motion.

When the powder-scooping member 73 moves, the powder-scooping member 73 moves in the axial direction thereof, so that the powder-scooping member 73 can move forward or backward. When the powder-scooping member 73 rotates, the powder-scooping member 73 rotates around the axis thereof, so that the operations of powder scooping and powder pouring can be realized. When the powder-scooping member 73 performs the composite motion of translational motion and rotational motion, the powder-scooping member 73 can realize composite motion of any combination of forward movement, backward movement, powder scooping, and powder pouring. In this way, the flexibility of the powder-scooping mechanism 70 itself can be significantly improved.

Optionally, the powder-scooping member 73 includes a screw shaft 733, a first nut 734, a second nut 735, and a powder-scooping rod 731. The first support mechanism 61 is rotatably connected to the first nut 734. The second powder-scooping transmission member 75 is connected to the first nut 734. The second support mechanism 62 is rotatably connected to the second nut 735. The third powder-scooping transmission member 77 is connected to the second nut 735. The screw shaft 733 passes through the first nut 734 and the second nut 735. Both the first nut 734 and the second nut 735 are movably connected to the screw shaft 733. One end of the screw shaft 733 away from the second powder-scooping driving member 74 is connected to one end of the powder-scooping rod 731, and one end of the powder-scooping rod 731 away from the screw shaft 733 is provided with a scoop 732.

One of the first nut 734 and the second nut 735 is a screw nut, and the other of the first nut 734 and the second nut 735 is a spline nut. The screw shaft 733 defines a helical groove 7331 spirally extending in an axial direction of the screw shaft 733 and a straight groove 7332 linearly extending in the axial direction of the screw shaft 733. The screw nut is engaged with the helical groove 7331. The spline nut is engaged with the straight groove 7332. The first nut 734 and/or the second nut 735 is rotatable relative to the screw shaft 733 to drive the screw shaft 733 to perform any one of the translational motion, the rotational motion, or the composite motion of the translational motion and the rotational motion.

In this embodiment, the screw shaft 733 may be connected to the powder-scooping rod 731 by means of welding, bonding, snapping, screwing, etc. The screw shaft 733 and the powder-scooping rod 731 may be directly connected, or the screw shaft 733 and the powder-scooping rod 731 may be detachably connected through an adapter 739, without limitation. The powder-scooping transmission member may be connected to the nut by means of screwing, bonding, snapping, etc.

In this embodiment, the first nut 734, the second nut 735, and the screw shaft 733 form a screw and spline pair as a whole. The second powder-scooping driving member 74 can drive the first nut 734 to rotate. The third powder-scooping driving member 76 can drive the second nut 735 to rotate. One of the first nut 734 and the second nut 735 is the screw nut and the other of the first nut 734 and the second nut 735 is the spline nut, the screw nut rotates to generate a transmission effect with the helical groove 7331, and the spline nut rotates to generate a transmission effect with the straight groove 7332, so that the screw shaft 733 can perform any one of the translational motion, the rotational motion, or the composite motion of the translational motion and the rotational motion.

When the screw nut is fixed and does not rotate (i.e., a corresponding powder-scooping driving member does not operate) while the spline nut rotates (i.e., a corresponding powder-scooping driving member operates), the screw shaft 733 performs a composite motion of helical forward or helical backward. When the screw nut rotates while the spline nut is fixed and does not rotate, the screw shaft 733 moves linearly. When the screw nut and the spline nut both rotate, the screw shaft 733 substantially rotates in situ.

Exemplarily, as illustrated in FIG. 8 and FIG. 9, the first nut 734 is a screw nut, and the second nut 735 is a spline nut.

Optionally, the powder scooping manipulator 300 may further be provided with a bearing 736. The bearing 736 is located in the second rotating member 642 of the joint 64. An outer ring of the bearing 736 is connected to an inner wall of the second rotating member 642. An inner ring of the bearing 736 is connected to the first nut 734 or the second nut 735. Therefore, the first nut 734 or the second nut 735 is rotatably connected to a corresponding support mechanism.

Optionally, since the first nut 734 and the second nut 735 are limited in size, and direct connection between each of the first nut 734 and the second nut 735 and the bearing 736 may not be feasible, the powder scooping manipulator 300 may further be provided with an adapter sleeve 737 and a locking nut 738. The adapter sleeve 737 is at least partially located in the bearing 736 and is connected to the inner ring of the bearing 736. The adapter sleeve 737 is sleeved on the screw shaft 733 and is not in a transmission relationship with the screw shaft 733. There is a gap between the adapter sleeve 737 and the screw shaft 733. The locking nut 738 is connected to and locked with one end of the adapter sleeve 737. Each of the first nut 734 and the second nut 735 may be provided with the adapter sleeve 737, the bearing 736, and the locking nut 738. Each of the first nut 734 and the second nut 735 is connected and fixed to one end of the corresponding adapter sleeve 737 away from the locking nut 738. Since the length of each of the first nut 734 and the second nut 735 is limited, by providing the adapter sleeve 737, each of the first nut 734 and the second nut 735 can be connected to the corresponding bearing 736. By locking the locking nut 738 with one end of the adapter sleeve 737 that exceeds the second rotating member 642 and is away from the first nut 734 or the second nut 735, an axial motion of the first nut 734 and the second nut 735 can be restricted, thereby ensuring structural stability. When the second powder-scooping driving member 74 drives the first nut 734 to rotate and the third powder-scooping driving member 76 drives the second nut 735 to rotate, the first nut 734 drives the adapter sleeve 737 connected to the first nut 734 to rotate and the second nut 735 drives the adapter sleeve 737 connected to the second nut 735 to rotate. Accordingly, the rotation of the adapter sleeve 737 causes the inner ring of the bearing 736 connected to the adapter sleeve 737 to rotate, while the outer ring of the bearing 736 and the second rotating member 642 do not rotate along with rotation of the inner ring of the bearing 736. Therefore, the first nut 734 rotates relative to the first support mechanism 61, and the second nut 735 rotates relative to the second support mechanism 62.

The adapter sleeve 737 may be connected to each of the first nut 734 or the second nut 735 by means of screwing, bonding, snapping, etc., which is not limited herein. The adapter sleeve 737 may be connected to the bearing 736 by means of interference fit, transition fit, or the like, which is not limited herein.

By providing the screw and spline pair, it is possible for the screw shaft 733 with a simple structure to achieve any motion such as the translational motion, the rotational motion, or the composite motion of the translational motion and the rotational motion, so that the flexibility of the powder scooping mechanism 70 can be improved, so as to achieve a more complex operation. Without providing the translation mechanism 205, the powder scooping rod 731 can still be moved in the second direction Y.

Optionally, reference can be made to FIG. 8, at least one of the second powder-scooping transmission member 75 or the third powder-scooping transmission member 77 includes a first powder-scooping synchronous pulley 751, a second powder-scooping synchronous pulley 752, and a powder-scooping synchronous belt 753 connected between the first powder-scooping synchronous pulley 751 and the second powder-scooping synchronous pulley 752. The first powder-scooping synchronous pulley 751 is connected to a corresponding powder scooping driving member. The second powder-scooping synchronous pulley 752 is connected to a nut on a corresponding screw and spline pair.

Optionally, the first powder-scooping synchronous pulley 751 is connected to the second powder-scooping driving member 74 (or the third powder-scooping driving member 76). The second powder-scooping synchronous pulley 752 is sleeved on the corresponding nut or adapter sleeve 737 and is fixed to the corresponding nut or adapter sleeve 737 (such as by means of screwing, bonding, snapping, etc.), and the powder-scooping synchronous belt 753 is wound around the first powder-scooping synchronous pulley 751 and the second powder-scooping synchronous pulley 752. When the corresponding powder-scooping driving member operates, the first powder-scooping synchronous pulley 751 is driven to rotate, to drive the second powder-scooping synchronous pulley 752 by the powder-scooping synchronous belt 753 to rotate, so that the corresponding screw and spline pair can be driven to perform the required movement. Optionally, at least one of the second powder-scooping transmission member 75 or the third powder-scooping transmission member 77 includes a first gear and a second gear engaged with each other. The first gear is connected to the second powder-scooping driving member 74 (or the third powder-scooping driving member 76), and the second gear is connected to the corresponding nut. The power from the powder scooping driving member can likewise be transmitted to the corresponding nut by means of gearing transmission.

By providing the aforementioned powder scooping manipulator 300, the powder-scooping mechanism 70 can realize functions such as powder scooping, powder moving, and powder pouring under the driving of the powder-scooping robotic arm 60, without manual powder scooping and pouring operations, thereby reducing labor cost and improving the accuracy and efficiency of powder scooping operations.

In an embodiment, reference can be made to FIG. 6 and FIG. 7. The support structure 63 includes a first support member 631, a second support member 632, a first transmission member 633, a second transmission member 634, a first driving member 635, and a second driving member 636. The first support member 631 is rotatably connected to the joint 64 and the first transmission member 633. The second support member 632 is rotatably connected to the first support member 631 and the second transmission member 634. The first driving member 635 is connected to the first transmission member 633 and is configured to drive the first transmission member 633 to drive the first support member 631 to move. The second driving member 636 is connected to the second transmission member 634 and is configured to drive the second transmission member 634 to drive the second support member 632 to move.

Optionally, one end of the first support member 631 is rotatably connected to the joint 64, and one end of the second support member 632 is rotatably connected to the joint 64. The first transmission member 633 is rotatably connected to the other end of the first support member 631 away from the joint 64. The second transmission member 634 is rotatably connected to the other end of the second support member 632 away from the joint 64. Optionally, both the first driving member 635 and the second driving member 636 are disposed on the base 200 (or the mounting plate 203).

Optionally, each of the first support member 631 and the second support member 632 extends substantially in a straight line or a curve, and has two opposite ends in the length direction. One end of the first support member 631 is rotatably connected to the first rotating member 641 of the joint 64. Optionally, the first support member 631 extends along a straight line, and the straight line is parallel to the rotation axis of the first rotating member 641. In other words, the first rotating member 641 rotates around an axis extending along the length direction of the first support member 631.

At least one of the first support member 631 or the second support member 632 performs an active motion. Since the first support member 631 and the second support member 632 are rotatably connected, so that the first support member 631 and the second support member 632 together support the joint 64 and drive the joint 64 to move. The active motion refers to that the at least one of the first support member 631 or the second support member 632 is moved under the action of the input power, while the motion is regarded as a follow-up motion in the absence of power input. For example, the first support member 631 performs the active motion, and the second support member 632 performs the follow-up motion; or the second support member 632 performs the active motion, and the first support member 631 performs the follow-up motion; or each of the first support member 631 and the second support member 632 performs the active motion. The active motion of the first support member 631 and/or the second support member 632 may be the translational motion, the rotational motion, or the like, which is not limited herein.

When the first support member 631 and/or the second support member 632 move, the position of the joint 64 can be changed, and the joint 64 is rotatably connected to one end of the first support member 631, so that the position of the powder scooping mechanism 70 connected to the joint 64 can be changed, and the powder scooping mechanism 70 can be moved flexibly without interference.

Specific structures and types of the first driving member 635, the first transmission member 633, the second driving member 636, and the second transmission member 634 are not limited, and may be any feasible ones. For example, the first driving member 635 and the second driving member 636 may be an electric machine, an air cylinder, or the like. It should be understood that, according to the motion required by the powder scooping mechanism 70, the first driving member 635 and/or the second driving member 636 can be controlled to operate, and the first support member 631 and/or the second support member 632 are driven to move through the first transmission member 633 and/or the second transmission member 634, so as to adjust a position of the joint 64. That is, at least one of the first driving member 635 or the second driving member 636 may not operate. For example, the first driving member 635 does not operate and the second driving member 636 operates. Since the first driving member 635 does not operate, the first transmission member 633 does not operate either. However, since the first support member 631 is rotatably connected to the first transmission member 633, the first support member 631 can rotate relative to the first transmission member 633 when the second driving member 636 drives the second support member 632 to move through the second transmission member 634, so that the position of the joint 64 can also be changed. The embodiments of the present disclosure do not limit how the first driving member 635 and the second driving member 636 operate, as long as the joint 64 can be driven to move. The rotational connection manner between the first transmission member 633 and the first support member 631 and the rotational connection manner between the second transmission member 634 and the second support member 632 may be implemented by using a structure such as a rotating shaft or a universal joint, which is not limited herein.

By arranging the aforementioned support mechanism, the position of the joint 64 can be flexibly adjusted by controlling whether and how the first driving member 635 and the second driving member 636 operate, and the adaptability is strong.

Reference can be made to FIG. 6 and FIG. 7. Each of the first driving member 635 and the second driving member 636 is a rotary electric machine. Each of the first support member 631 and the second support member 632 is a connecting rod. The first transmission member 633 includes any one or combination of a connecting rod, a lead screw and nut pair, a gear and rack pair, or a worm wheel and worm pair. The second transmission member 634 includes any one or combination of a connecting rod, a lead screw and nut pair, a gear and rack pair, or a worm wheel and worm pair.

Optionally, a rotation axis of the first driving member 635 is parallel to a rotation axis of the second driving member 636. In this way, a direction in which the first driving member 635 drives the first transmission member 633 to move (such as rotate or translate) is either the same as or opposite to a direction in which the second driving member 636 drives the second transmission member 634 to move (such as rotate or translate). Therefore, the structure and control logic can be simplified, and excessively complex motion can be avoided to avoid a difficulty in controlling the motion of the joint 64.

Optionally, the first driving member 635 and the second driving member 636 may specifically be servo electric machines, stepping electric machines, etc. The rotary electric machine may be integrated with a speed reducer, a transmission, a brake, or the like, which is not limited.

In a specific embodiment, referring to FIG. 6, each of the first transmission member 633, the first support member 631, the second transmission member 634, and the second support member 632 is a connecting rod. One end of the first support member 631 is rotatably connected to the joint 64. One end of the first transmission member 633 is rotatably connected to the end of the first support member 631 away from the joint 64, and the other end of the first transmission member 633 is connected to the first driving member 635. One end of the second support member 632 is rotatably connected to one end of the first support member 631 close to the joint 64. One end of the second transmission member 634 is rotatably connected to the end of the second support member 632 away from the joint 64, and the other end of the second transmission member 634 is connected to the second driving member 636.

Optionally, the axis of the first driving member 635 may coincide with the axis of the second driving member 636. Furthermore, the first transmission member 633, the first support member 631, the second transmission member 634, and the second support member 632 all use connecting rods. The axis about which the first transmission member 633 and the first support member 631 rotate relative to each other, the axis about which the first support member 631 and the second support member 632 rotate relative to each other, and the axis about which the second transmission member 634 and the second support member 632 rotate relative to each other, are all parallel to the axis of the first driving member 635. In this way, the first transmission member 633, the first support member 631, the second transmission member 634, and the second support member 632 substantially form a quadrilateral structure (which may present a quadrilateral structure in the projection direction of the axis of the first driving member 635). Any two adjacent sides of the quadrilateral structure can rotate relative to each other, so that the quadrilateral structure has good deformability, simple structure, and low cost. Optionally, the axis of the first driving member 635 and the axis of the second driving member 636 may be parallel but have a spacing.

Optionally, the axis about which the first transmission member 633 and the first support member 631 rotate relative to each other, the axis about which the first support member 631 and the second support member 632 rotate relative to each other, and the axis about which the second transmission member 634 and the second support member 632 rotate relative to each other, may be parallel to one another, but be non-parallel to the axis of the first driving member 635, etc.

Optionally, the axis about which the first transmission member 633 and the first support member 631 rotate relative to each other, the axis about which the first support member 631 and the second support member 632 rotate relative to each other, and the axis about which the second transmission member 634 and the second support member 632 rotate relative to each other, may also be non-parallel.

In another specific embodiment, which is basically the same as the embodiment illustrated in FIG. 6, except that the first transmission member 633 is rotatably connected to the first support member 631 at the middle part of the first support member 631, one end of the second support member 632 is connected to the second transmission member 634, and the other end of the second support member 632 is rotatably connected to the end of the first support member 631 away from the joint 64.

The middle part of the first support member 631 may be at the midpoint or near the midpoint (with a certain allowable distance from the midpoint). In this manner, the part of the first support member 631 between the middle of the first support member 631 and the joint 64 remains free from interference by the second support member 632, which facilitates more complex motion of the powder scooping mechanism 70. In addition, the sizes of the second support member 632 and the second transmission member 634 can be appropriately reduced to reduce the space occupation of the structure.

In addition, the first support member 631 is equivalent to a lever with the first transmission member 633 as a fulcrum. Compared with a manner where the second support member 632 is rotatably connected to one end of the first support member 631 close to the joint 64, the second support member 632 moves in the opposite direction when the powder scooping mechanism 70 performs the same motion. For example, when the powder scooping mechanism 70 moves upwards, in the manner where the second support member 632 is rotatably connected to the end of the first support member 631 close to the joint 64, the second support member 632 moves towards the first support member 631. In contrast, when the powder scooping mechanism 70 moves upwards, in the manner where the first transmission member 633 is rotatably connected to the first support member 631 at the middle of the first support member 631 and the second support member 632 is rotatably connected to the end of the first support member 631 away from the joint 64, the second support member 632 moves away from the first support member 631. Therefore, the operation manner of the first driving member 635 and the second driving member 636 can be adjusted more flexibly, which facilitates simplifying the control logic.

Optionally, referring to FIG. 6, the length of the first transmission member 633 is equal to the length of the second transmission member 634, and the length of the first support member 631 is equal to the length of the second support member 632. In this way, the structure is simple, the control logic is simple, the coordination is high, the implementation is easy, and the cost is low.

In another specific embodiment, referring to FIG. 7, the embodiment is basically the same as the embodiment illustrated in FIG. 6, except that each of the first transmission member 633 and the second transmission member 634 is a lead screw and nut pair. A lead screw of the first transmission member 633 is connected to the first driving member 635. A lead screw of the second transmission member 634 is connected to the second driving member 636. One end of the first support member 631 away from the joint 64 is rotatably connected to a nut of the first transmission member 633. One end of the second support member 632 away from the joint 64 is rotatably connected to a nut of the second transmission member 634. Optionally, the lead screw of the first transmission member 633 and the lead screw of the second transmission member 634 are arranged in parallel.

In this embodiment, the connecting rod as the first transmission member 633 and the connecting rod as the second transmission member 634 in FIG. 6 are replaced with lead screw and nut pairs. In the embodiment illustrated in FIG. 6, the connecting rod as the first transmission member 633 and the connecting rod as the second transmission member 634 rotate. In contrast, in the embodiment illustrated in FIG. 7, each of the first driving member 44 and the second driving member 46 is a rotary electric machine, and an axis of the rotary electric machine is the same as an extending direction of a corresponding lead screw. The lead screw is driven by the rotary electric machine to rotate, the nut is driven by the lead screw to move linearly, and the corresponding support member is driven by the nut to move (or to translate and rotate), so that the joint 64 can be driven to move. The lead screw of the first transmission member 633 and the lead screw of the second transmission member 634 are arranged in parallel, so that one end of the first support member 631 rotatably connected to the nut of the first transmission member 633 and one end of the second support member 632 rotatably connected to the nut of the second transmission member 634 can move relatively close to or relatively away from each other in the extending direction of the lead screw, which facilitates simplifying the control logic of the first driving member 635 and the second driving member 636, has a simple structure, small space occupation, and a low cost.

Optionally, referring to FIG. 7, each of the first support member 631 and the second support member 632 is a connecting rod. The length of the first support member 631 is equal to the length of the second support member 632.

One end of the second support member 632 away from the nut of the second transmission member 634 may be rotatably connected to one end of the first support member 631 close to the joint 64, or may be rotatably connected to the first support member 631 at the middle of the first support member 631, which is not limited herein. In this way, the structures of the first support member 631 and the second support member 632 are simple, and the size of the second support member 632 can be appropriately reduced.

It can be understood that, the structure of the first support mechanism 61 may be substantially the same as the structure of the second support mechanism 62, for example, the support structure 63 of each of the first support mechanism 61 and the second support mechanism 62 is a combination of two rotary electric machines and four connecting rods illustrated in FIG. 6; or the support structure 63 of each of the first support mechanism 61 and the second support mechanism 62 is a combination of two rotary electric machines, two lead-screw-and-nut pairs, and two connecting rods illustrated in FIG. 7. The structure of the first support mechanism 61 may be different from the structure of the second support mechanism 62. For example, one of the support structure 63 of the first support mechanism 61 and the support structure 63 of the second support mechanism 62 is a combination of two rotary electric machines and four connecting rods, and another of the support structure 63 of the first support mechanism 61 and the support structure 63 of the second support mechanism 62 is a combination of two rotary electric machines, two lead-screw-and-nut pairs, and two connecting rods; or one of the support structure 63 of the first support mechanism 61 and the support structure 63 of the second support mechanism 62 is a combination of two rotary electric machines and four connecting rods, and another of the support structure 63 of the first support mechanism 61 and the support structure 63 of the second support mechanism 62 is a single supporting rod; or one of the support structure 63 of the first support mechanism 61 and the support structure 63 of the second support mechanism 62 is a combination of two rotary electric machines, two lead-screw-and-nut pairs, and two connecting rods, and another of the support structure 63 of the first support mechanism 61 and the support structure 63 of the second support mechanism 62 is a single supporting rod.

In another embodiment, referring to FIG. 8, the support structure 63 includes a first support member 631, a second support member 632, a third driving member 637, a third transmission member 638, and a fourth transmission member 639. The third transmission member 638 is rotatably connected to the first support mechanism 61. The fourth transmission member 639 is rotatably connected to the second support mechanism 62. The third driving member 637 is connected to the third transmission member 638 and the fourth transmission member 639, and is configured to drive the third transmission member 638 and the fourth transmission member 639 to move independently.

One third driving member 637, one third transmission member 638, and one fourth transmission member 639 together form one group of power structures. In this embodiment, one or more groups of power structures may be provided. When one group of power structures is provided, one joint 64 can be driven to move. In combination with FIG. 6 and FIG. 7, the other joint 64 can be driven by any feasible structure in the foregoing embodiments, which is not limited herein. When multiple groups of power structures are provided, two of the multiple groups of power structures can drive two joints 64 connected to the same powder scooping mechanism 70 to move, and the other groups of power structures can also drive the joints 64 connected to the other powder scooping mechanisms 70 to move. For example, one third driving member 637 can independently drive more than two (e.g., four, six, eight, etc.,) transmission members to move. By providing two third driving members 637 as illustrated in FIG. 8, multiple powder scooping mechanisms 70 can be independently driven to operate, thereby improving apparatus flexibility and experimental throughput.

The third driving member 637, the third transmission member 638, and the fourth transmission member 639 may be any feasible structure. For example, the third driving member 637 may be a rotary electric machine, a linear electric machine, a hydraulic pump, an air cylinder, or the like, which is not limited herein. The third transmission member 638 and the fourth transmission member 639 may be a sliding block, a connecting rod, or various matching pairs. The third driving member 637 can drive the third transmission member 638 and the fourth transmission member 639 to move independently, so that the corresponding first support member 61 and the corresponding second support member 62 can be driven to move independently, and then the joint 64 connected to the first support member 61 and the second support member 62 can be driven to move. Thus, the posture or position of the powder scooping mechanism 70 connected to the joint 64 can be adjusted.

By providing the third driving member 637 to drive the third transmission member 638 and the fourth transmission member 639 to move independently, compared with the structures illustrated in FIG. 6 and FIG. 7, one driving member can be removed, thereby reducing structural complexity and cost.

Optionally, referring to FIG. 8, the third driving member 637 is a linear electric machine. The linear electric machine includes multiple independently movable movers 6371. The third transmission member 638 and the fourth transmission member 639 are connected to different movers 6371 of the multiple movers 6371.

Specifically, the linear electric machine as the third driving member 637 includes a stator 6372 extending linearly and a guide member 6373, and the guide member 6373 is disposed on the stator 6372 and extends in the same direction as the stator 6372. The multiple movers 6371 are slidably connected to the guide member 6373. The stator 6372 is configured to drive the multiple movers 6371 to slide along the guide member 6373 by means of an electromagnetic induction effect. The multiple movers 6371 can move linearly along the guide member 6373 independently of each other.

The guide member 6373 may specifically be plate-shaped, rod-shaped, or the like. For example, the guide member 6373 is a slide rail, a slide rod, or the like, which is not limited herein. The guide member 6373 is an insulating member to avoid affecting the electromagnetic induction effect of the stator 6372 and the mover 6371. There may be multiple guide members 483 disposed on the stator 6372 at intervals (for example, disposed at two opposite sides of the stator 6372). The mover 6371 may be directly mounted on the guide member 6373. The mover 6371 may also be mounted on the guide member 6373 through a fit structure, which is not limited herein.

Optionally, the third driving member 637 is further provided with a detection apparatus 6374. The detection apparatus 6374 may be disposed on the guide member 6373 and configured to detect a position of the mover 6371. The detection apparatus 6374 may be a grating detection structure, a photoelectric sensor, or the like. Exemplarily, the detection apparatus 6374 consists of a grating ruler and two grating reading heads. The two grating reading heads are respectively connected to two movers 6371, and move on the guide member 6373 along with the movers 6371. The grating ruler is disposed in an extending direction of the stator 6372 and is located within a moving range of the two movers 6371. By providing the detection apparatus 6374, a moving position of the mover 6371 can be precisely controlled, and collision with other structures can be avoided, thereby improving the operation accuracy and safety of the powder scooping manipulator 300.

A linear electric machine as one third driving member 637 may be provided with multiple movers 6371. Two adjacent movers 6371 are connected to the third transmission member 638 and the fourth transmission member 639 respectively; and the other two adjacent movers 6371 may be connected to another third transmission member 638 and another fourth transmission member 639 respectively, or may be connected to other mechanisms. Thus, a more complex function can be implemented. Exemplarily, as illustrated in FIG. 8, one stator 6372 is provided with four movers 6371, two adjacent movers 6371 form one group, and there are two groups of movers 6371. Each group of movers 6371 is connected to a corresponding third transmission member 638 and a corresponding fourth transmission member 639, so as to drive the four corresponding transmission members to move.

The third driving member 637 may be multiple linear electric machines. Each linear electric machine may be provided with multiple independently movable movers 6371. Exemplarily, when each of the first support mechanism 61 and the second support mechanism 62 includes the support structure 63 illustrated in FIG. 8, as illustrated in FIG. 8, the third driving member 637 is two linear electric machines, stators 6372 of the two linear electric machines are parallel to each other, and each linear electric machine has four movers 6371. There are two powder scooping mechanisms 70, and each powder scooping mechanism 70 is driven to operate by the motion of the four movers 6371 on the two linear electric machines. The number of the movers 6371 on each of the two linear electric machines may be more than four, which is not limited herein. By means of this arrangement, multiple identical or different powder scooping mechanisms 70 can be driven at the same time to operate, thereby improving the experimental throughput, device flexibility and universality.

The third transmission member 638 and the fourth transmission member 639 may be connected and fixed to the corresponding movers 6371, respectively. The first support mechanism 61 and the second support mechanism 62 may be rotatably connected to the corresponding transmission members, respectively.

By configuring the third driving member 637 as the linear electric machine with the multiple independently movable movers 6371, the motion of the third transmission member 638 and the fourth transmission member 639 can be realized in a simple manner, and the structure is simple.

In an embodiment, referring to FIG. 8, each of the third transmission member 638 and the fourth transmission member 639 includes a slider 6381. The slider 6381 is connected to a corresponding mover 6371 at one side of the slider 6381 facing towards the mover 6371. The slider 6381 is rotatably connected to a corresponding support member at one side of the slider 6381 facing away from the mover 6371. Each of the first support mechanism 61 and the second support mechanism 62 is a connecting rod.

The structure of the slider 6381 is not limited. The slider 6381 may be connected and fixed to the mover 6371 by means of a connection manner such as screwing, snapping, or the like. The slider 6381 can follow the motion of the mover 6371 under the drive of the stator 6372. The first support mechanism 61 and the second support mechanism 62 are configured as connecting rods, which is simple in structure and low in cost.

The manner in which the slider 6381 is rotatably connected to the corresponding support member, that is, the first support mechanism 61 or the second support mechanism 62, is not limited. Optionally, each of the third transmission member 638 and the fourth transmission member 639 further includes a connecting head 6382. The connecting head 6382 is fixedly connected to the slider 6381. The connecting head 6382 is rotatably connected to the corresponding support member. The specific structure of the connecting head 6382 is not limited, and may be configured as a structure that facilitates relative rotation with the corresponding support member. The connecting head 6382 may be connected to the slider 6381 by means of screwing, snapping, or any feasible manner, which is not limited herein. In this way, the slider 6381 can be rotatably connected to the corresponding support member through the connecting head 6382, so that the structure of the slider 6381 is simple, and the slider 6381 is easy to produce and manufacture.

Optionally, referring to FIG. 8, at least one of the third transmission member 638 or the fourth transmission member 639 further includes a connecting member 6383. One end of the connecting member 6383 is connected to a corresponding slider 6381, and the other end of the connecting member 6383 is rotatably connected to a corresponding support member.

One end of the connecting member 6383 is fixedly connected to the slider 6381 by means of screwing, snapping, or any feasible connection manner. The other end of the connecting member 6383 may be connected to a connecting head 6382, and is rotatably connected to the corresponding support member through the connecting head 6382.

The connecting member 6383 may extend for a certain length along a straight line or a curved line, and may be rod-shaped or plate-shaped, which is not limited herein. Exemplarily, as illustrated in FIG. 8, a slider 6381 of one third transmission member 638 is fixedly connected to one end of one connecting member 6383, the other end of the connecting member 6383 is fixedly connected to one connecting head 6382, and the connecting head 6382 is rotatably connected to the first support mechanism 61.

By providing the connecting member 6383, the spatial motion range of the corresponding support member can be enlarged, so that more complex adjustment of the motion posture and position of the powder scooping mechanism 70 can be achieved, and the flexibility is improved.

It can be understood that, each of the third transmission member 638 and the fourth transmission member 639 may be composed of a slider 6381 and a connecting head 6382. Alternatively, each of the third transmission member 638 and the fourth transmission member 639 may be composed of a slider 6381, a connecting head 6382, and a connecting member 6383. Alternatively, one of the third transmission member 638 and the fourth transmission member 639 is composed of a slider 6381 and a connecting head 6382, and the other of the third transmission member 638 and the fourth transmission member 639 is composed of a slider 6381, a connecting head 6382, and a connecting member 6383, which are not limited.

Optionally, referring to FIG. 8, the linear electric machine may further include a fixing plate 6375. Each of the stator 6372 and the guide member 6373 is mounted on the fixing plate 6375, and an extending direction of the stator 6372, an extending direction of the guide member 6373, and an extending direction of the fixing plate 6375 are the same. Optionally, the linear electric machine may further include an end plate 6376. One end plate 6376 is disposed at each of two opposite ends of the fixing plate 6375. The stator 6372 and the guide member 6373 may also be connected to the end plate 6376. The end plate 6376 can play a role in support and fixing, and play a role in a limitation to a maximum stroke of motion of the mover 6371. Optionally, the linear electric machine may further include a cover plate 6377. Two ends of the cover plate 6377 are connected and fixed to the end plate 6376, respectively. The cover plate 6377 is disposed right above the stator 6372 and spaced apart from the stator 6372, so as to play a protective role. The mover 6371 may be disposed at one side of the cover plate 6377 facing towards the stator 6372. The slider 6381 may be disposed at one side of the cover plate 6377 facing away from the stator 6372. The mover 6371 and the slider 6381 both exceed two edges of the cover plate 6377 in the width direction of the cover plate 6377, and are connected at the two edges of the cover plate 6377 where the mover 6371 and the slider 6381 both exceed. The cover plate 6377 may also function to guide the mover 6371 and the slider 6381.

In any of the above support structures 63, each driving member and transmission member are common structures, readily available, simple in structure, and low in cost.

Reference can be made to FIG. 6 and FIG. 7. The powder scooping apparatus 1000 further includes a translation mechanism 205. The translation mechanism 205 is connected to the first support mechanism 61 and/or the second support mechanism 62, and is configured to drive the first support mechanism 61 and/or the second support mechanism 62 on the translation mechanism 205 to move.

Optionally, the first support mechanism 61 and/or the second support mechanism 62 are disposed on the aforementioned sliding plate 204. The translation mechanism 205 is configured to drive the sliding plate 204 to move, to drive the support mechanism thereon to move. For example, both the first support mechanism 61 and the second support mechanism 62 are disposed on the sliding plate 204, and the two support mechanisms translate together. Alternatively, one of the first support mechanism 61 and the second support mechanism 62 is disposed on the sliding plate 204, and the other of the first support mechanism 61 and the second support mechanism 62 is fixedly disposed on the aforementioned mounting plate 203, so that the two support mechanisms can approach or move away from each other. The above arrangement can further improve the freedom of movement and flexibility of the powder scooping mechanism 70.

Optionally, the translation mechanism 205 includes a driving apparatus and a transmission apparatus. The driving apparatus is disposed on the aforementioned mounting plate 203. The transmission apparatus is connected to the driving apparatus and the sliding plate 204. The driving apparatus may be an electric machine or an air cylinder, etc. The transmission apparatus may be a lead screw and nut pair, a gear pair, a belt and pulley pair, etc., without limitation.

Reference can be made to FIG. 5. The powder weighing assembly 100 includes a box body 50 and a box cover 51. The box body 50 defines a cavity 52 with an opening. The moving mechanism 10, the container seat 20, and the weighing device 30 are all accommodated in the cavity 52. The box cover 51 is movably connected to the box body 50 to open or close the opening of the cavity 52. The box cover 51 defines a notch 511. When the box cover 51 closes the opening of the cavity 52, the notch 511 corresponds to the source container 3000 and the target container 2000. The powder scooping manipulator 300 may be located on one side of the powder weighing assembly 100 close to the notch 511, and is configured to extend into the cavity 52 through the notch 511. Specifically, the powder scooping robotic arm 60 of the powder scooping manipulator 300 is configured to drive the powder scooping rod 731 of the powder scooping mechanism 70 to extend into the cavity 52 through the notch 511, and further, the powder scooping rod 731 enters the target container 2000 and the source container 3000. This configuration allows the powder scooping apparatus 1000 to perform the powder transfer process through the notch 511 on the box cover 51 without opening the box cover 51, thereby improving operating efficiency.

Reference can be made to FIG. 5. The powder scooping apparatus 1000 further includes a visual inspection assembly 80. The visual inspection assembly 80 is disposed adjacent to the powder weighing assembly 100 or the container seat 20, and is configured to detect the operating state of the powder weighing assembly 100 and/or the powder scooping manipulator 300. Optionally, the visual inspection assembly 80 is disposed on the base 200.

Optionally, the visual inspection assembly 80 may be disposed outside the box body 50. Both the box body 50 and the box cover 51 are of transparent structure, or parts of the box body 50 and the box cover 51 are of transparent structure, and the visual inspection assembly 80 is configured to detect the condition of the cavity 52 through the box body 50 and the box cover 51. Specifically, the visual inspection assembly 80 may be configured to detect the position of the source container 3000 in the cavity 52, the remaining amount of powder in the source container 3000, the position of the target container 2000, the powder spilled during the process of the powder scooping manipulator 300 transferring powder from the source container 3000 to the target container 2000, as well as the position and posture of the powder scooping manipulator 300 in the container, etc., without limitation. Both the target container 2000 and the source container 3000 are transparent containers.

Optionally, the visual inspection assembly 80 may be disposed inside the box body 50. Specifically, the visual inspection assembly 80 may be disposed adjacent to the container seat 20 to collect the state of powder in the target container 2000 and the source container 3000, the posture of the powder scooping manipulator 300, etc., without limitation.

By providing the aforementioned visual inspection assembly 80, the operating conditions in the cavity 52 can be monitored by the visual inspection assembly 80, without the need for manual opening of the box cover 51 for inspection, thereby saving labor cost and time cost, and improving operating efficiency and reliability of the powder scooping apparatus 1000.

Reference can be made to FIG. 5. The visual inspection assembly 80 includes a first inspection member 82 and a second inspection member 83. The first inspection member 82 is disposed on the first side of the powder weighing assembly 100 or the container seat 20, and the second inspection member 83 is disposed on the second side of the powder weighing assembly 100 or the container seat 20, where the first side and the second side are different sides.

Optionally, the visual inspection assembly 80 further includes an inspection bracket 81. The inspection bracket 81 is disposed on the base 200 and adjacent to the powder weighing component 100. Both the first inspection member 82 and the second inspection member 83 are disposed on the inspection bracket 81.

Optionally, the first inspection member 82 is disposed on the first side of the powder weighing assembly 100, and the second inspection member 83 is disposed on the second side of the powder weighing assembly 100. The first side may be the upper side of the powder weighing assembly 100 in the first direction Z, and the second side may be one side of the powder weighing assembly 100 in the third direction X, where the third direction X intersects with both the first direction Z and the second direction Y. Specifically, when the powder scooping apparatus 1000 is placed on a horizontal plane, the first direction Z is the height direction of the powder scooping apparatus 1000, the second direction Y is the front-back direction of the powder scooping apparatus 1000, and the third direction X is the left-right direction of the powder scooping apparatus 1000. Optionally, the positions of the first inspection member 82 and the second inspection member 83 may be reversed relative to each other.

Optionally, the inspection bracket 81 can be movably connected to the base 200. Specifically, the inspection bracket 81 is movable relative to the base 200 in the first direction Z and/or the second direction Y. Optionally, both the first inspection member 82 and the second inspection member 83 can be movably connected to the inspection bracket 81. Specifically, the first inspection member 82 is movable relative to the inspection bracket 81 in the first direction Z and/or the second direction Y, and/or the second inspection member 83 is movable relative to the inspection bracket 81 in the first direction Z and/or the second direction Y, so that the first inspection member 82 and the second inspection member 83 can adjust their positions according to the positions of various components in the cavity 52 to accurately monitor the operating conditions in the cavity 52.

By providing the aforementioned first inspection member 82 and second inspection member 83, the operating conditions in the cavity 52 can be monitored from multiple different directions. Therefore, spatial positioning can be achieved and the cavity 52 can be monitored comprehensively.

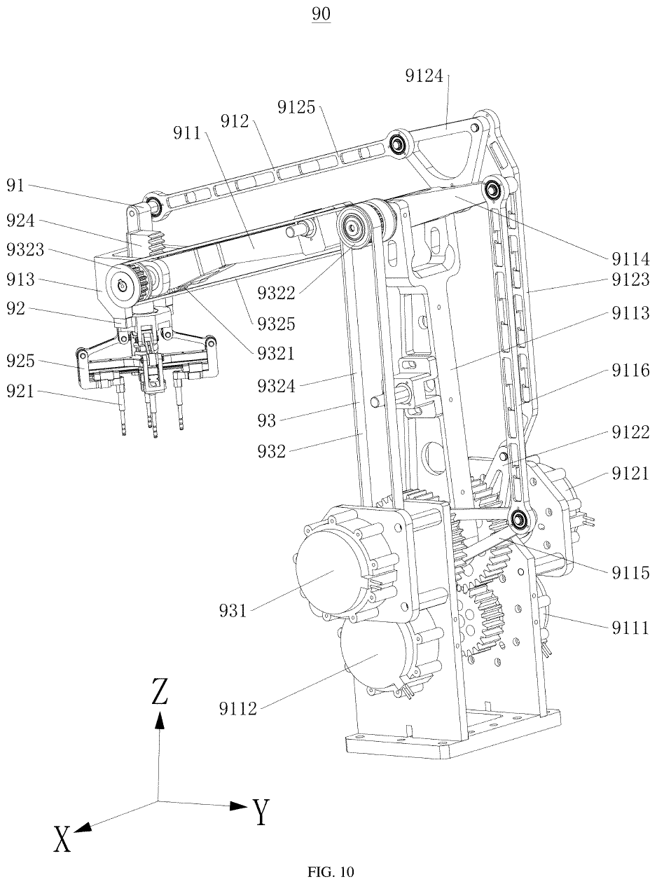

Reference can be made to FIG. 10 to FIG. 13. The powder scooping apparatus 1000 further includes a loading-and-unloading manipulator 90. The loading-and-unloading manipulator 90 is configured to pick and place the source container 3000 and the target container 2000 on the powder weighing assembly 100.

Optionally, the specific structure of the loading-and-unloading manipulator 90 is not limited. Specifically, before the loading-and-unloading manipulator 90 picks and places the source container 3000 and the target container 2000 on the powder weighing assembly 100, the aforementioned box cover 51 and the tube pressing mechanism 40 are both in an open state, and the powder weighing assembly 100 is exposed to the outside through the opening of the cavity 52 of the box body 50. The loading-and-unloading manipulator 90 is configured to grip the source container 3000 or the target container 2000 into the cavity 52, and places the target container 2000 on the first placement structure 21, or places the source container 3000 on the second placement structure 22.

By providing the loading-and-unloading manipulator 90, which is configured to pick and place the source container 3000 and target container 2000 on the powder weighing assembly 100, the loading-and-unloading processes of the source container 3000 and target container 2000 can be automated without manual operation, thereby reducing labor cost and improving operating efficiency. In addition, the loading-and-unloading manipulator 90 cooperates with the aforementioned powder scooping manipulator 300 and powder weighing assembly 100, enabling operation in a dust-free and relatively enclosed space without the need to frequently open the box cover 51 during the operating process, thereby providing a stable operating environment for the powder dispensing process. Therefore, the accuracy and operating speed of the powder dispensing process can be ensured, the frequency of manual contact with the powder scooping apparatus 1000 can be reduced, and interference with the powder scooping apparatus 1000 can be lowered.

Reference can be made to FIG. 10 to FIG. 13. The loading-and-unloading manipulator 90 includes a loading-and-unloading robotic arm 91 and a gripper 92. The gripper 92 is disposed on the loading-and-unloading robotic arm 91. The loading-and-unloading robotic arm 91 is configured to drive the gripper 92 to move. The gripper 92 includes multiple fingers 921. The multiple fingers 921 are movable towards to or away from each other.

Optionally, the loading-and-unloading robotic arm 91 is disposed on the base 200. Optionally, the multiple fingers 921 are arranged at intervals in the circumferential direction. The multiple fingers 921 are movable towards or away from each other to clamp or release the source container 3000 and target container 2000.

Optionally, the loading-and-unloading robotic arm 91 is configured to drive the gripper 92 to move to change a distance between the gripper 92 and the aforementioned container seat 20. In addition, the gripper 92 is also rotatable relative to the loading-and-unloading robotic arm 91 to adjust the angle of the gripper 92. When the placement angles of the source container 3000 and target container 2000 are different, the angle of the gripper 92 relative to the container seat 20 needs to be changed to correctly place the source container 3000 and target container 2000. Optionally, the specific structure of the loading-and-unloading robotic arm 91 is not limited, and the specific structure of the gripper 92 is also not limited.

Optionally, the number of the multiple fingers 921 may be two, three, four, etc., which is not limited. The specific structure of each finger 921 is not limited, which may be rod-shaped, block-shaped, plate-shaped, etc. Optionally, the minimum radial distance between the multiple fingers 921 should be smaller than the minimum equivalent diameter of each of the source container 3000 and target container 2000, so that the multiple fingers 921 can provide sufficient pressure and friction to the source container 3000 and target container 2000 when gripping the source container 3000 and target container 2000. Optionally, the part of the gripper 92 for contact with the source container 3000 and target container 2000 is provided with an elastic pad (not shown) with a large friction coefficient and certain resilience, which may be specifically made of materials such as rubber and silicone, and is not limited.

By providing the above loading-and-unloading manipulator 90, the source container 3000 and target container 2000 can be gripped or released by the gripper 92, and moved in cooperation with the loading-and-unloading robotic arm 91, so that the application range of the loading-and-unloading manipulator 90 can be improved, the loading-and-unloading manipulator 90 can cooperate with powder weighing assemblies 100 of various different arrangement methods.

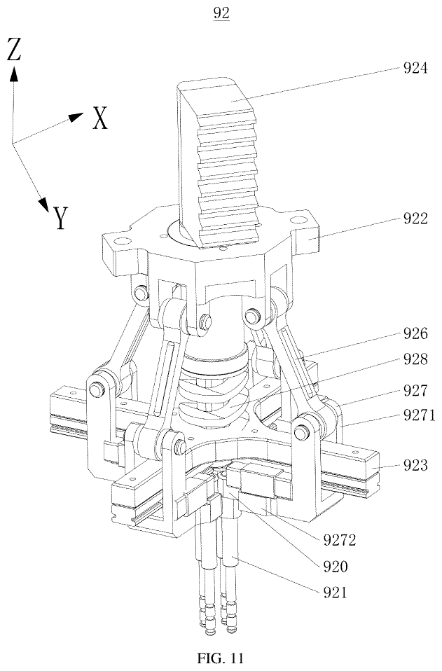

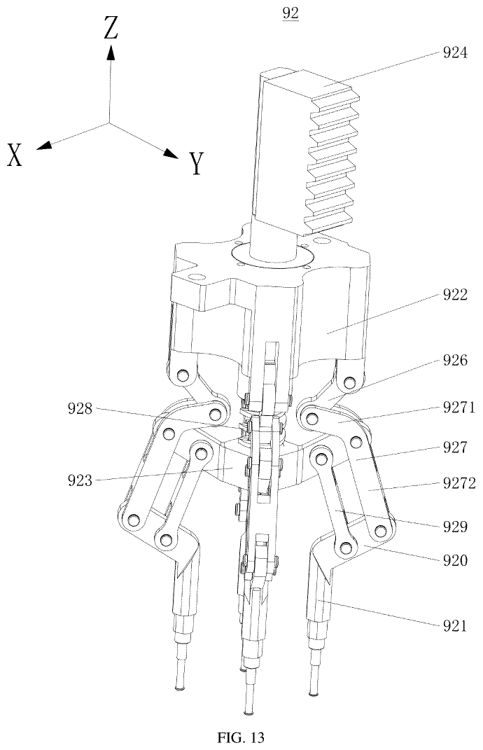

Reference can be made to FIG. 11 and FIG. 13. The gripper 92 further includes a gripper fixed seat 922, a gripper movable seat 923, a gripper transmission rod 924, and multiple gripper transmission structures 925. The gripper fixed seat 922 is connected to the loading-and-unloading robotic arm 91. The gripper transmission rod 924 is movably connected to the gripper fixed seat 922. The gripper movable seat 923 is connected to the gripper transmission rod 924. The multiple gripper transmission structures 925 are arranged at intervals in a circumferential direction of the gripper transmission rod 924 and are movably connected to both the gripper fixed seat 922 and the gripper movable seat 923. The multiple gripper transmission structures 925 are connected to the multiple fingers 921 in a one-to-one correspondence. The gripper transmission rod 924 is configured to drive the gripper movable seat 923 to move in an axial direction of the gripper transmission rod 924 to drive the multiple gripper transmission structures 925 to move. The multiple gripper transmission structures 925 are configured to drive the multiple fingers 921 to move in a radial direction of the gripper transmission rod 924.

The gripper transmission structure 925 includes a first gripper transmission member 926 and a second gripper transmission member 927. One end of the first gripper transmission member 926 is rotatably connected to the gripper fixed seat 922, the other end of the first gripper transmission member 926 is rotatably connected to one end of the second gripper transmission member 927, the other end of the second gripper transmission member 927 is connected to the finger 921, and the second gripper transmission member 927 is also movably connected to the gripper movable seat 923.

When the gripper transmission rod 924 drives the gripper movable seat 923 to approach the gripper fixed seat 922, the gripper movable seat 923 drives the multiple second gripper transmission members 927 to move outward in the radial direction of the gripper transmission rod 924, and the multiple first gripper transmission members 926 are also driven by the multiple second gripper transmission members 927 to rotate outward in the radial direction of the gripper transmission rod 924, so that the multiple fingers 921 move away from each other to open the gripper 92. At this time, the gripper 92 can release or prepare to grip the source container 3000 and the target container 2000.

When the gripper transmission rod 924 drives the gripper movable seat 923 to move away from the gripper fixed seat 922, the gripper movable seat 923 drives the multiple second gripper transmission members 927 to move inward in the radial direction of the gripper transmission rod 924, and the multiple first gripper transmission members 926 are also driven by the multiple second gripper transmission members 927 to rotate inward in the radial direction of the gripper transmission rod 924, so that the multiple fingers 921 approach each other to contract the gripper 92. At this time, the gripper 92 can grip the source container 3000 and the target container 2000.

Optionally, the gripper 92 further includes an elastic member 928. The elastic member 928 is disposed between the gripper fixed seat 922 and the gripper movable seat 923, and is connected between the gripper fixed seat 922 and the gripper movable seat 923. In the process of the gripper fixed seat 922 and the gripper movable seat 923 moving away from and approaching each other, the elastic member 928 undergoes elastic deformation to provide additional pulling force or pushing force to the gripper movable seat 923.

There is no limitation on the specific structure of the gripper transmission structure 925, and the following specific embodiments are provided for reference.

In a specific embodiment, referring to FIG. 11, both the first gripper transmission member 926 and the second gripper transmission member 927 are connecting rods. The second gripper transmission member 927 includes a first rod 9271 and a second rod 9272. The first rod 9271 and the second rod 9272 are connected and define an angle therebetween, and the angle is not limited. For example, the angle between the first rod 9271 and the second rod 9272 may be 30°, 40°, 50°, 60°, 70°, 80°, 90°, 100°, 110°, 120°, 130°, 140°, 150°, etc.

Optionally, the first rod 9271 is perpendicular to the second rod 9272, and an extending direction of the first rod 9271 is parallel to the axis of the gripper transmission rod 924. The second rod 9272 extends in the radial direction of the gripper transmission rod 924.

One end of the first rod 9271 away from the second rod 9272 is rotatably connected to the first gripper transmission member 926. One end of the second rod 9272 away from the first rod 9271 is connected to the finger 921. The gripper movable seat 923 is slidably connected to the second rod 9272. The second rod 9272 can perform translational movement in the radial direction relative to the gripper movable seat 923.

Optionally, the second rod 9272 and the gripper movable seat 923 can realize relative movement by means of slide rail and slider, slide rail and pulley, slide rod and sliding sleeve, etc., which is not limited. Optionally, the first gripper transmission member 926 may extend linearly or curvedly, which is not limited.

When the gripper transmission rod 924 drives the gripper movable seat 923 to approach the gripper fixed seat 922, the second rod 9272 translates outward in the radial direction of the gripper transmission rod 924 relative to the gripper movable seat 923, to realize the opening of the gripper 92. When the gripper transmission rod 924 drives the gripper movable seat 923 to move away from the gripper fixed seat 922, the second rod 9272 translates inward in the radial direction of the gripper transmission rod 924 relative to the gripper movable seat 923, to realize the contraction of the gripper 92.

In another specific embodiment, referring to FIG. 13, compared with the embodiment illustrated in FIG. 11, the difference in the embodiment illustrated in FIG. 13 is that the gripper movable seat 923 is rotatably connected near the junction of the first rod 9271 and the second rod 9272, and a third gripper transmission member 929 and a fourth gripper transmission member 920 are further provided. One end of the third gripper transmission member 929 is rotatably connected to the gripper movable seat 923, and the other end of the third gripper transmission member 929 is rotatably connected to the fourth gripper transmission member 920. The fourth gripper transmission member 920 is also rotatably connected to the second gripper transmission member 927. The finger 921 is connected and fixed to the fourth gripper transmission member 920. The second gripper transmission member 927, the third gripper transmission member 929, the fourth gripper transmission member 920 and the gripper movable seat 923 form a parallelogram structure, so that the finger 921 always extends in the axial direction of the gripper transmission rod 924.

Optionally, the fourth gripper transmission member 920 can be configured as the third rod of the second gripper transmission member 927. In the embodiment illustrated in FIG. 13, the third rod is rotatably connected to the second rod 9272, while in the embodiment illustrated in FIG. 11, the third rod is connected and fixed to the second rod 9272.

When the gripper transmission rod 924 drives the gripper movable seat 923 to approach the gripper fixed seat 922, the second rod 9272 rotates outward relative to the gripper movable seat 923 in the radial direction of the gripper transmission rod 924 to realize the opening of the gripper 92. When the gripper transmission rod 924 drives the gripper movable seat 923 to move away from the gripper fixed seat 922, the second rod 9272 rotates inward relative to the gripper movable seat 923 in the radial direction of the gripper transmission rod 924 to realize the contraction of the gripper 92.

By providing the above gripper 92, the space between the multiple fingers 921 can be changed by adjusting the distance between the gripper movable seat 923 and the gripper fixed seat 922 through the gripper transmission rod 924, so as to realize the gripping and releasing functions without separately providing a drive for each finger 921, thereby simplifying the structure of the gripper 92.

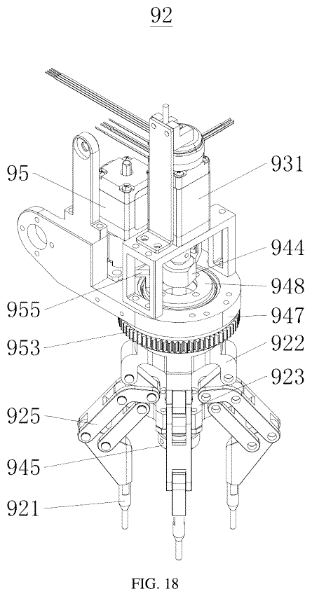

In an embodiment, referring to FIG. 18 to FIG. 20, the gripper transmission rod 924 is a spline shaft. The gripper 92 further includes a first spline-nut 941 and a second spline-nut 942. The first spline-nut 941 and the second spline-nut 942 are spaced apart from each other in the axial direction of the gripper transmission rod 924. The first spline-nut 941 and the second spline-nut 942 both are sleeved on the gripper transmission rod 924 and movably connected (such as slidably connected and/or rotatably connected) to the gripper transmission rod 924. The first spline-nut 941 is connected and fixed to the gripper fixed seat 922. The second spline-nut 942 is connected and fixed to the gripper movable seat 923.

The spline shaft, first spline-nut 941, and second spline-nut 942 together form a ball spline. A ball spline is a high-precision, orientable linear transmission component, in which the steel balls in the inner cavity of the spline nut roll back and forth in a circulating manner along the grooves of the spline shaft, thereby enabling smooth and unrestricted linear motion.

Optionally, the gripper fixed seat 922 may be connected and fixed to a side circumferential surface of the first spline-nut 941 and/or opposite surfaces of the first spline-nut 941 in the axis of the spline shaft, and no specific limitations are imposed. The connection manner between the gripper fixed seat 922 and the first spline-nut 941 may be welding, bonding, snapping, screwing, riveting, etc., which is not specifically limited.

Similarly, the connection manner between the second spline-nut 942 and the gripper movable seat 923 can refer to the aforementioned connection manner between the first spline-nut 941 and the gripper fixed seat 922, and will not be repeated here.

By configuring the gripper transmission rod 924 as a spline shaft, and the gripper fixed seat 922 and the gripper movable seat 923 are movably connected to the spline shaft through spline nuts respectively. Therefore, the transmission efficiency between the spline shaft and the spline-nut is high, and the transmission precision is good, thereby reducing the friction and movement deviation between the gripper transmission rod 924 and each of the gripper fixed seat 922 and the gripper movable seat 923.

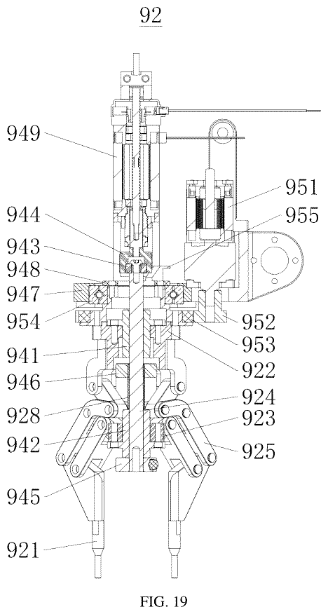

In an embodiment, as illustrated in FIG. 19, both the first spline-nut 941 and the second spline-nut 942 are slidably connected to the gripper transmission rod 924 in the axial direction of the gripper transmission rod 924. The gripper 92 further includes a gripper driving member 931. The gripper driving member 931 is connected to the gripper fixed seat 922. The gripper driving member 931 is connected to one end of the gripper transmission rod 924. The gripper driving member 931 is configured to drive the gripper transmission rod 924 to move in the axial direction of the gripper transmission rod 924.

The manner in which both the first spline-nut 941 and the second spline-nut 942 are slidingly connected to the gripper transmission rod 924 is as follows. A sliding groove is defined in the axial direction on the outer periphery of the spline shaft, and both the first spline-nut 941 and the second spline-nut 942 are connected to the sliding groove and can move along the sliding groove, so that both spline nuts can move relative to the gripper transmission rod 924 in the axial direction of the gripper transmission rod 924.

Optionally, the gripper driving member 931 is an electric machine. An output end of the gripper driving member 931 is a driving shaft of the electric machine (such as a telescopic rod). The driving shaft of the electric machine is connected to one end of the gripper transmission rod 924 and can move linearly, thereby enabling the gripper transmission rod 924 to move linearly. Alternatively, the gripper driving member 931 is an oil cylinder or an air cylinder, and the output end of the gripper driving member 931 is a piston rod of the oil cylinder or air cylinder. The piston rod of the gripper driving member 931 can perform linear telescopic movement to enable the gripper transmission rod 924 to move linearly, which is not limited.

With such an arrangement, the gripper driving member 931 can drive the gripper transmission rod 924 to move in the axial direction of the gripper transmission rod 924. When the gripper driving member 931 drives the gripper transmission rod 924 to move upward (in a direction from the gripper movable seat 923 toward the gripper fixed seat 922), the gripper transmission rod 924 drives the second spline-nut 942 to move toward the first spline-nut 941, thereby driving the gripper movable seat 923 to move toward the gripper fixed seat 922, so that the fingers 921 are opened. When the gripper driving member 931 drives the gripper transmission rod 924 to move downward (in a direction from the gripper fixed seat 922 toward the gripper movable seat 923), the gripper transmission rod 924 drives the second spline-nut 942 to move away from the first spline-nut 941, thereby driving the gripper movable seat 923 to move away from the gripper fixed seat 922, so that the fingers 921 are tightened.

In an embodiment, as illustrated in FIG. 18 and FIG. 19, the gripper transmission rod 924 can also rotate around the axis of the gripper transmission rod 924 relative to the gripper driving member 931. The gripper driving member 931 is an electric machine. The gripper transmission rod 924 is rotatably connected to the output end of the gripper driving member 931 through an adapter bearing 943.

Optionally, the adapter bearing 943 includes an inner ring and an outer ring that can move relative to each other. The inner ring of the adapter bearing 943 is sleeved on one end of the gripper transmission rod 924 and is connected and fixed to the gripper transmission rod 924. The outer ring of the adapter bearing 943 is connected and fixed to the output end of the gripper driving member 931. In this way, the gripper transmission rod 924 can rotate around the axis of the gripper transmission rod 924 relative to the gripper driving member 931. It can be understood that the gripper transmission rod 924 can also be connected and fixed to the outer ring of the adapter bearing 943, and the gripper driving member 931 can be connected and fixed to the inner ring of the adapter bearing 943, which is not limited.

Optionally, the output end of the gripper driving member 931 is provided with an adapter joint 944. The outer ring of the adapter bearing 943 is connected and fixed to the output end of the gripper driving member 931 through the adapter joint 944. The specific shape of the adapter joint 944 is not limited, as long as the adapter joint 944 can be in fit with the output end of the gripper driving member 931 and the outer ring of the adapter bearing 943.

By disposing the gripper transmission rod 924 to be rotatable relative to the gripper driving member 931 around the axis of the gripper transmission rod 924, the gripper transmission rod 924 can drive the spline nut connected to the gripper transmission rod 924 to rotate or be driven to rotate by the spline nut connected to the gripper transmission rod 924, thereby driving multiple fingers 921 to rotate, adjusting the positions of the multiple fingers 921 of the gripper 92 and facilitating the gripping of different objects.

In an embodiment, as illustrated in FIG. 18 and FIG. 19, the gripper 92 further includes a locking member 945, a limiting member 946, and an elastic member 928. The locking member 945 is disposed at one end of the gripper transmission rod 924 and located on one side of the gripper movable seat 923 facing away from the gripper fixed seat 922. The limiting member 946 is disposed on the gripper transmission rod 924 and is located between the first spline-nut 941 and the second spline-nut 942. One end of the elastic member 928 elastically abuts against the limiting member 946, and the other end of the elastic member 928 elastically abuts against the gripper movable seat 923.

The locking member 945 is connected and fixed to the end of the gripper transmission rod 924, and is configured to drive the gripper movable seat 923 to move upward when the gripper driving member 931 drives the gripper transmission rod 924 to move upward (from the gripper movable seat 923 to the gripper fixed seat 922). The locking member 945 may be ring-shaped, block-shaped, etc., which is not specifically limited.

Optionally, the limiting member 946 is connected and fixed to the gripper transmission rod 924, and the connection manner therebetween is not limited. The limiting member 946 is configured to cooperate with the elastic member 928 to drive the gripper movable seat 923 to move downward when the gripper driving member 931 drives the gripper transmission rod 924 to move downward (in the direction from the gripper fixed seat 922 to the gripper movable seat 923). The limiting member 946 may be ring-shaped, or the limiting member 946 may be multiple protrusions evenly arranged in the circumferential direction of the gripper transmission rod 924, which is not specifically limited.

Optionally, the elastic member 928 is wound around the gripper transmission rod 924. One end of the elastic member 928 abuts against the limiting member 946, and the other end of the elastic member 928 abuts against the gripper movable seat 923 or the second spline-nut 942. The elastic member 928 is preferably a compression spring or a rubber sleeve. The elastic deformation of the elastic member 928 can provide a buffer force to the gripper movable seat 923, and the elastic member 928 can provide preload force. The fit manner between the elastic member 928 and the limiting member 946 is similar to the fit manner between the aforementioned elastic member 928 and the stepped structure on the gripper transmission rod 924. In the process when the gripper transmission rod 924 drives the gripper movable seat 923 to move closer to the gripper fixed seat 922, the locking member 945 abuts against the gripper movable seat 923 to move, and the fingers 921 gradually open, while the elastic member 928 returns to its initial deformation and remains unchanged. In the process when the gripper transmission rod 924 drives the gripper movable seat 923 to move away from the gripper fixed seat 922, the limiting member 946 and the elastic member 928 jointly act to press against the gripper movable seat 923 to move, and the fingers 921 gradually tighten. To ensure the gripping force of the fingers 921, the gripper transmission rod 924 continues to move under the action of the gripper driving member 931, during which the elastic member 928 is further compressed under the action of the limiting member 946.

By providing the locking member 945, the limiting member 946, and the elastic member 928, the relative movement of the gripper movable seat 923 relative to the gripper fixed seat 922 is realized, and the opening and tightening of the finger 921 are realized.

In an embodiment, as illustrated in FIG. 18 and FIG. 19, the gripper 92 further includes a rotation mechanism 95. The rotation mechanism 95 is connected to the gripper fixed seat 922 and can drive the gripper fixed seat 922 to rotate around the axial direction of the gripper transmission rod 924.

The rotation mechanism 95 may be directly connected to the gripper fixed seat 922 or indirectly connected to the gripper fixed seat 922, which is not limited.

By providing the rotation mechanism 95, the gripper fixed seat 922 can rotate around the axial direction of the gripper transmission rod 924, thereby driving the finger 921 of the gripper 92 to rotate. Therefore, the gripping position of the gripper 92 relative to the object to be gripped can be adjusted, thereby improving the applicability of the gripper 92, such as opening and closing lids.

In an embodiment, as illustrated in FIG. 18 and FIG. 19, the first spline-nut 941 and the second spline-nut 942 are both circumferentially fixed in position relative to the gripper transmission rod 924. The rotation mechanism 95 includes a rotational driving member 951, a first rotation gear 952, and a second rotation gear 953. The rotational driving member 951 is connected to the first rotation gear 952. The second rotation gear 953 is connected to the gripper fixed seat 922. The first rotation gear 952 is engaged with the second rotation gear 953. The rotational driving member 951 is configured to drive the first rotation gear 952 to rotate, to drive the second rotation gear 953 to rotate, so as to drive the gripper fixed seat 922 and the gripper transmission rod 924 to rotate synchronously.

It can be understood that the first spline-nut 941 and the second spline-nut 942 are both circumferentially fixed in position relative to the gripper transmission rod 924, that is, the first spline-nut 941 and the second spline-nut 942 do not rotate relative to the gripper transmission rod 924. With this arrangement, under the driving of the rotational driving member 951, the first spline-nut 941, the gripper fixed seat 922, and the gripper transmission rod 924 rotate synchronously, and there is no relative rotation between the gripper fixed seat 922 and the gripper movable seat 923, thereby avoiding the gripper transmission structure 925 from twisting during rotation and avoiding affecting use.

The rotational driving member 951 may be an electric machine, cylinder, motor, etc., which is not limited. Optionally, the first rotation gear 952 is connected and fixed to the output end of the rotational driving member 951, and can rotate following the output end of the rotational driving member 951. Optionally, the second rotation gear 953 is connected and fixed to the gripper fixed seat 922, and the connection manner may be welding, bonding, snapping, screwing, riveting, etc., which is not limited.

Optionally, other transmission mechanisms (such as gears, racks, etc.) may also be provided between the first rotation gear 952 and the second rotation gear 953, and or the first rotation gear 952 may be directly engaged with the second rotation gear 953, which is not limited. Optionally, other transmission structures may be adopted to replace the first rotation gear 952 and the second rotation gear 953, such as a combination of a synchronous pulley and a synchronous belt, a worm wheel and worm mechanism, etc., which is not limited.

Optionally, the second rotation gear 953 can rotate and drive the gripper fixed seat 922 to rotate. The gripper fixed seat 922 can drive the gripper transmission rod 924 to rotate through the first spline-nut 941. Since the second spline-nut 942 can also rotate synchronously with the gripper transmission rod 924, the gripper transmission rod 924 can also drive the gripper movable seat 923 to rotate through the second spline-nut 942. Therefore, the synchronous rotation of the gripper fixed seat 922, the gripper transmission rod 924, and the gripper movable seat 923 can be established.

By providing the above rotation mechanism 95 to drive the gripper fixed seat 922 and the gripper transmission rod 924 to rotate synchronously, the transmission method is simple and efficient.

In an embodiment, as illustrated in FIG. 18 and FIG. 19, the gripper 92 further includes a mounting seat 947 and a pressing plate 948. The gripper driving member 931 and the rotation driving member 951 are both disposed on the mounting seat 947. The gripper fixed seat 922 is rotatably connected to the mounting seat 947 through a rotary bearing 954.

Optionally, the rotary bearing 954 includes an inner ring and an outer ring that can rotate relative to each other. The gripper fixed seat 922 is connected and fixed to the inner ring of the rotary bearing 954. The mounting seat 947 is connected and fixed to the outer ring of the rotary bearing 954. The rotation of the gripper fixed seat 922 relative to the mounting seat 947 can be realized through the relative rotation of the inner ring of the rotary bearing 954 and the outer ring of the rotary bearing 954.

The pressing plate 948 is disposed on the gripper fixed seat 922 and is configured to limit the rotary bearing 954 in the axial direction of the gripper transmission rod 924.

Optionally, the pressing plate 948 and the gripper fixed seat 922 may be of an integrated structure or a split structure, which is not limited. On a plane perpendicular to the axial direction of the gripper transmission rod 924, an orthographic projection of the pressing plate 948 at least partially overlaps with an orthographic projection of the rotary bearing 954. With such an arrangement, the rotary bearing 954 can be limited in the axial direction of the gripper transmission rod 924, thereby preventing the rotary bearing 954 from moving in the axial direction of the gripper transmission rod 924.

Optionally, the gripper 92 further includes a sensor (not shown) and a sensing sheet 955. The sensor is mounted on the mounting seat 947. The sensing sheet 955 is mounted on the pressing plate 948. When the rotation driving member 951 drives the gripper fixed seat 922 to rotate, the pressing plate 948 rotates following the gripper fixed seat 922, so as to drive the sensing sheet 955 to rotate relative to the sensor.

Optionally, the sensor and the sensing sheet 955 may adopt any feasible sensing-control structure known in the related art, which is not specifically limited. Optionally, the sensor may be a photoelectric coupling sensor, and the sensing sheet 955 may be a metal sheet. When the sensing sheet 955 rotates into a sensing range of the sensor, the sensor undergoes a signal change. Through the cooperation of the sensor and the sensing sheet 955, functions such as homing of the rotation driving member 951 and counting of the number of rotations can be realized.

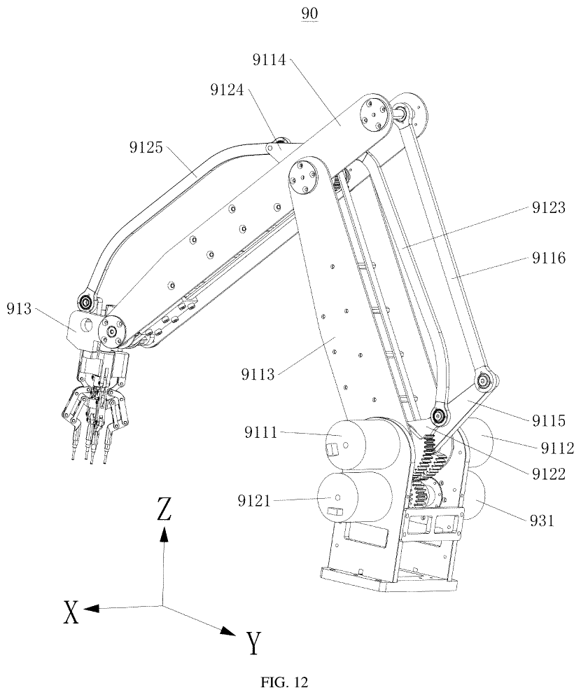

Reference can be made to FIG. 10 and FIG. 12. The loading-and-unloading robotic arm 91 includes a loading-and-unloading support arm 911, a loading-and-unloading adjustment arm 912, and a loading-and-unloading connecting seat 913. The loading-and-unloading support arm 911 is configured for movement in space. The loading-and-unloading connecting seat 913 is rotatably connected to the tail end of the loading-and-unloading support arm 911. The gripper fixed seat 922 is connected to the loading-and-unloading connecting seat 913. The loading-and-unloading adjustment arm 912 is rotatably connected to the loading-and-unloading support arm 911, and is connected to the loading-and-unloading connecting seat 913. The loading-and-unloading adjustment arm 912 is configured to drive the loading-and-unloading connecting seat 913 to rotate relative to the loading-and-unloading support arm 911.

Regarding the structure of the loading-and-unloading support arm 911, there is no limitation, and the following two specific implementations are provided.

In a specific implementation, referring to FIG. 10, the loading-and-unloading support arm 911 includes a first loading-and-unloading driving structure 9111, a second loading-and-unloading driving structure 9112, a first loading-and-unloading connecting arm 9113, a second loading-and-unloading connecting arm 9114, a third loading-and-unloading connecting arm 9115, and a fourth loading-and-unloading connecting arm 9116. Both the first loading-and-unloading driving structure 9111 and the second loading-and-unloading driving structure 9112 are disposed on the base 200. One end of the first loading-and-unloading connecting arm 9113 is connected to the first loading-and-unloading driving structure 9111, and the other end of the first loading-and-unloading connecting arm 9113 is rotatably connected to the second loading-and-unloading connecting arm 9114. One end of the second loading-and-unloading connecting arm 9114 away from the first loading-and-unloading connecting arm 9113 is rotatably connected to the loading-and-unloading connecting seat 913. One end of the third loading-and-unloading connecting arm 9115 is connected to the second loading-and-unloading driving structure 9112, and the other end of the third loading-and-unloading connecting arm 9115 is rotatably connected to one end of the fourth loading-and-unloading connecting arm 9116. The other end of the fourth loading-and-unloading connecting arm 9116 is rotatably connected to the second loading-and-unloading connecting arm 9114, and there is a spacing distance between a connection position of the fourth loading-and-unloading connecting arm 9116 and the second loading-and-unloading connecting arm 9114 and a connection position of the first loading-and-unloading connecting arm 9113 and the second loading-and-unloading connecting arm 9114.

The structures of the first loading-and-unloading driving structure 9111 and the second loading-and-unloading driving structure 9112 are similar. Taking the first loading-and-unloading driving structure 9111 as an example, the first loading-and-unloading driving structure 9111 includes a driver and a transmission. The driver is disposed on the base 200 and connected to the transmission. The transmission is connected to the first loading-and-unloading connecting arm 9113, and the transmission may also be rotatably connected to the base 200. Optionally, the first loading-and-unloading driving structure 9111 includes a first electric machine, a first gear connected to the first electric machine, and a second gear engaged with the first gear. The second gear is rotatably connected to the base 200 and connected to the first loading-and-unloading connecting arm 9113. It can be understood that the implementation of the transmission may be in other forms. For example, the combination of a synchronous pulley and a synchronous belt can be adopted instead of the first gear and the second gear, which is not limited here. In addition, the transmission may not be provided, and the driver can be connected to the first loading-and-unloading connecting arm 9113 through a coupling.

Driven by the first loading-and-unloading driving structure 9111, the first loading-and-unloading connecting arm 9113 can drive the second loading-and-unloading connecting arm 9114 and the gripper 92 to rotate around the connection position between the first loading-and-unloading connecting arm 9113 and the first loading-and-unloading driving structure 9111. Driven by the second loading-and-unloading driving structure 9112, the third loading-and-unloading connecting arm 9115 can drive the second loading-and-unloading connecting arm 9114 and the gripper 92 to rotate around the connection position between the second loading-and-unloading connecting arm 9114 and the fourth loading-and-unloading connecting arm 9116 through the fourth loading-and-unloading connecting arm 9116. Driven by the cooperation of the first loading-and-unloading driving structure 9111 and the second loading-and-unloading driving structure 9112, the gripper 92 can perform various linear or curved movements, which are not specifically limited.

In another specific implementation, referring to FIG. 12, which is basically the same as the implementation illustrated in FIG. 10, but the difference is that each of the first loading-and-unloading connecting arm 9113 and the second loading-and-unloading connecting arm 9114 includes two plate-shaped members arranged at opposite intervals and multiple connecting posts connected between the two plate-shaped members, and the two plate-shaped members of the first loading-and-unloading connecting arm 9113 and the two plate-shaped members of the second loading-and-unloading connecting arm 9114 are rotatably connected in a one-to-one correspondence.

Regarding the structure of the loading-and-unloading adjustment arm 912, there is no limitation, and the following two specific implementations are provided.

In a specific implementation, referring to FIG. 10, the loading-and-unloading adjustment arm 912 includes a third loading-and-unloading driving structure 9121, a first adjustment arm 9122, a second adjustment arm 9123, an adjustment plate 9124, and a third adjustment arm 9125. The third loading-and-unloading driving structure 9121 is disposed on the base 200. One end of the first adjustment arm 9122 is connected to the third loading-and-unloading driving structure 9121, the other end of the first adjustment arm 9122 is rotatably connected to one end of the second adjustment arm 9123. The adjustment plate 9124 is rotatably connected to the first loading-and-unloading connecting arm 9113. One end of the second adjustment arm 9123 away from the first adjustment arm 9122 is rotatably connected to the adjustment plate 9124. Two ends of the third adjustment arm 9125 are rotatably connected to the adjustment plate 9124 and the loading-and-unloading connecting seat 913 respectively. The three positions where the adjustment plate 9124 is rotatably connected to the first loading-and-unloading connecting arm 9113, the second adjustment arm 9123, and the third adjustment arm 9125 define a triangle.

The third loading-and-unloading driving structure 9121 may include a driver and a coupling. The driver may be connected to the first adjustment arm 9122 through the coupling. Alternatively, the third loading-and-unloading driving structure 9121 may include a driver and a gear set, and the driver may be connected to the first adjustment arm 9122 through the gear set. Alternatively, a combination of a synchronous pulley and a synchronous belt may be adopted to replace the aforementioned gear set. All the above methods are acceptable, and there is no specific limitation.

The first adjustment arm 9122 and the second adjustment arm 9123 may be rotatably connected by means of snapping, screwing, riveting, hinging, pivoting, shafting, etc. The connection positions of the adjustment plate 9124 with the first loading-and-unloading connecting arm 9113, the second adjustment arm 9123, and the third adjustment arm 9125 define a triangle. The triangle may be an equilateral triangle, an isosceles triangle, or a triangle with three unequal interior angles, which is not limited.

Driven by the third loading-and-unloading driving structure 9121, the first adjustment arm 9122 rotates, and drives the adjustment plate 9124 to rotate around the connection position of the first loading-and-unloading connecting arm 9113 and the adjustment plate 9124 through the second adjustment arm 9123. Since the connection positions of the adjustment plate 9124 with the first loading-and-unloading connecting arm 9113, the second adjustment arm 9123, and the third adjustment arm 9125 are relatively fixed, the third adjustment arm 9125 moves along with the rotation of the adjustment plate 9124, thereby driving the loading-and-unloading connecting seat 913 to rotate relative to the first loading-and-unloading connecting arm 9113.

In another specific implementation, referring to FIG. 12, which is basically the same as the implementation illustrated in FIG. 10, but the difference is that the first adjustment arm 9122, the second adjustment arm 9123, the adjustment plate 9124, and the third adjustment arm 9125 in the implementation illustrated in FIG. 10 are all located outside the first loading-and-unloading connecting arm 9113 and the second loading-and-unloading connecting arm 9114, while the first adjustment arm 9122, the second adjustment arm 9123, the adjustment plate 9124, and the third adjustment arm 9125 in the implementation illustrated in FIG. 12 are all disposed between the two plate-shaped members of the first loading-and-unloading connecting arm 9113 and between two plate-shaped members of the second loading-and-unloading connecting arm 9114.

By arranging the aforementioned loading-and-unloading robotic arm 91, the adjustment of the distance and position between the gripper 92 and the container seat 20 can be realized, and the adjustment of the angle between the gripper 92 and the container seat 20 can be realized at the same time, so that the gripper 92 can be adjusted according to the position of the target object, which increases the movement freedom of the gripper 92 and makes the gripper 92 more flexible.

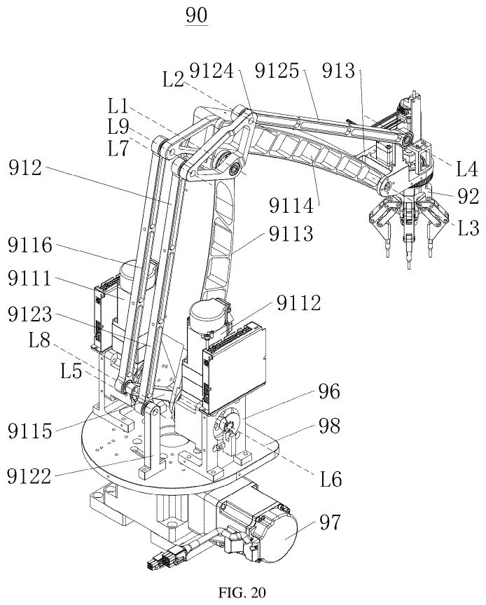

In another embodiment, as illustrated in FIG. 20, which is basically the same as the embodiment illustrated in FIG. 10, the loading-and-unloading support arm 911 also includes a first loading-and-unloading connecting arm 9113, a second loading-and-unloading connecting arm 9114, a third loading-and-unloading connecting arm 9115, a fourth loading-and-unloading connecting arm 9116, a first loading-and-unloading driving structure 9111, a second loading-and-unloading driving structure 9112, and a loading-and-unloading adjustment arm 912, and the main difference lies in the different structures of the loading-and-unloading adjustment arm 912 in FIG. 10 and the loading-and-unloading adjustment arm 912 in FIG. 20.

The loading-and-unloading manipulator 90 also includes a base seat 96. One end of the loading-and-unloading adjustment arm 912 is connected and fixed to the base seat 96, and the other end of the loading-and-unloading adjustment arm 912 is rotatably connected to the loading-and-unloading connecting seat 913. The loading-and-unloading adjustment arm 912 includes a first adjustment arm 9122, a second adjustment arm 9123, an adjustment plate 9124, and a third adjustment arm 9125. One end of the first adjustment arm 9122 is connected and fixed to the base seat 96, the other end of the first adjustment arm 9122 is rotatably connected to one end of the second adjustment arm 9123. The adjustment plate 9124 is rotatably connected to the first loading-and-unloading connecting arm 9113. One end of the second adjustment arm 9123 away from the first adjustment arm 9122 is rotatably connected to the adjustment plate 9124. Two ends of the third adjustment arm 9125 are respectively rotatably connected to the adjustment plate 9124 and the loading-and-unloading connecting seat 913. The three rotational connection positions of the adjustment plate 9124 with the first loading-and-unloading connecting arm 9113, the second adjustment arm 9123 and the third adjustment arm 9125 define a triangle.

The connection manners between respective adjustment arms and between respective adjustment arms and the adjustment plate 9124 can refer to the foregoing, and will not be repeated here.

With this configuration, the first loading-and-unloading driving structure 9111 can drive the first loading-and-unloading connecting arm 9113 to drive the second loading-and-unloading connecting arm 9114 to rotate, and the second loading-and-unloading driving structure 9112 can drive the second loading-and-unloading connecting arm 9114 to rotate around the connection position between the second loading-and-unloading connecting arm 9114 and the fourth loading-and-unloading connecting arm 9116, so that the position of the gripper 92 relative to the base seat 96 is changed. At this time, the respective adjustment arms of the loading-and-unloading adjustment arm 912 can rotate relative to each other, thereby enhancing the structural stability of the loading-and-unloading robotic arm 91 and simplifying the driving manner of the structure.

In an embodiment, as illustrated in FIG. 20, the first loading-and-unloading connecting arm 9113 is rotatably connected to the adjustment plate 9124 to rotate around a first rotation axis L1. The third adjustment arm 9125 is rotatably connected to the adjustment plate 9124 to rotate around a second rotation axis L2. The second loading-and-unloading connecting arm 9114 is rotatably connected to the loading-and-unloading connecting seat 913 to rotate around a third rotation axis L3. The third adjustment arm 9125 is rotatably connected to the loading-and-unloading connecting seat 913 to rotate around a fourth rotation axis L4. The first rotation axis L1, the second rotation axis L2, the third rotation axis L3, and the fourth rotation axis L4 are all parallel to one another. A distance between the first rotation axis L1 and the second rotation axis L2 is equal to a distance between the third rotation axis L3 and the fourth rotation axis L4. A distance between the first rotation axis L1 and the third rotation axis L3 is equal to a distance between the second rotation axis L2 and the fourth rotation axis L4.

It can be understood that the first rotation axis L1 passes through the connection position of the first loading-and-unloading connecting arm 9113 and the adjustment plate 9124, so that both the adjustment plate 9124 and the first loading-and-unloading connecting arm 9113 can rotate around the first rotation axis L1. The rotation axes between the respective adjustment arms, the respective connecting arms, and the adjustment plate 9124 are similar to the first rotation axis L1, and can be referred to without further elaboration. Optionally, the rotational connection between the respective adjustment arms, the respective connecting arms, and the adjustment plate 9124 may be established by means of hinges, shaft liners, rotating shafts, screws, nuts, etc., without specific limitations.

Optionally, the first rotation axis L1, the second rotation axis L2, the third rotation axis L3, and the fourth rotation axis L4, as well as a fifth rotation axis L5 to a ninth rotation axis L9 mentioned later, are parallel to one another. Optionally, when the loading-and-unloading manipulator 90 is placed on a horizontal plane, the first rotation axis L1 to the ninth rotation axis L9 are all parallel to the horizontal plane.

It can be understood that the distance between the first rotation axis L1 and the second rotation axis L2 is equal to the distance between the third rotation axis L3 and the fourth rotation axis L4, and the distance between the first rotation axis L1 and the third rotation axis L3 is equal to the distance between the second rotation axis L2 and the fourth rotation axis L4. With such a design, in the extending direction of the rotation axes, the first rotation axis L1, the second rotation axis L2, the third rotation axis L3, and the fourth rotation axis L4 are perpendicular to and intersect with a plane to form four intersection points, and the four intersection points are connected in sequence to form a parallelogram. Specifically, on the plane which is perpendicular to the extending direction of all rotation axes, two points formed by the perpendicular intersection of the first rotation axis L1 and the second rotation axis L2 with the plane, and two points formed by the perpendicular intersection of the third rotation axis L3 and the fourth rotation axis L4 with the plane, constitute one pair of equal edges. Two points formed by the perpendicular intersection of the first rotation axis L1 and the third rotation axis L3 with the plane, and two points formed by the perpendicular intersection of the second rotation axis L2 and the fourth rotation axis L4 with the plane, constitute another pair of equal edges.

With such a design, the first loading-and-unloading driving structure 9111 can drive the first loading-and-unloading connecting arm 9113 to drive the second loading-and-unloading connecting arm 9114 to rotate, and the second loading-and-unloading driving structure 9112 can drive the second loading-and-unloading connecting arm 9114 to rotate around the connection position between the second loading-and-unloading connecting arm 9114 and the fourth loading-and-unloading connecting arm 9116, so that the position of the gripper 92 relative to the base seat 96 is changed. At this time, projections of the rotation axes between the second loading-and-unloading connecting arm 9114, the third adjustment arm 9125, the loading-and-unloading connecting seat 913, and the adjustment plate 9124 always form a parallelogram, and act in coordination with one another, thereby ensuring the stability of the gripper 92 during movement in space.

In an embodiment, the first adjustment arm 9122 is rotatably connected to the second adjustment arm 9123 to rotate around a fifth rotation axis L5. The first loading-and-unloading driving structure 9111 drives the first loading-and-unloading connecting arm 9113 to rotate around a sixth rotation axis L6. The second adjustment arm 9123 is rotatably connected to the adjustment plate 9124 to rotate around a seventh rotation axis L7. The first rotation axis L1, the fifth rotation axis L5, the sixth rotation axis L6, and the seventh rotation axis L7 are parallel to one another. A distance between the first rotation axis L1 and the sixth rotation axis L6 is equal to a distance between the fifth rotation axis L5 and the seventh rotation axis L7. A distance between the first rotation axis L1 and a seventh rotation axis L7 is equal to a distance between the fifth rotation axis L5 and the sixth rotation axis L6.

Similarly, in the extending direction of the rotation axes, the first rotation axis L1, the fifth rotation axis L5, the sixth rotation axis L6, and the seventh rotation axis L7 are perpendicular to and intersect with a plane to form four intersection points, and the four intersection points are connected in sequence to form a parallelogram. For the specific manner, reference can be made to the aforementioned first rotation axis L1, second rotation axis L2, third rotation axis L3, and fourth rotation axis L4, and no further details will be provided.

Optionally, when the loading-and-unloading robotic arm 91 in the embodiment of FIG. 10 and FIG. 12 is adopted, the first adjustment arm 9122 can be driven by the third loading-and-unloading driving structure 9121 to rotate, and the rotation axis of the first adjustment arm 9122 coincides with the sixth rotation axis L6. At this time, in the extending direction of the rotation axes, the first rotation axis L1, the fifth rotation axis L5, the sixth rotation axis L6, and the seventh rotation axis L7 are perpendicular to and intersect a plane to form four intersection points, and the four intersection points are connected in sequence to form a parallelogram. This parallelogram structure can operate in coordination to drive the loading-and-unloading connecting seat 913 to rotate relative to the second loading-and-unloading connecting arm 9114, thereby enabling adjustment of the gripping direction of the gripper 92, so that the gripper 92 can perform pitching motion and the gripper 92 is prevented from moving randomly when adjusting the direction.

When the loading-and-unloading robotic arm 91 in the embodiment of FIG. 20 is adopted, one end of the first adjustment arm 9122 is fixed relative to the base seat 96, at this time, in the extending direction of the rotation axes, the first rotation axis L1, the fifth rotation axis L5, the sixth rotation axis L6, and the seventh rotation axis L7 are perpendicular to and intersect a plane to form four intersection points, and the four intersection points are connected in sequence to form a parallelogram. Therefore, one edge of the parallelogram structure is relatively fixed (i.e., a line connecting the fifth rotation axis L5 and the sixth rotation axis L6). When the first loading-and-unloading driving structure 9111 drives the first loading-and-unloading connecting arm 9113 to drive the second loading-and-unloading connecting arm 9114 to rotate, and the second loading-and-unloading driving structure 9112 drives the second loading-and-unloading connecting arm 9114 to rotate around the connection position between the second loading-and-unloading connecting arm 9114 and the fourth loading-and-unloading connecting arm 9116, in the above parallelogram structure, the connecting line between the fifth rotation axis L5 and the sixth rotation axis L6 and the connecting line between the fifth rotation axis L5 and the seventh rotation axis L7 can undergo relative rotation, thereby ensuring that the loading-and-unloading robotic arm 91 can rotate smoothly, avoiding jamming, enhancing the structural stability of the loading-and-unloading robotic arm 91, and simplifying the driving manner of the structure.

In an embodiment, an output shaft of the second loading-and-unloading driving structure 9112 coincides with an output shaft of the first loading-and-unloading driving structure 9111. The second loading-and-unloading driving structure 9112 is configured to drive the third loading-and-unloading connecting arm 9115 to rotate around the sixth rotation axis L6. A rotation axis of the rotational connection between the first loading-and-unloading connecting arm 9113 and the second loading-and-unloading connecting arm 9114 coincides with the first rotation axis L1. The third loading-and-unloading connecting arm 9115 is rotatably connected to the fourth loading-and-unloading connecting arm 9116 to rotate around the eighth rotation axis L8. The fourth loading-and-unloading connecting arm 9116 is rotatably connected to the second loading-and-unloading connecting arm 9114 to rotate around the ninth rotation axis L9. The first rotation axis L1, the sixth rotation axis L6, the eighth rotation axis L8, and the ninth rotation axis L9 are parallel to one another. The distance between the first rotation axis L1 and the sixth rotation axis L6 is equal to a distance between the eighth rotation axis L8 and the ninth rotation axis L9. A distance between the first rotation axis L1 and the ninth rotation axis L9 is equal to a distance between the sixth rotation axis L6 and the eighth rotation axis L8.

Optionally, the sixth rotation axis L6 passes through the connection position between the first loading-and-unloading connecting arm 9113 and the first loading-and-unloading driving structure 9111 as well as the connection position between the third loading-and-unloading connecting arm 9115 and the second loading-and-unloading driving structure 9112. In the extending direction of the rotation axes, the first rotation axis L1, the sixth rotation axis L6, the eighth rotation axis L8, and the ninth rotation axis L9 are perpendicular to and intersect a plane to form four intersection points. The four intersection points are connected in sequence to form a parallelogram. The specific manner can refer to the aforementioned first rotation axis L1, second rotation axis L2, third rotation axis L3, and fourth rotation axis L4, and will not be repeated here.

With such a design, when the second loading-and-unloading driving structure 9112 drives the second loading-and-unloading connecting arm 9114 to rotate around the connection position between the second loading-and-unloading connecting arm 9114 and the fourth loading-and-unloading connecting arm 9116, causing the position of the gripper 92 relative to the base seat 96 to change, the parallelogram structure formed by its rotation axes ensures that all connecting arms always act in coordination, thereby ensuring the stability of the movement of the gripper 92.

Optionally, the rotation axes of the loading-and-unloading support arm 911 and the loading-and-unloading adjustment arm 912 of the loading-and-unloading manipulator 90 can be designed to meet any one or a combination of the above three parallelogram structures. In a specific implementation, as illustrated in FIG. 20, the first rotation axis L1 to the ninth rotation axis L9 are parallel to one another. The distance between the first rotation axis L1 and the second rotation axis L2 is equal to the distance between the third rotation axis L3 and the fourth rotation axis L4. The distance between the first rotation axis L1 and the third rotation axis L3 is equal to the distance between the second rotation axis L2 and the fourth rotation axis L4. The distance between the first rotation axis L1 and the sixth rotation axis L6 is equal to the distance between the fifth rotation axis L5 and the seventh rotation axis L7. The distance between the first rotation axis L1 and the seventh rotation axis L7 is equal to the distance between the fifth rotation axis L5 and the sixth rotation axis L6. The distance between the first rotation axis L1 and the sixth rotation axis L6 is equal to the distance between the eighth rotation axis L8 and the ninth rotation axis L9. The distance between the first rotation axis L1 and the ninth rotation axis L9 is equal to the distance between the sixth rotation axis L6 and the eighth rotation axis L8. Optionally, different loading-and-unloading manipulators 90 in the embodiments of the present disclosure all meet the above requirements.

Reference can be made to FIG. 10 and FIG. 12. The loading-and-unloading manipulator 90 further includes a gripper driving structure 93. The gripper driving structure 93 is in transmission connection with the gripper transmission rod 924, and is configured to drive the gripper transmission rod 924 to move. Optionally, the gripper driving structure 93 is disposed on the gripper fixed seat 922, or the gripper driving structure 93 is disposed on the loading-and-unloading robotic arm 91.

Optionally, the gripper driving structure 93 includes a gripper driving member 931 and a transmission mechanism. The gripper driving member 931 may be disposed on the gripper fixed seat 922 or on the loading-and-unloading robotic arm 91. The gripper driving member 931 is connected to the transmission mechanism. The transmission mechanism is connected to the gripper transmission rod 924. The gripper driving member 931 is configured to drive the gripper transmission rod 924 to move through the transmission mechanism, so that the multiple fingers 921 approach or move away from each other.

Optionally, the gripper driving member 931 is an electric machine, specifically a servo electric machine, a stepping electric machine, etc. The electric machine may be integrated with a speed reducer, a transmission, a brake, or the like, which is not limited. The transmission mechanism may be a coupling, a lead screw and nut pair, a gear and rack pair, a worm wheel and worm pair, etc., which is not limited.

Optionally, the gripper driving member 931 is disposed on the gripper fixed seat 922, the gripper driving member 931 is a linear stepping electric machine, and the transmission mechanism is a lead screw and nut pair. A lead screw of the lead screw and nut pair is connected and fixed to an output shaft of the gripper driving member 931, and a nut of the lead screw and nut pair is connected and fixed to the gripper transmission rod 924. The gripper driving member 931 is configured to drive the screw to rotate, so that the nut can drive the gripper transmission rod 924 to perform linear movement.

Optionally, the gripper driving member 931 is disposed on the gripper fixed seat 922, the gripper driving member 931 is a through-shaft linear stepping electric machine, and the transmission mechanism is a coupling. One end of the transmission mechanism is connected and fixed to a lead screw of the gripper driving member 931, and the other end of the transmission mechanism is connected and fixed to the gripper transmission rod 924. The lead screw of the gripper driving member 931 is configured to perform linear movement to drive the gripper transmission rod 924 to move.

Optionally, the gripper driving member 931 is disposed on the loading-and-unloading robotic arm 91, the gripper driving member 931 is an electric machine, and the transmission mechanism is a belt transmission mechanism 932. The belt transmission mechanism 932 includes a mating member 9321, a first synchronous pulley, a second synchronous pulley 9322, a third synchronous pulley 9323, a first synchronous belt 9324, and a second synchronous belt 9325. The first synchronous pulley is connected to the gripper driving member 931. The first synchronous pulley and the second synchronous pulley 9322 are connected through the first synchronous belt 9324. The second synchronous pulley 9322 and the third synchronous pulley 9323 are connected through the second synchronous belt 9325. The second synchronous pulley 9322 is rotatably connected to the first loading-and-unloading connecting arm 9113. The third synchronous pulley 9323 is in fit connection with the mating member 9321. The mating member 9321 is in transmission connection with the gripper transmission rod 924.

The belt transmission mechanism 932 may also be any other feasible belt transmission mechanism 932, without limitation. The belt transmission mechanism 932 can transmit power through the friction generated when the first synchronous pulley, the second synchronous pulley 9322, and the third synchronous pulley 9323 are tensioned with the first synchronous belt 9324 and the second synchronous belt 9325. Therefore, the transmission structure is simple and the operation is stable.

Optionally, the mating member 9321 and the gripper transmission rod 924 are engaged with each other through a rack and a gear, so that the rotational motion of the gear can be converted into the reciprocating linear motion of the rack, so as to drive the gripper transmission rod 924 to move linearly with high transmission efficiency. Exemplarily, the mating member 9321 is a gear, the gear is connected and fixed to the third synchronous pulley 9323, one end of the gripper transmission rod 924 away from the gripper movable seat 923 is connected and fixed to a rack, and the gear is engaged with the rack. When the third synchronous pulley 9323 is driven to rotate, the third synchronous pulley 9323 drives the gear to rotate, and the gear drives the rack to move, so that the gripper transmission rod 924 performs linear movement. Optionally, the mating member 9321 may be in transmission connection with the gripper transmission rod 924 through a worm wheel and worm pair or other structures, without limitation.

By providing the aforementioned gripper driving structure 93 to drive the gripper transmission rod 924 to move, the multiple fingers 921 of the gripper 92 can move in the radial direction of the gripper transmission rod 924 through the linear movement of the gripper transmission rod 924, with a simple structure and high transmission efficiency.

In an embodiment, as illustrated in FIG. 20, the loading-and-unloading manipulator 90 further includes a rotating driving member 97 and a rotary disc 98. The base seat 96 is connected and fixed to the rotary disc 98. The rotating driving member 97 is connected to the rotary disc 98 and can drive the rotary disc 98 to rotate.

The rotating driving member 97 may be an electric machine, a cylinder, a motor, etc., which is not limited. Optionally, the rotating driving member 97 can drive the rotary disc 98 to rotate through a transmission mechanism (such as a gear and rack pair or a gear set, etc.), thereby driving the base seat 96, and the loading-and-unloading support arm 911, loading-and-unloading adjustment arm 912, and gripper 92 that are connected to the base seat 96 to rotate synchronously.

With such an arrangement, the loading-and-unloading manipulator 90 or gripper 92 can grip objects located therearound, thereby expanding the operable range.

In each of the above embodiments, the rotational connection manner between the components may be hinging, pivoting, shafting, riveting, etc., without limitation. For example, the rotational connection may be established by a structure such as a rotating shaft or a universal joint.

Optionally, the powder scooping apparatus 1000 further includes a cap opening-and-closing assembly (not shown). The cap opening-and-closing assembly is configured to open and close the source container 3000 and/or the target container 2000 moved by the loading-and-unloading manipulator 90. For example, the container is opened before powder transfer, and closed after powder transfer. The specific structure of the cap opening-and-closing assembly is not limited. Exemplarily, the cap opening-and-closing assembly includes a bottle-body clamping mechanism for fixing the bottle body, a bottle-cap clamping mechanism for fixing the bottle cap, and a cap opening-and-closing driving mechanism for driving the relative movement of the bottle-body clamping mechanism and the bottle-cap clamping mechanism.

The cap opening-and-closing manner of the source container 3000 and the target container 2000 is not limited, and may be a rotary cap opening-and-closing manner or a cap plug-in and plug-out manner.

By providing the cap opening-and-closing assembly, which is configured to open and close the source container 3000 and/or the target container 2000 moved by the loading-and-unloading manipulator 90, the opening and closing process of the source container 3000 and target container 2000 can be automated without manual operation, thereby improving operating efficiency.

Optionally, the powder scooping apparatus 1000 may further include, but is not limited to, one or more combinations of a liquid-dispensing assembly, a mixing assembly, a filtering assembly, a testing assembly, etc. The liquid-dispensing assembly is configured to quantitatively dispense liquid to the target container 2000 after powder addition. The mixing assembly is configured to mix the solid and liquid in the target container 2000 after addition of powder and liquid. The mixing assembly may be one or more of an oscillator, a temperature-controlled magnetic stirrer, a centrifuge, etc. The filtering assembly is configured to filter the solution in the target container 2000. The testing assembly is configured to test the solution, for example, by visual inspection to obtain a state of the solution, by liquid chromatography-mass spectrometry (LCMS) detection to obtain related properties of the solution, and by rheometer detection to obtain mechanical properties of the solution, etc.

Optionally, the loading-and-unloading manipulator 90 may be disposed on a ground rail, so that the loading-and-unloading manipulator 90 can perform material interaction between modules such as the powder weighing assembly 100, the cap opening-and-closing assembly, the liquid-dispensing assembly, the mixing assembly, the filtering assembly, and the testing assembly, so as to expand the operating range of the loading-and-unloading manipulator 90 and realize a fully automated experimental process.

The present disclosure further provides an experimental device (not shown). The experimental device includes the powder weighing assembly 100 of any of the foregoing embodiments. The experimental device may be configured for various experiments, not limited to the aforementioned powder transfer.

The present disclosure further provides an experimental device (not shown). The experimental device includes the powder scooping apparatus 1000 of any of the foregoing embodiments. The experimental device can transfer powder through the powder scooping apparatus 1000 to achieve the required experimental operations.

The aforementioned experimental devices are each characterized by flexible adjustability, automatic operation, and strong adaptability.

In the description of embodiments of the present disclosure, it may be noted that orientation or positional relations indicated by terms such as “center”, “on”, “under”, “left”, “right”, “vertical”, “horizontal”, “in”, “out”, and the like are orientation or positional relations based on the accompanying drawings, only for facilitating description of the present disclosure and simplifying the description, rather than explicitly or implicitly indicating the referred apparatuses or elements must be in a particular orientation or constructed or operated in the particular orientation, and therefore they may not be construed as limiting the present disclosure.

The above embodiments are only one of preferable embodiments of the present disclosure, and cannot be used to limit the scope of the claims of the present disclosure. Those of ordinary skill in the art can understand all or a part of the process to realize the above embodiments of the present disclosure, and the equivalent changes made in accordance with the claims of the present disclosure still belong to the scope of the present disclosure.

What is claimed is:

1. A powder weighing assembly, comprising a moving mechanism, a container seat, and a weighing device, wherein the moving mechanism is connected to the container seat and/or the weighing device, and is configured to cause relative movement between the container seat and the weighing device, to enable the container seat and the weighing device to be in contact with or separated from each other in a first direction;
the container seat comprises a first placement structure and a second placement structure, the first placement structure is configured for placement of a target container to be filled with powder, and the second placement structure is configured for placement of a source container filled with powder; and the weighing device is disposed on one side of the container seat in the first direction, and is configured to be in contact with the container seat and weigh the container seat.

2. The powder weighing assembly of claim 1, wherein the moving mechanism is connected to the container seat and is configured to drive the container seat to lift in the first direction; the container seat further comprises a seat body, the seat body is connected to the moving mechanism, the first placement structure and the second placement structure are both disposed on the seat body, and the second placement structure protrudes from one side of the first placement structure away from the weighing device or the second placement structure is flush with the first placement structure in the first direction; the first placement structure is spaced apart from the second placement structure in the first direction and/or a second direction, and the second direction intersects with the first direction; and an extending direction of the source container on the second placement structure is configured to intersect with the first direction, and an extending direction of the target container on the first placement structure is configured to be parallel to or intersect with the extending direction of the source container on the second placement structure.

3. The powder weighing assembly of claim 2, wherein the first placement structure comprises a bottom support, a limiting block, and a connecting rod, the bottom support is spaced apart from the limiting block in the first direction, the bottom support is located on one side of the limiting block facing the weighing device, the bottom support and/or the limiting block are connected and fixed to the seat body, the connecting rod is disposed between the bottom support and the limiting block, one end of the connecting rod is connected to the bottom support, another end of the connecting rod is connected to the limiting block, the limiting block defines a limiting hole for accommodation of the target container, and the bottom support is configured to support the target container; and/or
the second placement structure comprises a first stand and a second stand, the first stand and the second stand are disposed on the seat body at intervals in the second direction, one end of the first stand away from the seat body defines a first accommodating groove, one end of the second stand away from the seat body defines a second accommodating groove, and the first accommodating groove and the second accommodating groove are configured for collective accommodation of the source container; and in the second direction, a distance between the first stand and the first placement structure is less than a distance between the second stand and the first placement structure, and in the first direction, a distance between the first accommodating groove and the first placement structure is greater than a distance between the second accommodating groove and the first placement structure; and an opening of the source container is configured to be defined on one side of the first stand facing away from the second stand, and the opening of the source container is configured to be higher than an opening of the target container.

4. The powder weighing assembly of claim 2, wherein the first placement structure is spaced apart from the second placement structure in the first direction; the container seat further comprises a first stand and a second stand, the first stand and the second stand are disposed on the seat body at intervals in the second direction, the first stand defines a first accommodating groove from one end of the first stand away from the seat body toward another end of the first stand close to the seat body, and the second stand defines a second accommodating groove from one end of the second stand away from the seat body toward another end of the second stand close to the seat body; one end of the first accommodating groove close to the seat body and one end of the second accommodating groove close to the seat body jointly form the first placement structure, and are configured for collective accommodation of the target container; and another end of the first accommodating groove away from the seat body and another end of the second accommodating groove away from the seat body jointly form the second placement structure, and are configured for collective accommodation of the source container; and
in the first direction, a distance between the end of the first accommodating groove close to the seat body and the seat body is greater than a distance between the end of the second accommodating groove close to the seat body and the seat body, a distance between said another end of the first accommodating groove away from the seat body and the seat body is greater than a distance between said another end of the second accommodating groove away from the seat body and the seat body, and an opening of the source container and an opening of the target container are both configured to be located on one side of the first stand facing away from the second stand.

5. The powder weighing assembly of claim 1, wherein the powder weighing assembly further comprises a tube pressing mechanism, and the tube pressing mechanism is configured to press the source container against the second placement structure; and the tube pressing mechanism comprises a tube pressing driving member, a tube pressing transmission member, and a tube pressing arm, the tube pressing transmission member is connected to the tube pressing driving member and the tube pressing arm, the tube pressing driving member is configured to drive the tube pressing arm to move through the tube pressing transmission member, and one end of the tube pressing arm away from the tube pressing transmission member is configured to press the source container against the second placement structure.

6. The powder weighing assembly of claim 5, wherein the tube pressing arm comprises a tube pressing plate and a tube pressing head, one end of the tube pressing plate is connected and fixed to the tube pressing transmission member, the tube pressing head is disposed at one end of the tube pressing plate away from the tube pressing transmission member and is disposed on one side of the tube pressing plate facing the second placement structure, the tube pressing head has a pressing surface, and the pressing surface is configured to press against a sidewall of the source container, to enable the tube pressing head to press the source container; and/or
the tube pressing mechanism further comprises a first support plate and a second support plate, and the first support plate and the second support plate are located on opposite sides of the container seat and are adjacent to the second placement structure; the tube pressing transmission member comprises a tube pressing transmission structure and a rotating shaft, the tube pressing transmission structure is connected to the tube pressing driving member and the rotating shaft, the tube pressing driving member is disposed on the first support plate or the second support plate and is configured to drive the rotating shaft to rotate through the tube pressing transmission structure, the rotating shaft is located between the first support plate and the second support plate, two ends of the rotating shaft are respectively rotatably connected to the first support plate and the second support plate, and the tube pressing arm is connected and fixed to the rotating shaft; the tube pressing arm is located on one side of the second placement structure facing away from the weighing device; and the moving mechanism is located between the first support plate and the second support plate and is located on one side of the tube pressing arm facing the weighing device.

7. The powder weighing assembly of claim 6, wherein the powder weighing assembly further comprises a box body and a box cover, the box body defines a cavity with an opening, the moving mechanism, the container seat, the weighing device, and the tube pressing mechanism are all accommodated in the cavity, and the box cover is movably connected to the box body to open or close the opening of the cavity;
the box cover is rotatably connected to the box body, the tube pressing arm further comprises an abutting head, the abutting head is disposed on one side of the tube pressing plate facing away from the tube pressing head, and the abutting head is configured to abut against the box cover and drive the box cover to rotate under the driving of the tube pressing plate, to open or close the opening of the cavity; and
the box cover defines a notch, and the notch is configured to correspond to the source container and the target container when the opening of the cavity is closed by the box cover.

8. The powder weighing assembly of claim 1, wherein the powder weighing assembly further comprises a tube clamping mechanism, the tube clamping mechanism is configured to pick and place the target container on the first placement structure and/or pick and place the source container on the second placement structure; and the tube clamping mechanism comprises a clamping assembly, a rotating assembly, and a first moving assembly, the rotating assembly is connected to the clamping assembly and the first moving assembly, the first moving assembly is configured to drive the rotating assembly and the clamping assembly to move synchronously, the rotating assembly is configured to drive the clamping assembly to rotate, and the clamping assembly is configured to clamp the target container and/or the source container.

9. The powder weighing assembly of claim 8, wherein the first moving assembly comprises a first lifting assembly, the first lifting assembly is connected to the rotating assembly, the first lifting assembly is configured to drive the rotating assembly and the clamping assembly to lift synchronously; and/or, the first moving assembly comprises a first translation assembly, the first translation assembly is connected to the rotating assembly, and the first translation assembly is configured to drive the rotating assembly and the clamping assembly to translate synchronously; and/or
the powder weighing assembly further comprises a buffer seat, the buffer seat is configured to temporarily store the source container and/or the target container, and the tube clamping mechanism is also configured to pick and place the source container and/or the target container on the buffer seat; and the buffer seat and the tube clamping mechanism are respectively located on opposite sides of the container seat and are adjacent to the second placement structure; and/or
the powder weighing assembly further comprises a powder vibration mechanism, the powder vibration mechanism comprises a mounting arm, a powder vibration driving member, and a powder vibration member, the powder vibration driving member is connected to the mounting arm and the powder vibration member, and the powder vibration driving member is configured to drive the powder vibration member to move when the powder vibration member is in contact with the source container, to enable the source container to vibrate.

10. The powder weighing assembly of claim 9, wherein the powder vibration mechanism further comprises a second moving assembly, the second moving assembly is connected to the mounting arm, the second moving assembly is configured to drive the mounting arm, the powder vibration driving member, and the powder vibration member to move synchronously;
the second moving assembly comprises a second lifting assembly, the second lifting assembly is connected to the mounting arm, the second lifting assembly is configured to drive the mounting arm, the powder vibration driving member, and the powder vibration member to lift synchronously; and/or, the second moving assembly comprises a second translation assembly, the second translation assembly is connected to the mounting arm, the second translation assembly is configured to drive the mounting arm, the powder vibration driving member, and the powder vibration member to translate synchronously; and/or
the powder vibration driving member comprises at least one of a rotary electric machine or a vibration motor, and the powder vibration member comprises at least one of a cam, a tapping rod, or a whip.

11. The powder weighing assembly of claim 1, wherein the powder weighing assembly further comprises a box body and a box cover, the box body defines a cavity with an opening, the moving mechanism, the container seat, and the weighing device are all accommodated in the cavity, and the box cover is movably connected to the box body to open or close the opening of the cavity; and
the box cover defines a notch, and the notch is configured to correspond to the source container and the target container when the opening of the cavity is closed by the box cover.

12. The powder weighing assembly of claim 11, wherein the box cover has a first cover surface and a second cover surface connected to each other, the notch is defined on the second cover surface, the second cover surface protrudes from the first cover surface in the first direction, the box body defines an avoidance opening, part of the second cover surface protruding from the first cover surface is configured to extend into the avoidance opening, at least the part of the second cover surface protruding from the first cover surface is concave toward the cavity, and the avoidance opening is configured for accommodation of at least part of a powder scooping rod when the box cover moves relative to the box body; and/or
the powder weighing assembly further comprises a door shield, the door shield is adjacent to the box cover and is movable relative to the box cover; when the opening of the cavity is closed by the box cover, the door shield is configured to move to the notch and block part of the notch; and the door shield defines a first avoidance groove and a second avoidance groove, and when the door shield moves to the notch, the first avoidance groove is configured to correspond to the source container, and the second avoidance groove is configured to correspond to the target container.

13. The powder weighing assembly of claim 1, wherein the powder weighing assembly further comprises a windproof enclosure, the windproof enclosure is disposed around the weighing device; and/or, the powder weighing assembly further comprises an electrostatic elimination mechanism, the electrostatic elimination mechanism is disposed facing toward the weighing device, the electrostatic elimination mechanism is configured to eliminate static electricity at the weighing device and the container seat; and/or, the powder weighing assembly further comprises a visual inspection assembly, the visual inspection assembly is disposed facing toward the container seat, and the visual inspection assembly is configured to detect a powder state of the target container and/or the source container, and/or the visual inspection assembly is configured to detect an operating state of a powder scooping rod at the container seat.

14. A powder scooping apparatus, comprising a powder scooping manipulator and a powder weighing assembly, wherein the powder weighing assembly comprises a moving mechanism, a container seat, and a weighing device, the moving mechanism is connected to the container seat and/or the weighing device, and is configured to cause relative movement between the container seat and the weighing device, to enable the container seat and the weighing device to be in contact with or separated from each other in a first direction; the container seat comprises a first placement structure and a second placement structure, the first placement structure is configured for placement of a target container to be filled with powder, and the second placement structure is configured for placement of a source container filled with powder; the weighing device is disposed on one side of the container seat in the first direction, and is configured to be in contact with the container seat and weigh the container seat; and the powder scooping manipulator is configured to scoop powder from the source container and transfer the powder into the target container; and
the powder scooping manipulator comprises a powder scooping robotic arm and a powder scooping mechanism, the powder scooping mechanism is disposed on the powder scooping robotic arm, the powder scooping robotic arm is configured to drive the powder scooping mechanism to move between the source container and the target container, and the powder scooping mechanism is configured to scoop the powder from the source container and pour the powder into the target container.

15. The powder scooping apparatus of claim 14, wherein the powder scooping mechanism comprises a powder scooping rod, the powder scooping apparatus further comprises a powder-scooping-member pick-and-place mechanism, the powder-scooping-member pick-and-place mechanism comprises a seat-rotation driving member, a loading seat, and an unloading seat, both the loading seat and the unloading seat are connected to the seat-rotation driving member, and the seat-rotation driving member is configured to drive the loading seat and the unloading seat to rotate; and the loading seat defines a receiving groove, the receiving groove is configured for placement of the powder scooping rod to enable the powder scooping robotic arm to be connected to the powder scooping rod, the unloading seat defines a slot, and the slot is configured to be snap-fitted with the powder scooping rod to separate the powder scooping rod from the powder scooping robotic arm; and/or
the powder scooping robotic arm comprises a first support mechanism and a second support mechanism spaced apart from the first support mechanism, both the first support mechanism and the second support mechanism are connected to the powder scooping mechanism, and the first support mechanism and/or the second support mechanism is movable to adjust a spatial position of the powder scooping mechanism.

16. The powder scooping apparatus of claim 15, wherein the powder scooping apparatus further comprises a translation mechanism, the translation mechanism is connected to the first support mechanism and/or the second support mechanism, and the translation mechanism is configured to drive the first support mechanism and/or the second support mechanism on the translation mechanism to move; and/or
the powder scooping mechanism comprises a first powder-scooping driving member, a first powder-scooping transmission member, and a powder scooping rod, one end of the first powder-scooping transmission member is connected to the first powder-scooping driving member, another end of the first powder-scooping transmission member is connected to the powder scooping rod, the first powder-scooping driving member is configured to drive the powder scooping rod to move to scoop or pour powder, the first powder-scooping driving member is connected to the first support mechanism, and the first powder-scooping transmission member is connected to the second support mechanism; or, the powder scooping mechanism comprises a second powder-scooping driving member, a second powder-scooping transmission member, a third powder-scooping driving member, a third powder-scooping transmission member, and a powder scooping member, both the second powder-scooping transmission member and the third powder-scooping transmission member are connected to the powder scooping member, the first support mechanism is connected to the second powder-scooping driving member, the second powder-scooping driving member is connected to the second powder-scooping transmission member, the second support mechanism is connected to the third powder-scooping driving member, the third powder-scooping driving member is connected to the third powder-scooping transmission member, both the first support mechanism and the second support mechanism are movably connected to the powder scooping member, and the second powder-scooping driving member and the third powder-scooping driving member are configured to drive the powder scooping member, through a corresponding powder-scooping transmission member, to perform any one of a translation motion, a rotational motion, or a composite motion of the translational motion and the rotational motion.

17. The powder scooping apparatus of claim 16, wherein the first powder-scooping transmission member comprises a bushing and a guide shaft, the bushing is sleeved on the guide shaft, the guide shaft is rotatable relative to the bushing, one end of the guide shaft is connected to the first powder-scooping driving member, another end of the guide shaft is connected to the powder scooping rod, the first powder-scooping driving member is configured to drive the guide shaft to rotate to drive the powder scooping rod to rotate, one end of the powder scooping rod away from the guide shaft is provided with a scoop, and the second support mechanism is connected to the bushing; and the guide shaft is also movable relative to the bushing, and the first support mechanism and the second support mechanism are movable close to or away from each other; or
the powder scooping member comprises a screw shaft, a first nut, a second nut, and a powder scooping rod, the first support mechanism is rotatably connected to the first nut, the second powder-scooping transmission member is connected to the first nut, the second support mechanism is rotatably connected to the second nut, the third powder-scooping transmission member is connected to the second nut, the screw shaft passes through the first nut and the second nut, both the first nut and the second nut are movably connected to the screw shaft, one end of the screw shaft away from the second powder-scooping driving member is connected to one end of the powder scooping rod, and one end of the powder scooping rod away from the screw shaft is provided with a scoop; one of the first nut and the second nut is a screw nut, another of the first nut and the second nut is a spline nut, the screw shaft defines a helical groove spirally extending in an axial direction of the screw shaft and a straight groove linearly extending in the axial direction of the screw shaft, the screw nut is engaged with the helical groove, the spline nut is engaged with the straight groove, and the first nut and/or the second nut is rotatable relative to the screw shaft to drive the screw shaft to perform any one of the translation motion, the rotational motion, or the composite motion of the translational motion and the rotational motion.

18. The powder scooping apparatus of claim 15, wherein at least one of the first support mechanism or the second support mechanism comprises a support structure and a joint, the joint is rotatably connected to one end of the support structure, and the joint is connected to the powder scooping mechanism; and the support structure comprises a first support member, a second support member, a first transmission member, a second transmission member, a first driving member, and a second driving member, the first support member is rotatably connected to the joint and the first transmission member, the second support member is rotatably connected to the first support member and the second transmission member, the first driving member is connected to the first transmission member and is configured to drive the first transmission member to drive the first support member to move, and the second driving member is connected to the second transmission member and is configured to drive the second transmission member to drive the second support member to move; or
at least one of the first support mechanism or the second support mechanism comprises a support structure and a joint, the joint is rotatably connected to one end of the support structure, and the joint is connected to the powder scooping mechanism; and the support structure comprises a first support member, a second support member, a third driving member, a third transmission member, and a fourth transmission member, the third transmission member is rotatably connected to the first support member, the fourth transmission member is rotatably connected to the second support member, and the third driving member is connected to the third transmission member and the fourth transmission member and is configured to drive the third transmission member and the fourth transmission member to move independently.

19. The powder scooping apparatus of claim 18, wherein each of the first driving member and the second driving member is a rotary electric machine, each of the first support member and the second support member is a connecting rod, the first transmission member comprises any one or a combination of a connecting rod, a lead screw and nut pair, a gear and rack pair, or a worm wheel and worm pair, and the second transmission member comprises any one or a combination of a connecting rod, a lead screw and nut pair, a gear and rack pair, or a worm wheel and worm pair; or, the third driving member is a linear electric machine, the linear electric machine comprises a plurality of independently movable movers, and the third transmission member and the fourth transmission member are connected to different movers of the plurality of movable movers; and/or
the joint comprises a first rotating member and a second rotating member, the first rotating member is rotatably connected to the support structure, the second rotating member is rotatably connected to the first rotating member, the second rotating member is connected to the powder scooping mechanism, and a rotation axis of the first rotating member intersects with a rotation axis of the second rotating member.

20. The powder scooping apparatus of claim 14, wherein the powder scooping apparatus further comprises a loading-and-unloading manipulator, the loading-and-unloading manipulator is configured to pick and place the source container and/or the target container on the powder weighing assembly; and
the loading-and-unloading manipulator comprises a loading-and-unloading robotic arm and a gripper, the gripper is disposed on the loading-and-unloading robotic arm, the loading-and-unloading robotic arm is configured to drive the gripper to move, the gripper comprises a plurality of fingers, and the plurality of fingers is movable toward or away from each other.

21. The powder scooping apparatus of claim 20, wherein the gripper further comprises a gripper fixed seat, a gripper movable seat, a gripper transmission rod, and a plurality of gripper transmission structures; and the gripper fixed seat is connected to the loading-and-unloading robotic arm, the gripper transmission rod is movably connected to the gripper fixed seat, the gripper movable seat is connected to the gripper transmission rod, the plurality of gripper transmission structures are arranged at intervals in a circumferential direction of the gripper transmission rod and are movably connected to both the gripper fixed seat and the gripper movable seat, the plurality of gripper transmission structures are connected to the plurality of fingers in a one-to-one correspondence, the gripper transmission rod is configured to drive the gripper movable seat to move in an axial direction of the gripper transmission rod to drive the plurality of gripper transmission structures to move, and the plurality of gripper transmission structures are configured to drive the plurality of fingers to move in a radial direction of the gripper transmission rod.

22. An experimental equipment, comprising:
a powder weighing assembly, wherein the powder weighing assembly comprises a moving mechanism, a container seat, and a weighing device, and the moving mechanism is connected to the container seat and/or the weighing device, and is configured to cause relative movement between the container seat and the weighing device, to enable the container seat and the weighing device to be in contact with or separated from each other in a first direction; the container seat comprises a first placement structure and a second placement structure, the first placement structure is configured for placement of a target container to be filled with powder, and the second placement structure is configured for placement of a source container filled with powder; and the weighing device is disposed on one side of the container seat in the first direction, and is configured to be in contact with the container seat and weigh the container seat; or
a powder scooping apparatus, wherein the powder scooping apparatus comprises a powder scooping manipulator and a powder weighing assembly, the powder weighing assembly comprises a moving mechanism, a container seat, and a weighing device, and the moving mechanism is connected to the container seat and/or the weighing device, and is configured to cause relative movement between the container seat and the weighing device, to enable the container seat and the weighing device to be in contact with or separated from each other in a first direction; the container seat comprises a first placement structure and a second placement structure, the first placement structure is configured for placement of a target container to be filled with powder, and the second placement structure is configured for placement of a source container filled with powder; the weighing device is disposed on one side of the container seat in the first direction, and is configured to be in contact with the container seat and weigh the container seat; the powder scooping manipulator is configured to scoop powder from the source container and transfer the powder into the target container; and the powder scooping manipulator comprises a powder scooping robotic arm and a powder scooping mechanism, the powder scooping mechanism is disposed on the powder scooping robotic arm, the powder scooping robotic arm is configured to drive the powder scooping mechanism to move between the source container and the target container, and the powder scooping mechanism is configured to scoop the powder from the source container and pour the powder into the target container.
